(19) United States
(12) Patent Application Publication
(10) Pub. No.: US 2015/0068512 A1
(43) Pub. Date: Mar. 12, 2015

(54) TABLE AND ACCESSORIES

(71) Applicant: TROPITONE FURNITURE CO., INC., Irvine, CA (US)

(72) Inventors: Brian Adam Mehler, Long Beach, CA (US); Richard Rivera, Corona, CA (US)

(21) Appl. No.: 14/487,984

(22) Filed: Sep. 16, 2014

Related U.S. Application Data
(63) Continuation-in-part of application No. 14/205,201, filed on Mar. 11, 2014.
(60) Provisional application No. 61/878,540, filed on Sep. 16, 2013.
(60) Provisional application No. 61/799,011, filed on Mar. 15, 2013.
(60) Provisional application No. 61/878,540, filed on Sep. 16, 2013.

(51) Int. Cl. A47J 37/07

(52) U.S. Cl. CPC A47J 37/0763; A47J 37/0786
USPC 126/25 R; 126/305

(57) ABSTRACT

A fire pit or stovetop cooking grill can have a griddle and a cooking rack. The griddle can be used to cook food. The cooking rack can be on the griddle. The cooking rack can be used to cook food. The griddle can be on the fire pit or stovetop to provide a surface of heat for cooking food. The fire pit can provide a fire light ambiance while cooking with the cooking grill on the fire pit. The fire pit can have other accessories placed on the tabletop of the fire pit, including a turntable for easy access of food items.

### CROSS-REFERENCE TO RELATED APPLICATIONS

This application claims the benefit under 35 U.S.C. §119(e) of U.S. Provisional Patent Application No. 61/878,540, titled “COOKING GRILL,” filed on Sep. 16, 2013. This application is a continuation-in-part of U.S. application Ser. No. 14/205,201, titled “COOKING GRILL,” filed on Mar. 11, 2014, which claims the benefit of U.S. Provisional Patent Application No. 61/799,011, titled “COOKING GRILL,” filed on Mar. 15, 2013, and U.S. Provisional Patent Application No. 61/878,540, titled “COOKING GRILL,” filed on Sep. 16, 2013. The above-identified patent applications are each incorporated by reference in their entirety and made a part of this specification.

### BACKGROUND

1. Field

This disclosure relates to tables and accessories and, more particularly, to accessories that can be used on tables with fire pits and/or openings.

2. Description of the Related Art

A number of cooking devices, such as barbeque grills, for cooking food are available. Cooking devices provide a heat source to cook the food. The cooking devices can provide the heat source using coals, firewood, natural gas, or electricity (e.g., heat plate, heat coils). Some cooking devices provide a grill over the heat source to cook the food. Some cooking devices provide a plate or pan over the heat source to cook the food. Some cooking devices integrate the grill or plate with the heat source, such as heat coils.

A number of fire pit devices are available. Fire pit devices can provide ambient light as well as limited heat for the enjoyment of an observer. Fire pit devices can provide the light and heat source using coals, firewood, natural gas, or electricity.

### SUMMARY

A need exists for cooking devices with a fire pit to provide a versatile fire pit cooking grill assembly for user enjoyment and/or cooking. A fire pit can provide ambient light and/or heat without cooking foods. The fire pit can have a cooking grill that can be removed when food cooking is not desired. A cooking grill can be used to cook food. While cooking food on the cooking grill, the fire pit can continue to provide ambient light and/or heat. The fire pit cooking grill assembly can provide an interactive and social cooking media on a fire pit that is relaxing and entertaining for the parties involved. A fire pit cooking grill can provide a central cooking area that is integral to a tabletop surface where each participant can cook food separately based on individual tastes. Small portions of meats, vegetables, and/or other food items can be provided to the participants who then add their selections to the central cooking area. Each participant seasons and cooks each item to their own tastes. When the food items are cooked, the participants remove them from the cooking area and place them directly on their plates for consumption.

The fire pit can have a tabletop. A user, which can include a group of users or a party of users, can use the tabletop as a table for setting items down, including food items, plates, utensil, etc. The user can also use it as a table for eating. Users can sit around the tabletop to cook on the cooking grill while still enjoying the luminescence and/or heat of a fire pit. Using a cooking grill with a fire pit can create a socially interactive cooking experience for the users. The tabletop and/or cooking grill can be a suitable height such that the user can see the food during cooking. The user can see the food while cooking on the cooking grill when standing up, sitting down, or both. A fire pit can serve as a patio or dining table. The cooking grill can be used with the fire pit or dining table. After cooking the food, the user can leave or remove the cooking grill from the fire pit or dining table while enjoying the cooked food at the same table. The user can manipulate controls on the fire pit that increase or decrease the ambient light and/or heat before, during, and after cooking.

The cooking grill can at least partially prevent the cooking juices of the food from falling on burning or hot non-disposable (or reusable) media of the fire pit. Burning or hot reusable media can include stones, glass, or other materials suitable that can withstand heat generated by the fire pit. The media can help with radiance of heat as well help provide ambience (luminescence). Cooking juices that buildup on the media may impair the media's ability to radiate heat and/or provide ambience. Further, preventing juices from falling on the media can help mitigate creating a mess during cooking and facilitate cleanup. Further, preventing juices from falling on the media can help prevent ruining the fire pit. For example, buildup of cooking juices on the burning or hot media may require changing out the burning or hot media. Cooking juices can also build up on the burners of the fire pit, which may require cleaning and/or changing of the burners. The cooking grill can be designed to avoid soot buildup on the cooking grill itself as discussed herein.

The cooking grill can have a cooking griddle. The griddle can be made of die cast or stamp-pressed aluminum, including aluminum alloys. Other suitable materials can include any suitable form or alloy of cast or wrought iron or carbon steel or stamped materials. The griddle can be used with metal cooking utensils without substantial damage or abrasion to the griddle. The griddle can have legs that rest around an opening of the fire pit containing the burner and burning or hot media. The griddle can have a middle portion (or cooking section) that slopes downwardly from a center of the griddle or slopes upwardly from a perimeter of the griddle to the center. The center of the cooking griddle can have a center opening.

A height of the legs, a slope and/or an arcuate shape of the middle portion, and a diameter of a center opening for the cooking grill can be arranged to achieve the following features. The arrangement can direct air, flame, heat, and/or combustion byproducts to help prevent flame rollout from sides of the cooking griddle during fuel combustion by the fire pit. The arrangement can direct air, flame, heat, and/or combustion byproducts to help prevent soot buildup on the griddle. The arrangement can direct air, flame, heat, and/or combustion byproducts to help create a vacuum that draws in air from the sides of the griddle for combustion by the fire pit. The arrangement can direct air, flame, heat, and/or combustion byproducts to help prevent melting of the griddle material. The arrangement can direct air, flame, heat, and/or combustion byproducts to help direct air, flame, heat, and/or combustion byproducts toward the center opening. The arrangement can make the middle portion of the griddle be the hottest portion of the cooking griddle during combustion of fuel by the fire pit. The heat can thermally conduct and dissipate throughout the griddle to create different heat zones on the griddle. The different heat zones can provide different cooking zones for a desired level of cooking based on a predetermined heat input.

The arrangement can create a partial vacuum at the sides of the cooking griddle to draw air in for improved combustion of the fuel by the fire pit. Proper combustion can include a desired flame color, height, and/or no or substantially no smoke. The created vacuum and/or proper combustion can also help prevent flame rollout from the sides of the griddle. Proper combustion can help prevent soot buildup on the griddle. Proper combustion can also help regulate flame color, size, and/or intensity (heat). The vacuum and/or proper combustion can at least in part be a result of the slope and/or the arcuate shape of the middle portion directing the air, flame, heat, and/or combustion byproducts toward the center of the griddle. The vacuum and/or proper combustion can at least in part be a result of the center opening through which air, flame, heat, and/or combustion byproducts can escape.

As part of the arrangement, the legs raise the cooking griddle above the opening and the burners of the fire pit. During combustion, heat is directed to the center opening of the griddle by the slope and/or the arcuate shape of the middle portion. The higher the legs raise the cooking griddle from the burners, the smaller the slope or the less arcuate the shape of the middle portion has to be in order to help prevent melting of the griddle and/or rollout of flames from the sides. As the air, heat, and/or combustion products are directed toward and out of the center opening, the flame is channeled toward the center opening to have a peak (highest) flame at the center opening due to an updraft or chimney effect. The updraft or chimney effect can help prevent the cooking griddle from melting and prevent flames from coming out of the sides of the griddle.

The griddle can have raised portions and/or recessed portions on the cooking surface. The raised portions and/or recessed portions can help elevate the food above the cooking surface of the griddle. The raised portions and/or recessed portions can help create barbeque sear marks in the food. The raised portions and/or recessed portions can help direct cooking juices toward a periphery or channel of the griddle. The slope and/or the arcuate shape of the middle portion can help direct cooking juices toward the periphery or channel of the cooking griddle.

The cooking grill can have a cooking rack. The cooking rack can rest on top of the cooking griddle. The cooking rack can elevate the food above the cooking griddle. The cooking rack can be wire frame structure. The wire frame structure can impart sear marks on the food during cooking and allow cooking juices to fall down onto the griddle below. The cooking grill can be substantially flat. The cooking grill can be sloped and/or follow the contour of the middle portion of the griddle. The cooking grill can have a cover plate arranged to be substantially over the center opening of the griddle. The cover plate can help prevent the cooking juices from dripping onto the burning or hot media through the center opening. The cooking grill can have different cooking zones as discussed herein for the griddle. The cooking zones can get relatively hotter toward the cover plate. The cooking grill can be removed from griddle to help prevent soot buildup on the food when cooking on the cover plate of the cooking rack, near the hottest cooking zone.

The cooking grill as discussed herein can be used on a stovetop, such as a commercial grade stovetop or fire pits, such as a propane and/or natural gas, wood, charcoal and/or electric fire pit. The stovetop or fire pit can have a heat output ranging from about 8,000 to about 100,000 BTUs. The foregoing heat output can make the cooking griddle reach temperatures of up to about 800° Fahrenheit. The heat source or flame of the fire pit can be under just a portion of the griddle. The heat can thermally conduct through the griddle, further contributing to the cooking zones discussed herein. The cooking grill can be particularly suitable for use on stovetops and fire pits that are hotter than typical or conventional stovetops or fire pits. Thus, the cooking grills versatility allows it be used over a broad range of cooking applications, including stovetops or fire pits designed to provide fire or light for ambiance that may have higher than typical BTU output.

The burner of the fire pit can be a 1 to 16 piece burner. The burner can also be a 6 piece burner. Numerical value of the pieces can represent individual burners of the fire pit that are operably connected. The pieces of the burners can have various shapes such as a star shape with a 5 piece burner or a hexagon with a 6 piece burner (or six arm star burner). The burners can have 3 to 100 combustion holes. In some embodiments, a smaller number of combustion holes in the burner piece directly correlates to relatively larger size of the combustion holes. A greater number of holes, such as 100 holes, in the burner allows for more air to be drawn in at the air intake of the fire pit, creating a more efficient burn. However, a more efficient burn can create less fire light ambiance (visible flame) that is desired from a fire pit flame. A large air intake for the fire pit can be provided to allow for a reduction of the number of combustion holes, such as 60 combustion holes in the burner, to have a more efficient burn of the flame while still providing fire light ambiance. The larger air intake can also create more intuitive control of the fire pit, such as the user turning up the gas to the fire pit to provide a larger flame and a hotter cooking surface without soot buildup. The larger air intake of the fire pit can help prevent soot buildup while cooking over a larger and hotter flame.

The fire pit can be designed to burn fuel at a high efficiency to minimize fuel consumption, as well as minimize the formation of byproducts (soot) that have not been fully consumed during the combustion process, which is undesirable and can be toxic to inhale. An inefficient flame can result in the formation of byproducts and black smoke. Byproducts can settle on the cooking grill as soot. An indication of efficient combustion can be the absence of smoke during combustion, a relatively low flame height, and a blue flame, indicating high temperatures, typically in excess of 1,000 degrees Fahrenheit. The fire pit designs disclosed herein can achieve a relatively high yellow luminescent flame while combusting fuel at a high temperature efficiently and cleanly. A high flame height can be about 2 to 8 inches and/or about 1 to 7 inches higher than a tabletop of the fire pit as discussed herein.

The fire pit table (or a table that does not necessarily incorporate a fire pit opening) can be adapted to be used with various accessories. For example, as with the cooking grill, the fire pit can be used with an oven. The oven can be, for example, a pizza oven. The oven can be used to also cook other food items normally cooked in a baking oven. The oven can provide conventional baking oven capabilities while enjoying the fire pit in an outdoor environment. The table can also be used with a turntable or a Lazy Susan. When the fire pit is not used or used in a low setting, the Lazy Susan may hold food items that can be rotated about a central axis for ease of access by each user around the table. Alternatively, the table can be used with a bucket. The bucket can be, for example an ice bucket for maintaining coolness of beverages. The bucket can be used for other food types as desired by the user.

Other accessories can include the use of alternative fuel types. For example, when a user desires to use natural charcoal rather than burning a gas fuel, the fire pit can be converted to a charcoal burning receptacle or pit. This may give the fire pit or charcoal pit a more rustic and natural smoke feel to the environment and any food being cooked. The table can also be used with gel burners. The gel burners can combust with less combustible byproducts relative to gas burners or charcoal. The gel burners may be used inside or a semi-closed environment while substantially avoiding noxious fumes that can be dangerous and unpleasant to a user.

In accordance with embodiments disclosed herein, a cooking grill fire pit assembly is provided. The cooking grill fire pit assembly comprises a fire pit comprising a top supported by sides, the top including an opening bounded by a rim, the opening including a burner and heat conducting media supported in the opening. The cooking grill fire pit assembly further comprises a cooking element comprising legs configured to rest on the fire pit and a dome on the legs, the dome including a center opening elevated higher than the legs of the dome, a concave surface facing the opening of the fire pit, and a cooking surface facing away from the opening of the fire pit. The cooking grill fire pit assembly further comprises a cooking rack comprising a cover plate and configured to mate with the cooking element, the cooking rack configured to be positioned generally over the cooking surface of the cooking element such that the cover plate is vertically over the center opening of the cooking element. The legs are configured to elevate the cooking element above the burner to allow intake of air via a vacuum created when the burner combusts fuel. The concave surface facing the opening of the fire pit is configured to direct combustion byproducts and heat output toward the center opening of the cooking element when the burner combusts fuel. The center opening of the cooking element is configured to vent the combustion byproducts and the heat output when the burner combusts fuel. The cooking element and the cover plate are configured to generally cover the heat conducting media such that cooking juices from food cooking do not drip onto the heat conducting media.

In some embodiments, the opening of the fire pit is generally round and the cooking element is generally a same shape as the opening of the fire pit; the opening of the fire pit is generally square and the cooking element is generally a same shape as the opening of the fire pit; the cooking rack is generally round and the cooking element is configured to accept the round cooking rack; the cooking element is bound by a perimeter generally following the rim of the opening of the fire pit; the legs of the cooking element comprise a body with a protrusion; the body is configured to rest on the rim of the opening of the fire pit and the protrusion is configured to engage an inside of the opening at the rim such that the legs inhibit movement of the cooking element in at least a plane parallel to the rim of the opening; the legs elevate the cooking element above the burner to keep a material of the cooking element below a melting point of the material when the burner combusts fuel; the legs elevate the cooking element above the burner to inhibit flame out beyond a perimeter bounding the cooking element when the burner combusts fuel; a height of the legs, an arch of the concave surface facing the opening of the fire pit, and a diameter of the center opening of the cooking element are sized to prevent combustion byproduct buildup on at least one of the concave surface or the center opening of the cooking element; a height of the legs, an arch of the concave surface facing the opening of the fire pit, and a diameter of the center opening of the cooking element are sized to channel a flame when the burner combusts fuel toward the center opening of the cooking element such that a highest peak of the flame is at the center opening; a diameter of the opening of the fire pit is about 12 to about 18 inches; a height of the legs of the cooking element is about 0.5 to about 5 inches above the rim of the opening of the fire pit; a diameter of the center opening of the cooking element is about 1 to about 5 inches; the heat output of the fire pit when the burner combusts fuel is about 8,000 to about 100,000 British thermal units; a ratio of a total opening area of combustion holes of the burner to an opening area of a fuel orifice of the fire pit is about 1.5:1 to about 5:1; the ratio is configured to achieve about a 2 to 8 inch flame height with yellow luminescence generally without byproduct buildup on the concave surface of the cooking element facing the opening of the fire pit when the burner combusts fuel; the fuel orifice is configured to direct fuel to the burner; the burner comprises six arms; and/or the six arms each include 10 combustion holes.

In accordance with embodiments disclosed herein, a cooking grill assembly is provided. The cooking grill assembly comprises a cooking element comprising posts configured to rest on a fire pit and a circular pan on the posts leading toward a center opening, the circular top including a heat surface facing the fire pit and a cooking surface facing away from the fire pit. The cooking grill assembly comprises a cooking rack comprising a cover plate and configured to be on the cooking element, the cooking rack positioned generally over the cooking surface of the cooking element such that the cover plate covers the center opening of the cooking element. The posts are configured to elevate the cooking element above the fire pit to allow intake of air via a vacuum created during combustion of fuel by the fire pit. The heat surface facing the fire pit is configured to direct combustion byproducts and heat output of the fire pit toward the center opening of the cooking element during combustion of fuel by the fire pit. The center opening of the cooking element is configured to vent the combustion byproducts and the heat output of the fire pit during combustion of fuel by the fire pit.

In some embodiments, the cooking rack further comprises a circular wire frame bounding the cooking rack, the wire frame configured to mate with a circular groove of the cooking element such that the mating of the circular wire frame with the circular groove inhibits movement of the cooking rack in at least a plane parallel to the circular groove of the cooking element; and/or the heat and cooking surfaces are arcuate and a contour of the cooking grill generally follows the arcuate heat and cooking surfaces.

In accordance with embodiments disclosed herein, a cooking grill is provided. The cooking grill comprises a cooking element comprising posts configured to be on a fire pit and a frustum on the posts, the frustum including a center opening elevated above the legs, an inner surface facing the fire pit, and a cooking surface facing away from the fire pit. The posts are configured to elevate the cooking element above the fire pit to allow intake of air via a vacuum created during combustion of fuel by the fire pit. The inner surface facing the fire pit is configured to direct combustion byproducts and heat output of the fire pit toward the center opening of the cooking element during combustion of fuel by the fire pit. The center opening of the cooking element is configured to vent the combustion byproducts and the heat output of the fire pit during combustion of fuel by the fire pit.

In some embodiments, the frustum is generally circular and arcuate to form a dome such that the inner surface is generally arcuate; the frustum is generally circular and arcuate to form a dome such that the cooking surface is generally arcuate; an angle formed between a periphery of the cooking element and the center opening relative to a horizontal axis is about 0 to about 45 degrees; the cooking surface further includes raised portions configured to elevate food above the cooking surface; the raised portions are configured to direct cooking juices from food cooking toward a periphery of the cooking element; the cooking element further comprises a ridge bounding the cooking element, the ridge configured to contain cooking juices from food cooking within the cooking element; and/or the cooking element further comprises handles attached at a periphery of the cooking element, the handles configured to allow for positioning of the cooking element over the fire pit.

In accordance with embodiments disclosed herein, a turntable fire pit assembly is provided. The turntable fire pit assembly comprises a fire pit comprising a tabletop supported by sides, the tabletop including an opening bounded by a rim. The turntable fire pit assembly further comprises a turntable comprising a rotating cover and a flange connected to the rotating cover, and at least one roller assembly connected to the flange, the turntable configured to engage the fire pit to allow the rotating cover to rotate on the roller assemblies relative to the tabletop of the fire pit about a central axis of the turntable when the turntable is at least partially over the opening of the fire pit. The roller assembly comprises a bolt connected to the flange and extending radially inward toward the central axis of the turntable. The roller assembly further comprises a roller on the bolt, the roller configured to rotate about the bolt to allow the rotating cover to move relative to the tabletop about the central axis when the turntable is at least partially over the opening of the fire pit. The roller assembly further comprises a fin connected to the bolt, the fin proximate to the central axis relative to the roller and extending past a periphery of the roller away from the rotating cover to guide the rotating cover along a rotating path while the roller rotates about the bolt to allow the rotating cover to move relative to the tabletop about the central axis when the turntable is at least partially over the opening of the fire.

In some embodiments, the turntable fire pit assembly includes one or more of the following: the roller assembly further comprises a spacer on the bolt, the spacer configured to position the fin at a desired position on the bolt relative to the flange; the spacer is between the roller and the fin; the roller assembly further comprises a washer on the bolt between the spacer and the roller, the washer configured to allow the roller to rotate about the bolt; the roller assembly further comprises a washer on the bolt between the flange and the roller, the washer configured to allow the roller to rotate about the bolt; the fin extends toward the rotating cover, the fin comprising a substantially straight side that inhibits rotation of the fin about the bolt by abutting a surface of the rotating cover via at least one contact point between the substantially straight side and the surface of the rotating cover; the turntable further comprises a protrusion connected to flange and radially extending out relative to the central axis beyond a perimeter of the flange about the central axis; a bolt hole radially extends through the flange and the protrusion; the bolt is securely connected to the flange via the bolt hole with the bolt hole orienting the bolt substantially perpendicular to the central axis; the roller is configured to roll on the rim of the opening of the fire pit, the rim circumscribing a perimeter of the opening and connected to an inner wall inside the opening; the fin extends past the rim into the opening adjacent the inner wall to guide the rotating cover along the rotating path; the rotating path corresponds to the perimeter of the opening via the inner wall inhibiting movement of the fin beyond the perimeter of the opening when the turntable is at least partially over the opening of the fire pit; comprising a table ring configured to be placed on the fire pit about the opening; the roller is configured to roll on a rim of the table ring of the fire pit, the rim circumscribing a perimeter of the opening and connected to an inner wall of the table ring; the fin extends past the rim adjacent the inner wall to guide the rotating cover along the rotating path; the rotating path corresponds to the perimeter of the opening via the inner wall inhibiting movement of the fin beyond the rim of the table ring when the table ring is at least partially over the opening of the fire pit with the turntable on the table ring; the table ring comprises a stop configured to rest against the fire pit to inhibit movement of the table ring relative to the tabletop of the fire pit; a diameter of the opening of the fire pit is about 12 to about 18 inches; a diameter of the rotating cover is about 12 to about 36 inches; and/or the fire pit comprises a table comprising legs configured to support the table on a resting surface.

In accordance with embodiments disclosed herein, a turntable assembly for placement onto a table is provided. The turntable assembly comprises a body comprising a skirt circumscribing a central axis of the body, the skirt extending from the body generally in a direction parallel to the central axis. The turntable assembly further comprises an axle connected to the skirt, the axle radially extending relative to the central axis. The turntable assembly further comprises a bearing on the axle, the bearing configured to spin on the axle. The turntable assembly further comprises a wing on the axle, the wing extending substantially parallel to the central axis beyond a periphery of the bearing. When the turntable is placed on top of a table with an opening, the bearing contacts the table to support the turntable on the table. When the turntable is placed on the table at least partially over the opening, the wing extends into the opening to guide the body along a perimeter of the opening while the body moves relative to the table via the bearings spinning on the axle.

In some embodiments, the turntable assembly includes one or more of the following: a spacer on the axle, the spacer configured to position the wing at a desired position on the axle relative to the skirt; the spacer is between the bearing and the wing; a washer on the axle between the spacer and the bearing, the washer configured to allow the bearing to rotate about the axle; a washer on the axle between the skirt and the bearing, the washer configured to allow the bearing to rotate about the axle; the wing extends toward the body parallel to the central axis, the wing comprising a side that inhibits rotation of the wing about the axle by the side abutting the body; a protrusion connected to the skirt and radially extending out relative to the central axis beyond a perimeter of the flange about the central axis; an axle opening radially extends through the skirt and the protrusion; the axle is securely connected to the skirt via the axle opening with the axle opening orienting the axle substantially perpendicular to the central axis; the bearing is configured to roll on a lip of the opening of the table, the lip circumscribing the perimeter of the opening of the table and connected to an inner wall of the opening of the table; the wing extends past the lip into the opening adjacent the inner wall to guide the body relative the inner wall such that the inner wall inhibits movement of the wing beyond the perimeter of the opening when the body is at least partially over the opening of the table; the bearing is configured to roll on a table hoop configured to be placed on the table about the opening of the table, the table hoop sized to follow the perimeter of the opening; the wing extends past a top of the table hoop to guide the body along a perimeter of the table hoop when the table hoop is at least partially over the opening of the table with the bearing on the table ring; the table hoop comprises a stop configured to rest against the table to inhibit movement of the table ring relative to the table; the axle radially extends from the skirt to the central axis; a diameter of the opening of the table is about 12 to about 18 inches; and/or a diameter of the body is about 12 to about 36 inches; the table comprises a fire pit including the opening of the table.

In accordance with embodiments disclosed herein, a wheel assembly for supporting a rotating cover on a resting surface. The wheel assembly comprises a shaft. The wheel assembly over further comprises a wheel on the shaft, the wheel configured to spin on the shaft. The wheel assembly further comprises a projection on the shaft, the projection extending substantially parallel to the central axis beyond a periphery of the wheel. When the shaft is connected to a rotating cover, the wheel is configured to support the rotating cover relative to a resting surface. When the shaft is connected to the rotating cover and the wheel is placed onto the resting surface, the rotating cover is allowed to rotate relative to resting surface via the wheel rotating on the resting surface, the rotation of the rotating cover guided along a predetermined path by the projection engaging a side of the resting surface.

In some embodiments, the wheel assembly includes one or more of the following: the resting surface comprises an opening having the side; when the shaft is connected to the rotating cover and the wheel is placed onto the resting surface, the rotating cover at least partially covers the opening such that the projection extends into the opening of the resting surface to engage the side and guide the rotating cover along the predetermined path about a central axis of the rotating cover; the shaft is connected to the rotating cover, the projection extends toward the rotating cover parallel to the central axis, the projection comprising a side that inhibits rotation of the wing about the shaft by coming against the body via at least one contact point between the side of the projection and the rotating cover; a spacer on the shaft, the spacer configured to position the projection at a desired position on the shaft; a washer on the shaft between the spacer and the wheel, the washer configured to allow the wheel to rotate about the shaft; the spacer is between the wheel and the projection; a washer on the shaft between the rotating cover and the bearing, the washer configured to allow the wheel to rotate about the shaft; the shaft radially extends substantially perpendicular to a central axis of the rotating cover; and/or a table comprises the resting surface.

The foregoing is a summary and thus contains, by necessity, simplifications, generalization, and omissions of detail; consequently, those skilled in the art will appreciate that the summary is illustrative only and is not intended to be in any way limiting. Other aspects, features, and advantages of the devices and/or processes and/or other subject matter discussed herein will become apparent in the teachings set forth herein. The summary is provided to introduce a selection of concepts in a simplified form that are further described below in the Detailed Description. This summary is not intended to identify key features or essential features of any subject matter discussed herein.

### BRIEF DESCRIPTION OF THE DRAWINGS

The foregoing and other features of the present disclosure will become more fully apparent from the following description, taken in conjunction with the accompanying drawings. Understanding that these drawings depict only some embodiments in accordance with the disclosure and are, therefore, not to be considered limiting of its scope, the disclosure will be described with additional specificity and detail through use of the accompanying drawings.

FIG. 1 illustrates a top perspective exploded view of an embodiment of a cooking grill 2.

FIG. 2 illustrates a top perspective view of an embodiment of the cooking grill.

FIG. 3 illustrates a top view of an embodiment of the cooking grill.

FIG. 4 illustrates a side view of an embodiment of the griddle.

FIG. 5 illustrates a bottom view of an embodiment of the griddle.

FIG. 6 illustrates a side view of an embodiment of the cooking rack.

FIG. 7 illustrates a bottom view of an embodiment of the cooking rack.

FIG. 8 illustrates a side view of an embodiment of the cooking grill.

FIG. 9 illustrates a top perspective exploded view of an embodiment of a cooking grill.

FIG. 10 illustrates a top perspective view of an embodiment of the cooking grill.

FIG. 11 illustrates a top view of an embodiment of the cooking grill.

FIG. 12 illustrates a side view of an embodiment of the griddle.

FIG. 13 illustrates a bottom view of an embodiment of the griddle.

FIG. 14 illustrates a side view of an embodiment of the cooking rack.

FIG. 15 illustrates a bottom view of an embodiment of the cooking rack.

FIG. 16 illustrates a side view of an embodiment of the cooking grill.

FIG. 17 illustrates a top perspective exploded view of an embodiment of a cooking grill.

FIG. 18 illustrates a top perspective view of an embodiment of the cooking grill.

FIG. 19 illustrates a top view of an embodiment of the cooking grill.

FIG. 20 illustrates a side view of an embodiment of the griddle.

FIG. 21 illustrates a bottom view of an embodiment of the griddle.

FIG. 22 illustrates a bottom view of an embodiment of the griddle.

FIG. 23 illustrates a side view of an embodiment of the cooking grill.

FIG. 24A illustrates a top perspective view of an embodiment of a fire pit.

FIG. 24B illustrates a top perspective view of an embodiment of a fire pit.

FIG. 25 illustrates a bottom perspective view of a burner tray.

FIGS. 26A-E illustrate an embodiment of a burner.

FIG. 27 illustrates a bottom perspective view of a fire pit.

FIG. 28A illustrates a top perspective view of an embodiment of a cooking grill on a fire pit.

FIG. 28B illustrates a top perspective view of an embodiment of the cooking grill on the fire pit zoomed in from FIG. 28A.

FIG. 29 illustrates a top perspective view of an embodiment of an oven.

FIG. 30 illustrates a top perspective view of an embodiment of the oven without a cover.

FIG. 31 illustrates a bottom perspective view of an embodiment of the oven.

FIG. 32 illustrates a top side view of an embodiment of the oven without a cover.

FIG. 33 illustrates a top perspective view of an embodiment of cooking utensils.

FIG. 34 illustrates a top side view of an embodiment of a turntable.

FIG. 35 illustrates a bottom side view of an embodiment of a turntable.

FIG. 36 illustrates a top side view of an embodiment of a table ring.

FIG. 37A illustrates a bottom view of a turntable.

FIG. 37B illustrates a cross-sectional view of a turntable.

FIG. 37C illustrates an enlarged cross-sectional view of a roller assembly.

FIGS. 38A-B illustrates a top perspective view of embodiment of turntables on a table.

FIG. 39 illustrates a top perspective view of an embodiment of a charcoal assembly on a fire pit.

FIG. 40 illustrates a bottom perspective view of an embodiment of a fire pit.

FIG. 41 illustrates a top perspective view of an embodiment of a charcoal assembly.

FIG. 42 illustrates a top perspective view of a cooking rack.

FIG. 43 illustrates a top perspective view of an embodiment of a square fire pit.

FIG. 44 illustrates a bottom perspective view of an embodiment of a square fire pit.

FIG. 45 illustrates a top perspective view of an embodiment a bucket in a fire pit table.

FIG. 46 illustrates a top perspective view of an embodiment of a bucket in a fire pit table.

FIG. 47 illustrates a top perspective view of an embodiment of a bucket in a table.

FIG. 48 illustrates a top perspective view of an embodiment of gel burners.

FIG. 49 illustrates a top view of an embodiment of gel burners.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description and drawings are not meant to be limiting. Other embodiments may be utilized, and other changes may be made, without departing from the spirit or scope of the subject matter presented here. It will be readily understood that the aspects of the present disclosure, as generally discussed herein, and illustrated in the Figures, may be arranged, substituted, combined, and designed in a wide variety of different configurations, all of which are explicitly contemplated and made part of this disclosure.

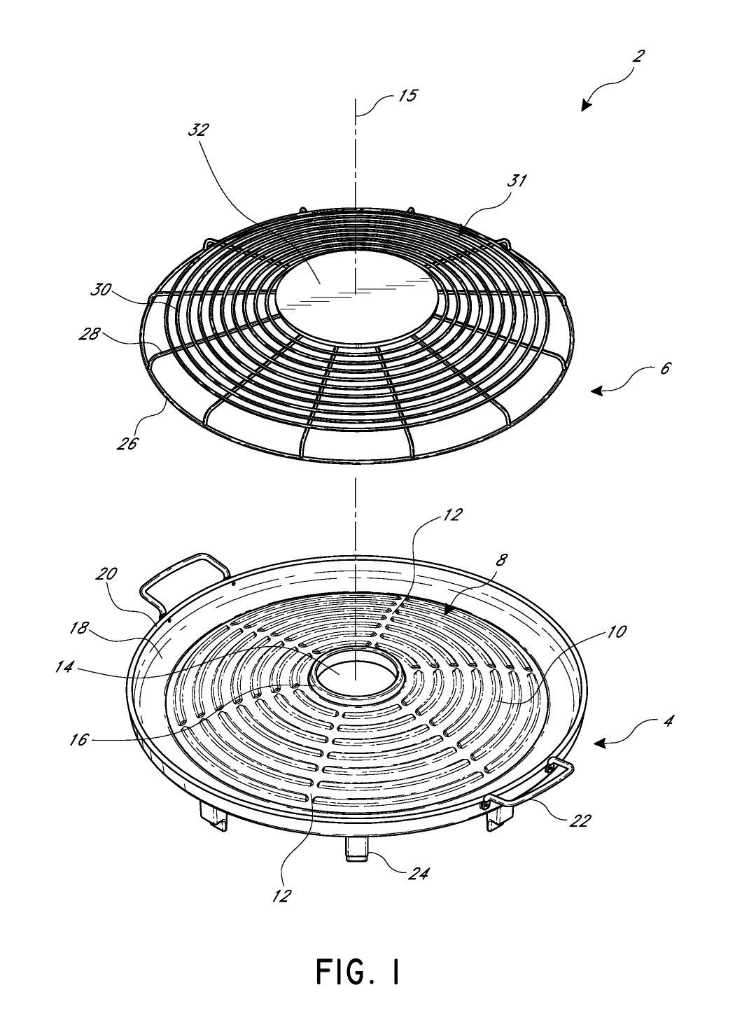

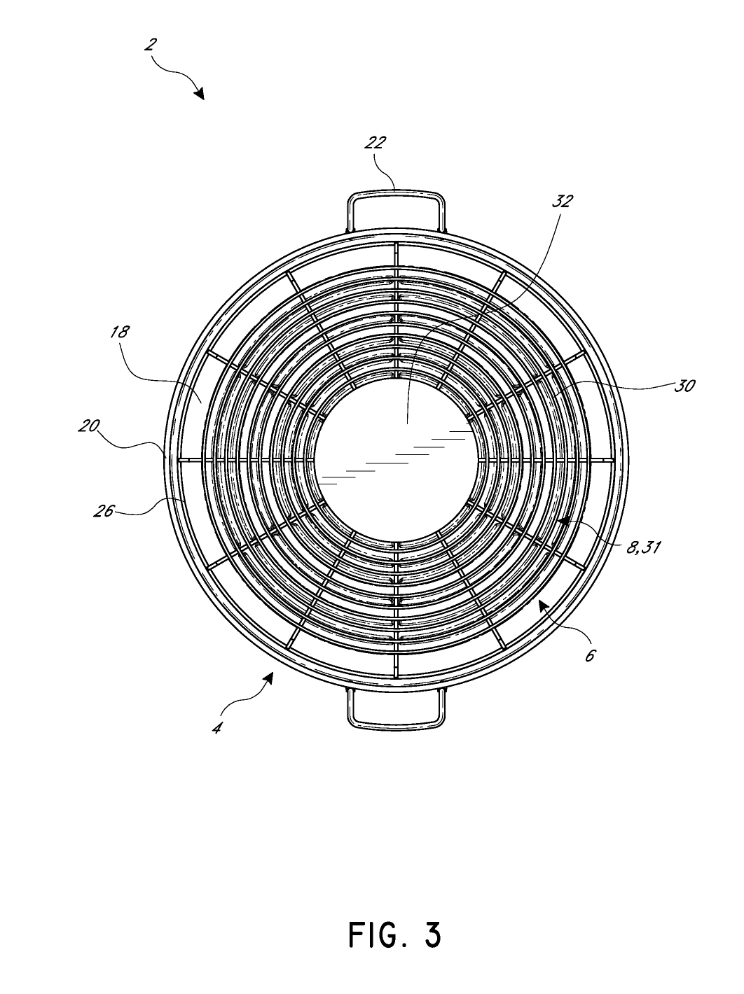

FIG. 1 illustrates a top perspective exploded view of an embodiment of a cooking grill 2. The cooking grill 2 can have a cooking element or griddle 4 and a cooking rack 6. The griddle 4 can be generally round or circular as discussed herein. The griddle 4 can be other suitable shapes, such as square, rectangular, triangular, oval, or other polygonal and/or round shapes. The griddle 4 can have a cooking surface 8. In some embodiments, the cooking surface 8 can have raised portions 10. The raised portions 10 can help elevate at least a portion of food above the cooking surface 8. The raised portions 10 can impart sear marks on the food being cooked by the griddle 4. In some embodiments, the raised portions 10 can be circular from a top perspective, such as illustrated in FIG. 3, for each to generally have a same distance from a center axis or a circular perimeter or periphery rim 20 of the griddle 4. The raised portions 10 can have a decreasing diameter, moving from the circular perimeter to the center, such that the raised portions 10 are concentric and/or coaxial relative to each other around a vertical or central axis 15. In some embodiments, the griddle 4 can have 3 to 11 raised portions 10, including 5 to 9, and including 7 raised portions 10, including ranges bordering and the foregoing values.

The raised portions 10 can be semi-circular in profile and form a generally smooth transition from the cooking surface 8 to the raised portions 10. Smooth transitions can, for example, help with cleaning the griddle 4 after cooking food. In some embodiments, the raised portions 10 can have other profile shapes such as generally square, rectangular, triangular, oval, or other polygonal and/or round shapes. In some embodiments, the raised portions 10 can have can have corners based on the geometric shape of their profile. The raised portions 10 can have abrupt transitions between the cooking surface 8 and the raised portions 10.

The raised portions 10 can have breaks or cutouts. The breaks or cutouts can line up along a radius of the griddle 4 to form passages 12. The passages 12 can extend from the center of the griddle 4 to a channel 18 and/or periphery of the griddle 4. The passages 12 can direct cooking juices from the food being cooked toward the channel 18 and/or periphery of the griddle 4.

The griddle 4 can have an opening 14 in the center of the griddle 4. The opening 14 can have a diameter of about 1 to about 5 inches, including about 2 to about 4, and including about 3 inches, including ranges bordering and the foregoing values. The opening 14 can have an inner rim 16 that defines a periphery of the opening 14. The inner rim 16 can protrude upwards from the cooking surface 8. The inner rim 16 can help prevent cooking juices of the cooking food from running into the opening 14 when the food is on the cooking surface 8. The inner rim 16 can help prevent food from falling into the opening 14 when placed on the cooking surface 8.

The griddle 4 can have a channel 18 near the periphery of the griddle 4. The channel 18 can be a flat surface at the periphery of the griddle 4. In some embodiments, the channel 18 can be a u-shaped in profile. The channel 18 can have a smooth transition from the cooking surface 8 to the channel 18. The channel 18 can collect cooking juices that may flow down the cooking surface 8 and/or the passages 12.

The griddle 4 can have an edge or a periphery rim 20 at the periphery of the griddle 4. The periphery rim 20 can protrude upwards from the cooking surface 8 and/or the channel 18. The periphery rim 20 can help contain cooking juices within the griddle 4 and/or within the channel 18 during cooking. The periphery rim 20 can help prevent food from falling into the opening 14 when placed on the cooking surface 8.

The griddle 4 can have handles 22 attached to the griddle 4 at the periphery. In some embodiments, the handles 22 are attached to the periphery rim 20. The handles 22 can be attached to the griddle 4 and/or periphery rim 20 using any suitable mechanism, such as, for example, a screw, lock, solder, and/or adhesive mechanism. In some embodiments, the handles 22 are secured onto the griddle 4 and/or periphery rim 20 using nuts and bolts. In some embodiments, the handles 22 can be integrally formed with the griddle 4 and/or periphery rim 20. The handles 22 can help a user carry and position the cooking grill 2 in a predetermined position.

The griddle 4 can have legs 24. The legs 24 can be at or near the periphery of the griddle 4. In some embodiments, the legs 24 are positioned generally underneath the channel 18 as discussed herein. The channel 18 and/or periphery, such as the periphery rim 20, can extend beyond the connection area of the legs 24 to the griddle 4. The legs 24 can be integrally formed with the griddle 4. In some embodiments, the legs 24 can be connected to the griddle 4 using any suitable mechanism, such as, for example, a screw, lock, solder, and/or adhesive mechanism.

With continued reference to FIG. 1, the cooking rack 6 can be generally a same shape as the griddle 4, such as, for example, circular. Other suitable shapes for the cooking rack 6 can include square, rectangular, triangular, oval, or other polygonal and/or round shapes. The cooking rack 6 can rest or mate with the griddle 4 to form the cooking grill 2 as discussed herein. The cooking rack 6 can be made of die cast or stamp-pressed aluminum, including aluminum alloys. Other suitable materials can include any suitable form or alloy of cast or wrought iron or carbon steel, including stainless steel.

The cooking rack 6 can be formed from wires and/or rods joined together. The cooking rack 6 can have a periphery wire 26. The periphery wire 26 can be sized to rest or mate with the channel 18 at or near the periphery rim 20. In some embodiments, the periphery wire 26 can be sized to rest or mate with the channel 18 at or near where the channel 18 transitions from the cooking surface 8 to the channel 18, which can include an area near a raised portion 10.

Support wires 28 can be connected to the periphery wire 26 to form the framework for the cooking rack 6. In some embodiments, the support wire 28 can be connected to the periphery wire 26 using any suitable mechanism, such as, for example, a screw, lock, solder, and/or adhesive mechanism. In some embodiments, the support wires 28 can be integral with the periphery wire 26. The support wires 28 can extend generally upward from the periphery wire 26 and transition to proceed generally horizontal or inclined as discussed herein toward the center of the cooking grill 6.

Cooking wires 30 can be on the support wires 28 to form a cooking section 31. The cooking section 31 can generally correspond to the cooking surface 8 of the griddle 4. In some embodiments, the cooking wires 30 can be connected to the support wires 28 using any suitable mechanism, such as, for example, a screw, lock, and/or, solder, adhesive mechanism. In some embodiments, the cooking wires 30 can be integrally formed with the support wires 28. The cooking rack 6 can have 3 to 20 cooking wires 30, including 5 to 15 and 7 to 10 cooking wires 30, including ranges bordering and the foregoing values.

The cooking rack 6 can have a center plate 32. The center plate 32 can be on the support wires 28 and/or the cooking wires 30. In some embodiments, the center plate 32 can be connected to the support wires 28 and/or cooking wires 30 using any suitable mechanism, such as, for example, a screw, lock, and/or, solder, adhesive mechanism. In some embodiments, the center plate 32 can be integrally formed with the support wires 28 and/or cooking wires 30. The center plate 32 can be generally sized and/or positioned such that when the cooking rack 6 is on the griddle 4, the center plate 32 substantially covers the center opening 14 of the griddle 4 from a top perspective. Covering the opening 14 can help prevent cooking juices from falling onto burning or hot non-disposable (or reusable) media and/or burners of a fire pit exposed by the opening 14 as discussed herein. The burning or hot media can be any media that can be subjected to high temperatures of a fire pit, and in some implementations, conduct heat (e.g., heat conducting media)

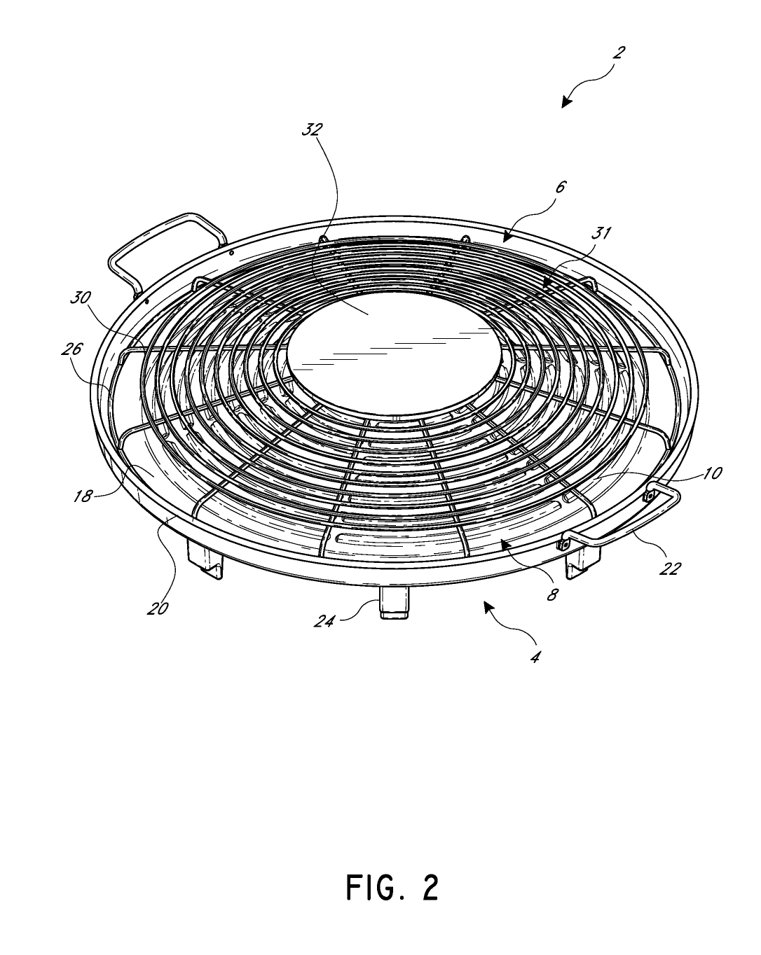

FIG. 2 illustrates a top perspective view of an embodiment of the cooking grill 2. In some embodiments, the periphery wire 26 is sized to be substantially near the peripheral edge, such as the peripheral rim 20, of the griddle 4 in the channel 18 when the cooking rack 6 is on the griddle 4. In some embodiments, the periphery wire 26 is at or near a transition between the channel 18 and the cooking surface 8.

FIG. 3 illustrates a top view of an embodiment of the cooking grill 2. As discussed herein for some embodiments, the periphery wire 26 is at or near a transition between the channel 18 and the peripheral rim 20. The cover plate 32 of the cooking rack 6 can substantially cover the center opening 14 of the griddle 4. The cooking region 31 of the cooking rack 6 can substantially coincide with the cooking surface 8 of the griddle 4. In some embodiments, the cooking region 31 can extend over the channel 18.

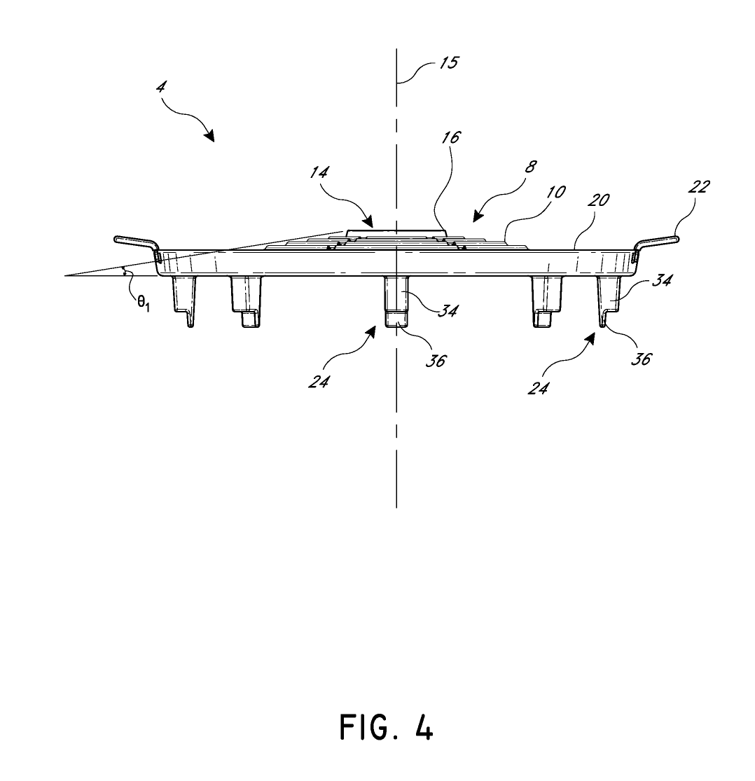

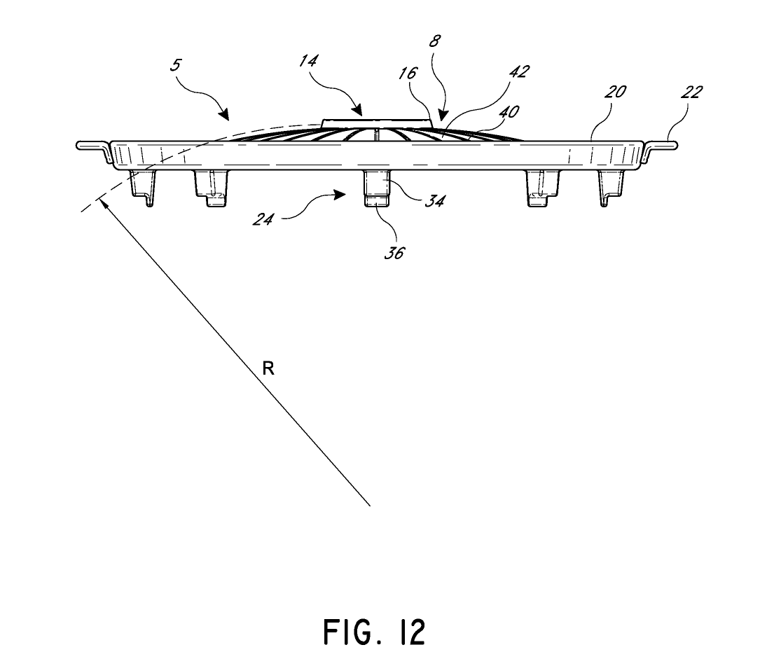

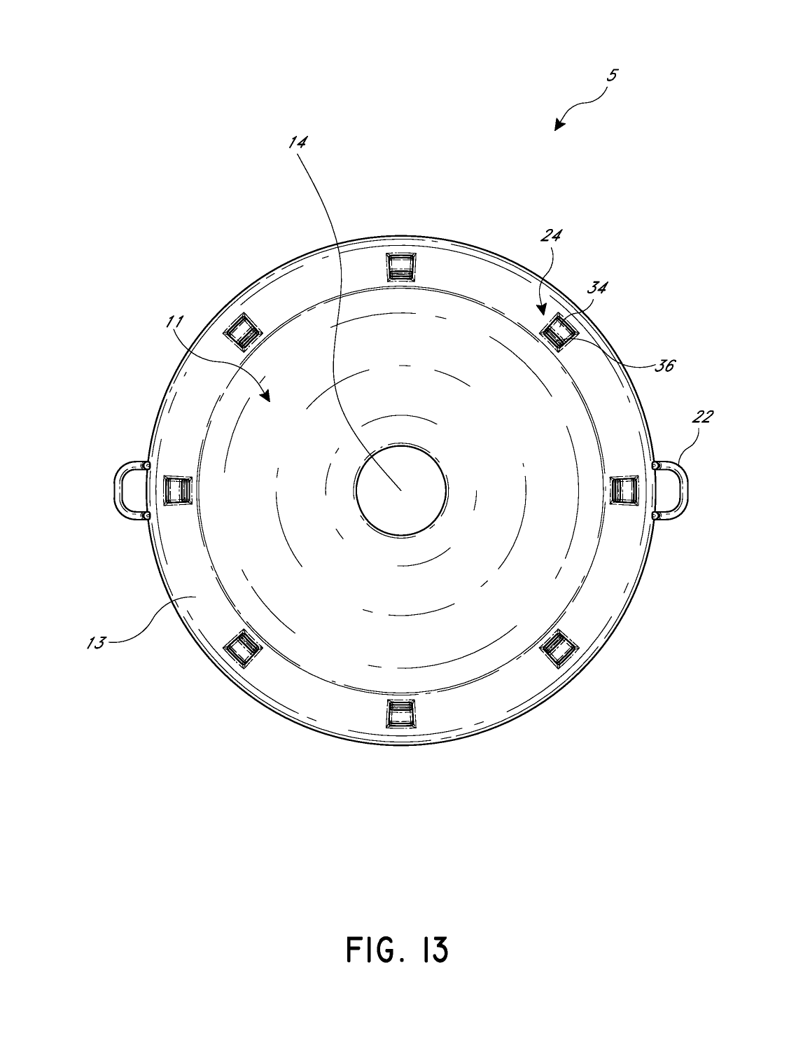

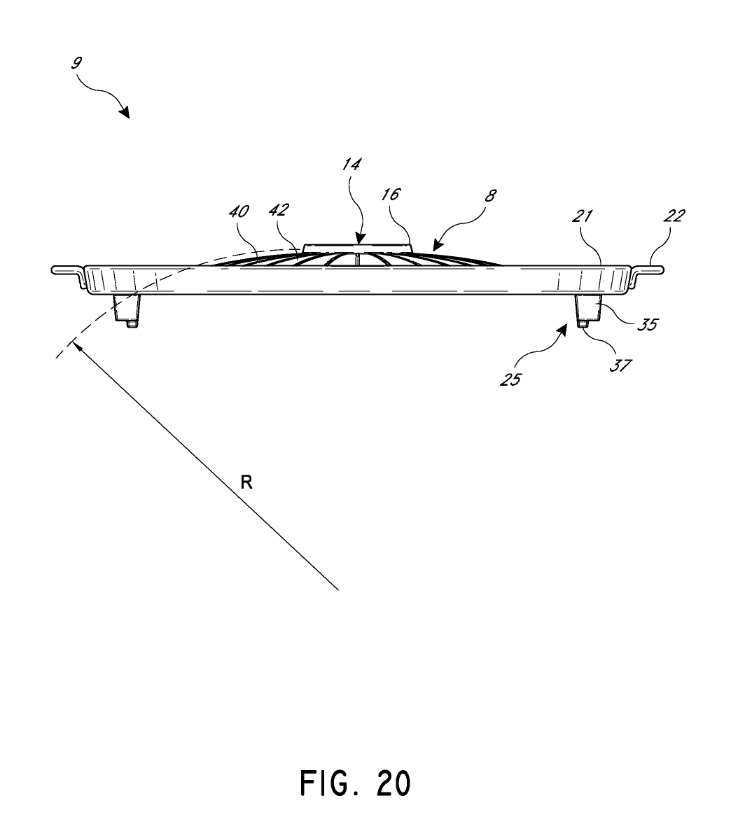

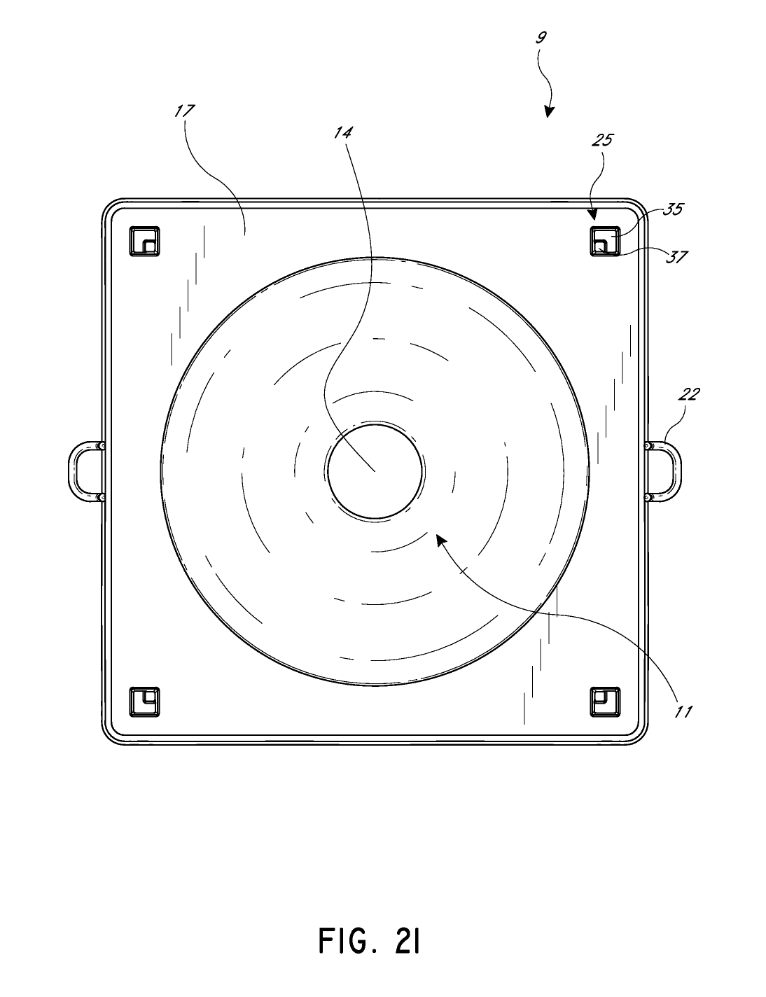

FIG. 4 illustrates a side view of an embodiment of the griddle 4. In some embodiments, the cooking surface 8 is downwardly sloped from the center axis 15 at an angle θ₁ relative to a horizontal plane (perpendicular the center axis 15) or bottom of the griddle 4. In some embodiments, angle θ₁ is constant. In some embodiments, angle θ₁ varies throughout the cooking region 8 as discussed herein, and in particular, in reference to FIGS. 12 and 20. Angle θ₁ can vary from about 0 to about 45 degrees, including about 10 to about 35, and about 15 to about 25 degrees, including ranges bordering and the foregoing values.

With an angled cooking surface 8 and a flat top or peak of the griddle 4 as formed by the center opening 14, the shape of the griddle 4, and in particular the cooking surface 8 in combination with the center opening 14, can form a general shape of a frustum. A frustum can be defined as a cone with its top cut off Other shapes can include a cone, dome, spherical, oval, and/or pyramidal shape.

The raised portions 10 can be concentric and/or coaxial as discussed herein along the cooking surface 8. In some embodiments, the raised portions 10 form a step pattern as illustrated in the side view of FIG. 4. The raised portions 10 can at least partially elevate the food relative to the cooking surface 8. The raised portions 10 can also aid in retaining the food in its initially placed position on the cooking surface 8.

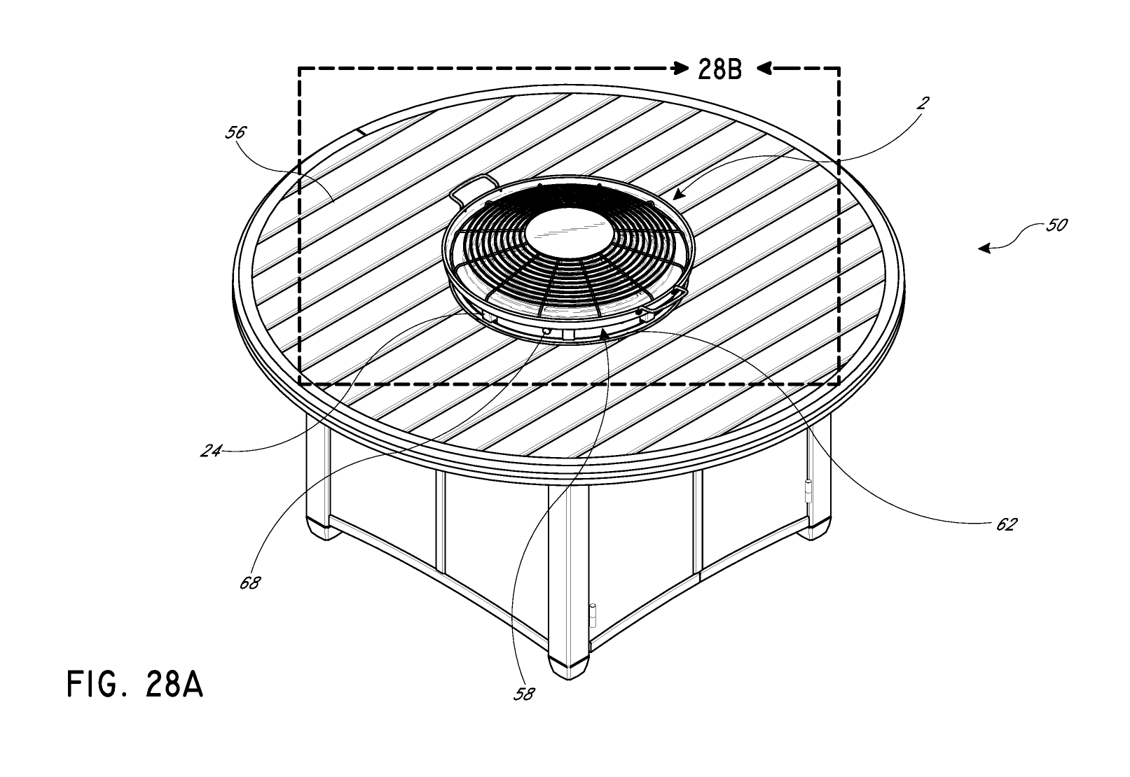

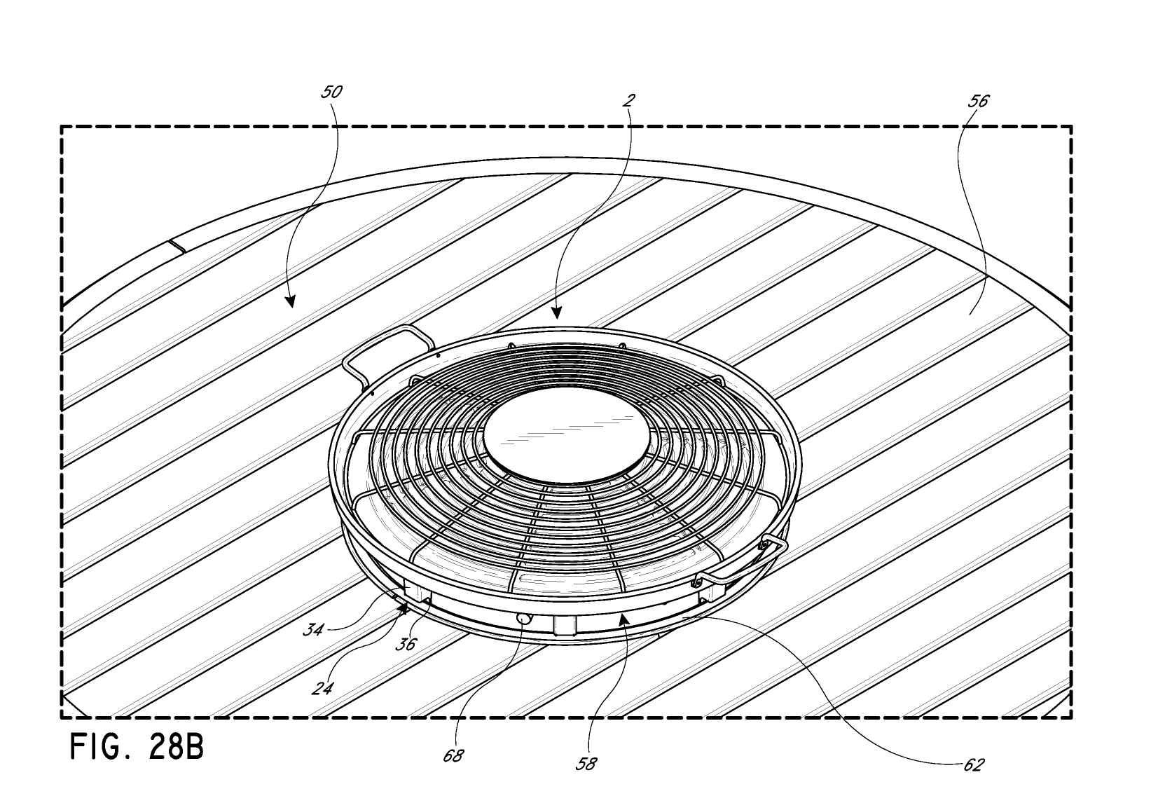

The griddle 4 (e.g., a pan) can have legs 24. The legs 24 can have a body portion 34 and protrusion portion 36. The body portion 34 can be sized and positioned on the griddle 4 for the body portion 34 to rest on a rim of an opening of a fire pit as discussed herein, and in particular, in reference to FIG. 28A-B. The protrusion portion 36 can be integrally formed with the body portion 36. In some embodiments, the protrusion portion 36 can be attached to the body portion 34 using any suitable mechanism, such as, for example, a screw, lock, solder, and/or adhesive mechanism. The body portion 36 can be connected to the griddle 4 using any suitable mechanism discussed herein, and in particular, in reference to the connection between the griddle 4 and the legs 24. The protrusion portion 36 can be sized and positioned on the body portion 34 for the protrusion portion 36 to be on an inside portion of the opening of the fire pit as discussed herein, and in particular, in reference to FIGS. 28A-B.

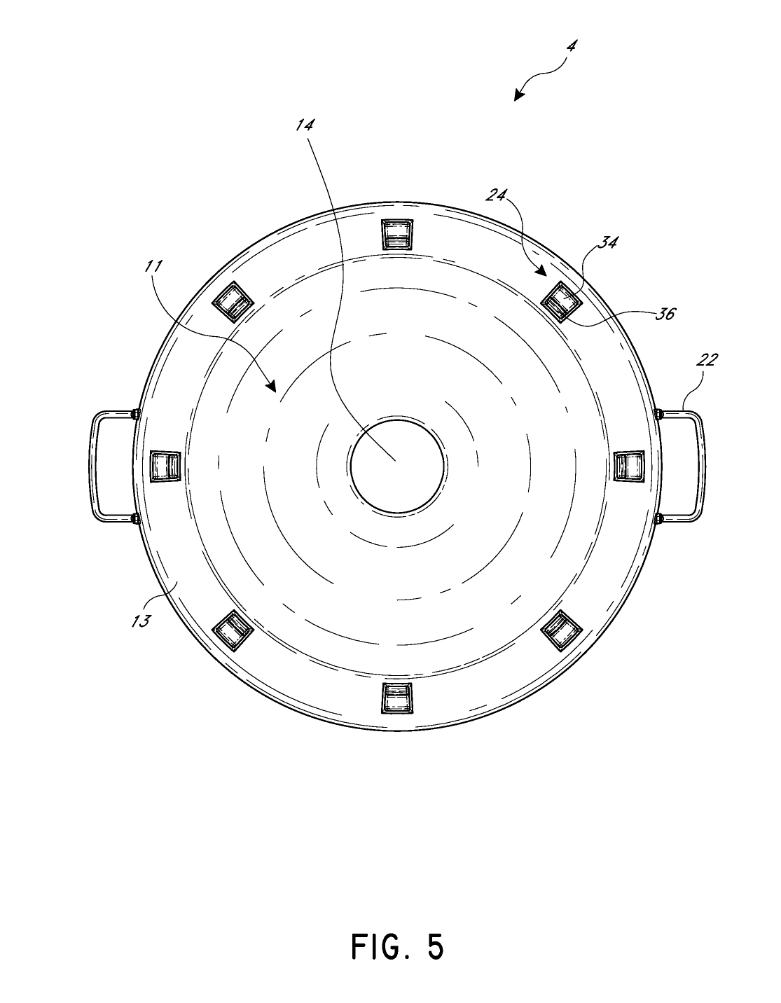

FIG. 5 illustrates a bottom view of an embodiment of the griddle 4. In some embodiments, a protrusion port 36 can extend substantially along a length of a body portion 34 of the legs 24. The body portion 34 and/or protrusion portion 36 generally follow the contour of the overall griddle 4 shape and/or the rim of the fire pit as discussed herein, and in particular, in reference to FIGS. 28A-B.

The griddle 4 can have a convection surface 11 forming at least a part of a bottom of the griddle 4. The convection surface 11 can generally correspond in shape, contour, and/or slope to the cooking surface 8 of the griddle 4 as discussed herein. The convection surface 11 can form an internal side of the frustum of the griddle 4 as discussed herein. The convection surface 11 can be generally flat. The convection surface 11 can have an upward slope at an angle θ toward the center axis 15 as discussed herein for the cooking surface 8, and in particular, in reference to FIG. 4. The convection surface 11 can be arcuate and/or concave. The convection surface can have a curvature of an arcuate and/or circular shape with a radius R as discussed herein for the cooking surface 8, and in particular, in reference to FIGS. 12 and 20.

A peripheral bottom 13 can generally correspond to the channel 18 and/or peripheral rim 20 of the griddle 4. The peripheral bottom 13 can be substantially flat in a horizontal direction or substantially perpendicular to the center axis 15 as discussed herein. The peripheral bottom 13 can transition into the convection surface 11 generally at a region corresponding to a transition between the channel 18 and the cooking surface 8. In some embodiments, the legs 24 are connected to the griddle 4 at the peripheral bottom 13.

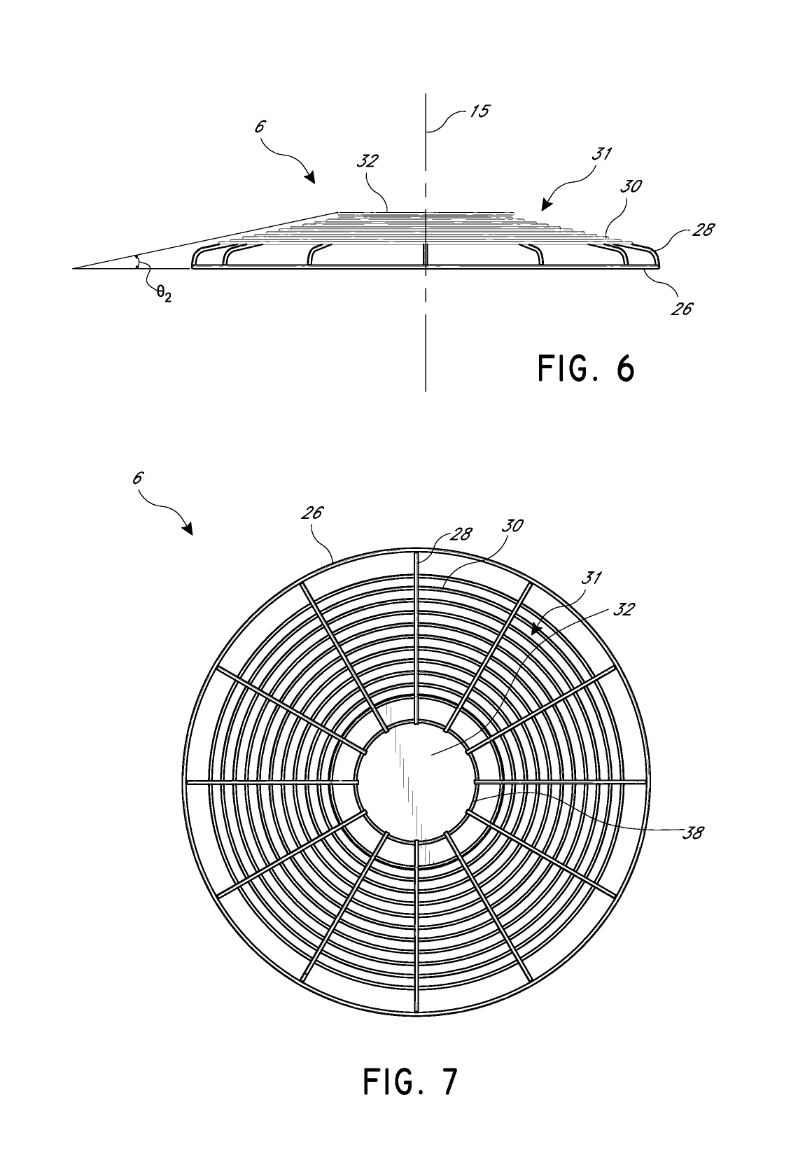

FIG. 6 illustrates a side view of an embodiment of the cooking rack 6. In some embodiments, the cooking section 31, and correspondingly the support wires 28 and/or the cooking wires 30, are downwardly sloped from the center axis 15 at an angle θ₂ relative to a horizontal plane (perpendicular the center axis 15). In some embodiments, angle θ₂ is constant. In some embodiments, angle θ₂ varies through the cooking region 8 as discussed herein, and in particular, in reference to FIGS. 12 and 20. Angle θ₂ can vary from about 0 to about 45 degrees, including about 10 to about 35, and about 15 to about 25 degrees, including ranges bordering and the foregoing values.

With an angled cooking section 31 and a flat top or peak of the cooking rack 6 as formed by the center plate 32, the shape of the cooking rack 6, and in particular the cooking section 31 in combination with the center plate 31, can form a general shape of a frustum as discussed herein. Other shapes can include a cone, dome, spherical, oval, and/or pyramidal shape.

The cooking wires 30 can be concentric and/or coaxial as discussed herein along the cooking section 31. In some embodiments, the cooking wires 30 form a step pattern as illustrated in the side view of FIG. 6. The cooking wires 30 can also aid in retaining the food in its initially placed position on the cooking section 31.

FIG. 7 illustrates a bottom view of an embodiment of the cooking rack 6. In some embodiments, the support wires 28 can lead from the periphery wire 26 to a center point of the cooking rack 6. The support wires 28 can terminate under the center plate 32. The support wires 28 can be connected to or formed integrally with the center plate 32 as discussed herein. The support wires 28 can be connected to or formed integrally with a support ring 38. The support ring 38 can be connected to the center plate 32 to form at least a partially rigid cooking rack 6.

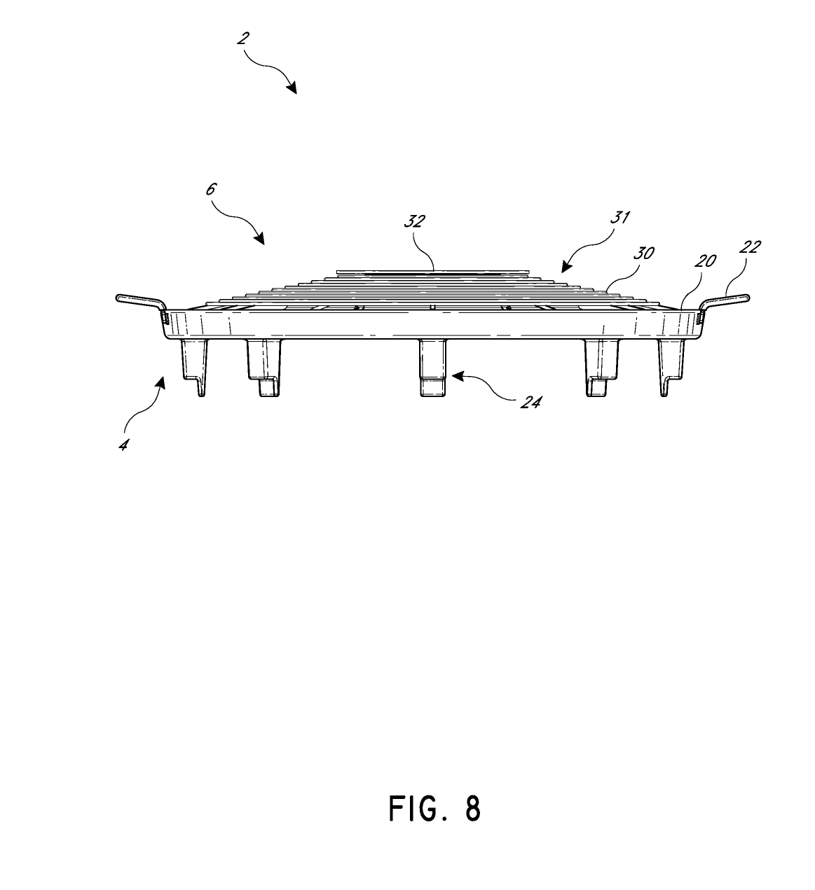

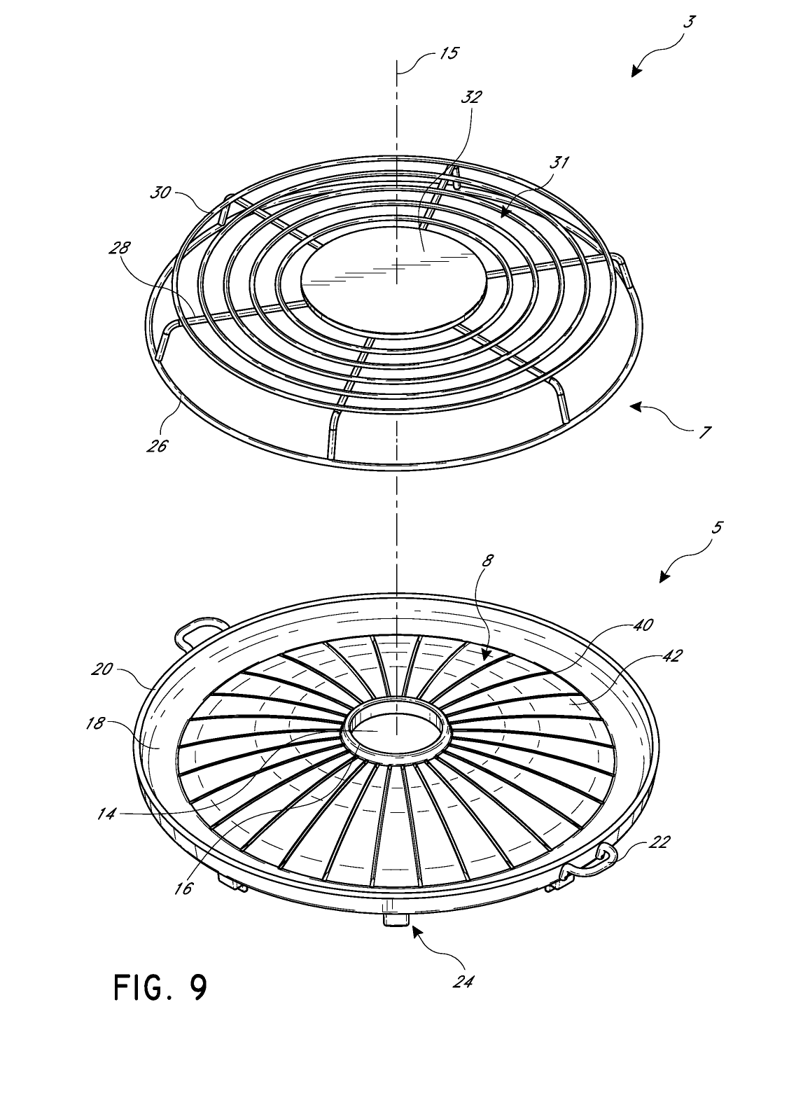

FIG. 8 illustrates a side view of an embodiment of the cooking grill 2. The cooking rack 6 can be on the griddle 4 as discussed herein. The shape, contour, and/or slope of the cooking section 31 of the cooking rack 6 can generally follow the shape, contour, and/or slope of the cooking surface 8 of the griddle 4. The peripheral rim 20 can bound the periphery wire 26 to inhibit movement of the cooking rack 6 in at least the horizontal direction. The cooking grill 2 can include various other features and functions as discussed herein for some embodiments, and in particular, in reference to FIGS. 9-28B.

FIG. 9 illustrates a top perspective exploded view of an embodiment of a cooking grill 3. The embodiment of the cooking grill 3 illustrated in FIG. 9 can include generally similar features and functions of a cooking surface 8, peripheral bottom 13 (see FIG. 13), convection surface 11 (see FIG. 13), center opening 14, center axis 15, inner rim 16, channel 18, periphery rim 20, handles 22, legs 24, periphery wire 26, support wires 28, cooking wires 30, cooking section 31, and/or center plate 32 as discussed herein. The cooking grill 2 can include various other features and functions as discussed herein for other embodiments, and in particular, in reference to FIGS. 1-8 and 17-28B.

The griddle 5 can have grooves 40 that radiate from the center axis 15 to a periphery of the griddle 5. The grooves 40 can be raised relative to the cooking surface 8. The grooves 40 can elevate at least a portion of the food above the cooking surface 8. Raised grooves 40 can form scallops 42. The scallops 42 can direct cooking juices toward the periphery or the channel 18 of the griddle 5.

In some embodiments, the grooves 40 can be recessed or indented relative to the cooking surface 8. Recessed grooves 40 can form scallops 42. Recessed grooves 40 can direct cooking juices toward the periphery or the channel 18 of the griddle 5.

The cooking rack 7 can have fewer, but relatively thicker cooking wires 30 then some embodiments of the cooking rack 6 as discussed herein. The cooking wires 30 can impart sear marks on the food.

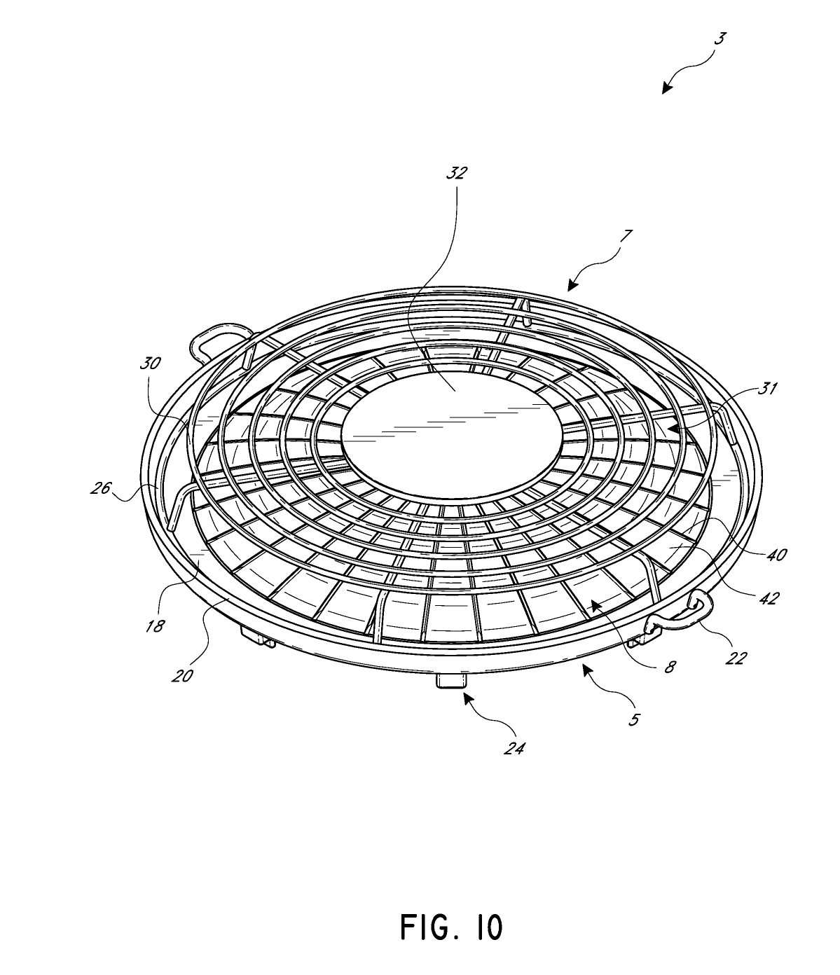

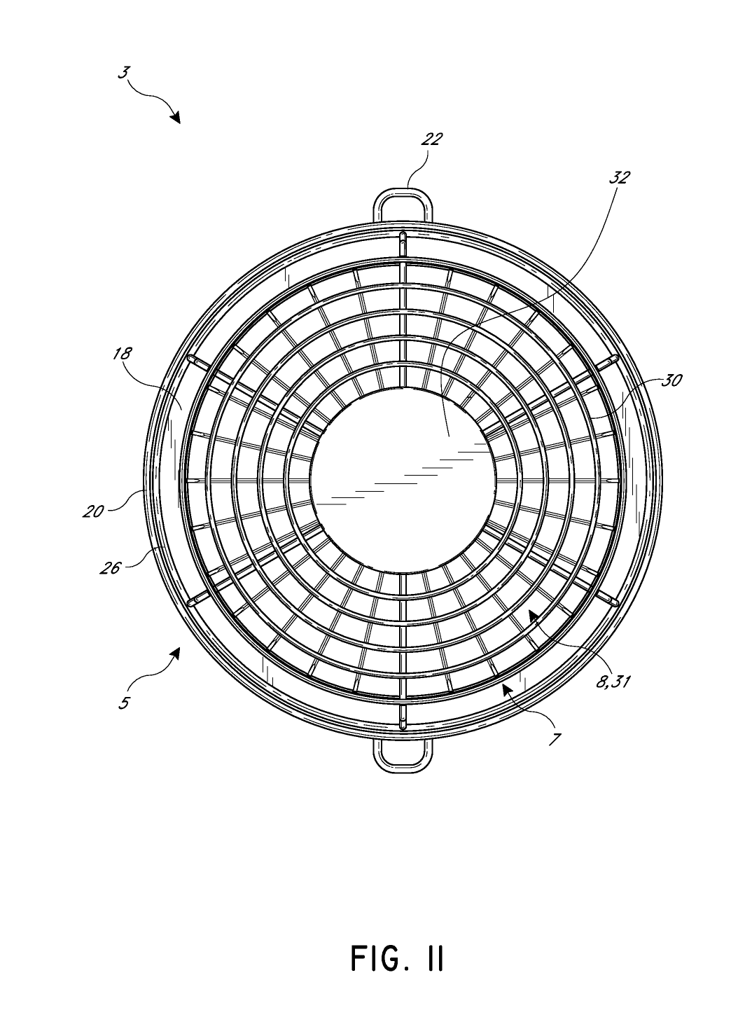

FIG. 10 illustrates a top perspective view of an embodiment of the cooking grill 3. The cooking rack 7 can be on and/or mate with the griddle 5 as discussed herein. The griddle 5 can inhibit at least horizontal movement of the cooking rack 7.

FIG. 11 illustrates a top view of an embodiment of the cooking grill 3. The center plate 32 of the cooking rack 7 can substantially cover the center opening 14 of the griddle 4. The cooking region 31 of the cooking rack 7 can substantially coincide with the cooking surface 8 of the griddle 5.

FIG. 12 illustrates a side view of an embodiment of the griddle 5. In some embodiments, the cooking surface 8 has a curvature of an arcuate and/or circular shape with a radius R. In some embodiments, the radius R varies throughout the cooking surface 8. For example, the radius R of the cooking surface 8 could be relatively smaller near the channel 18 or periphery of the griddle 5 and increase for the cooking surface 8 near to the center axis 15 or center opening 14. As another example, the radius R of the cooking surface 8 can be relatively larger near the periphery and/or center opening 14 and increase between the periphery and/or center of the griddle 5. As another example, the radius R of the cooking surface 8 can be relatively smaller near the periphery and/or center opening 14 and decrease between the periphery and/or center of the griddle 5. Radius R can vary between about 10 to about 100 inches, including about 15 to about 50 and about 20 to 25 inches, including ranges bordering and the foregoing values. The arcuate and/or circular cooking surface 8 can be sloped at an angle θ as discussed herein, and in particular, in reference to FIG. 4.

FIG. 13 illustrates a bottom view of an embodiment of the griddle 5. The griddle 5 can have a convection surface 11 forming at least a part of the bottom of the griddle 5. The convection surface 11 can generally correspond in shape, contour, and/or slope to the cooking surface 8 of the griddle 5. The convection surface 11 can form an internal side of the frustum of the griddle 5 as discussed herein. The convection surface 11 can be generally flat. The convection surface 11 can have an upward slope at an angle θ toward the center axis 15 as discussed herein for the cooking surface 8, and in particular, in reference to FIG. 4. The convection surface 11 can be arcuate and/or concave. The convection surface 11 can have a curvature of an arcuate and/or circular shape with a radius R as discussed herein for the cooking surface 8, and in particular, in reference to FIGS. 12 and 20.

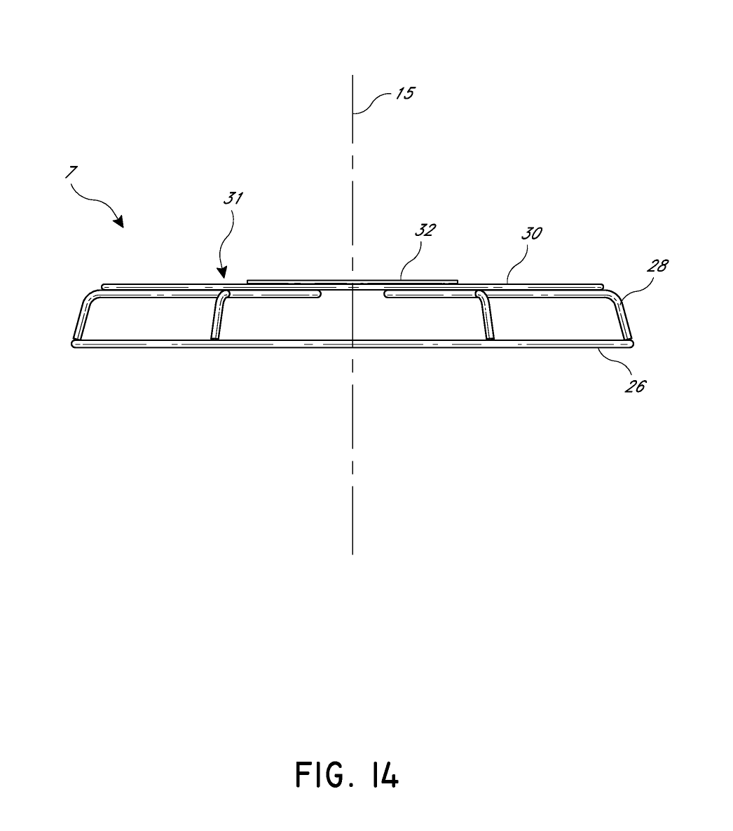

FIG. 14 illustrates a side view of an embodiment of the cooking rack 7. The cooking rack 7 can have support wires 28 are substantially vertically rise from the periphery wire 26. The support wires 28 can radiate toward the center axis 15 generally horizontally or substantially perpendicular to the center axis 15. The cooking wires 30 can be on or be integral with the support wires 28 as discussed herein to form a generally horizontal cooking section 31.

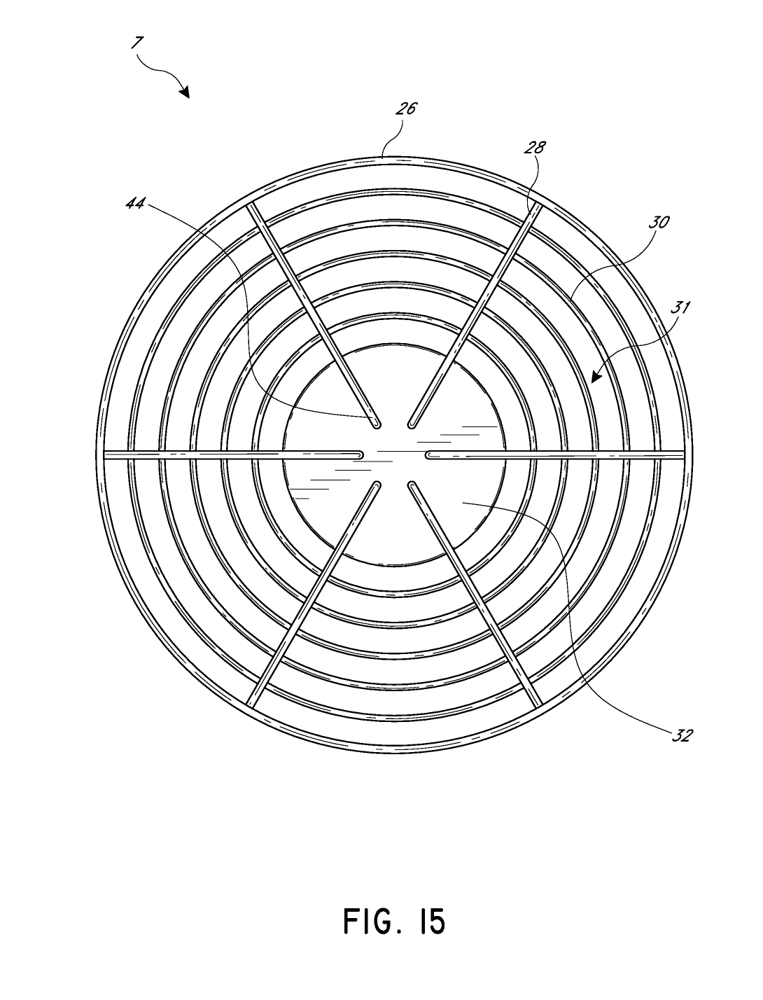

FIG. 15 illustrates a bottom view of an embodiment of the cooking rack 7. In some embodiments, the support wires 28 can lead from the periphery wire 26 to a center point of the cooking rack 6. The support wires 28 can terminate under the center plate 32 at ends 44 away from the center of the cooking rack 7. The support wires 28 can be connected to or formed integrally with the center plate 32 as discussed herein to form at least a partially rigid cooking rack 7.

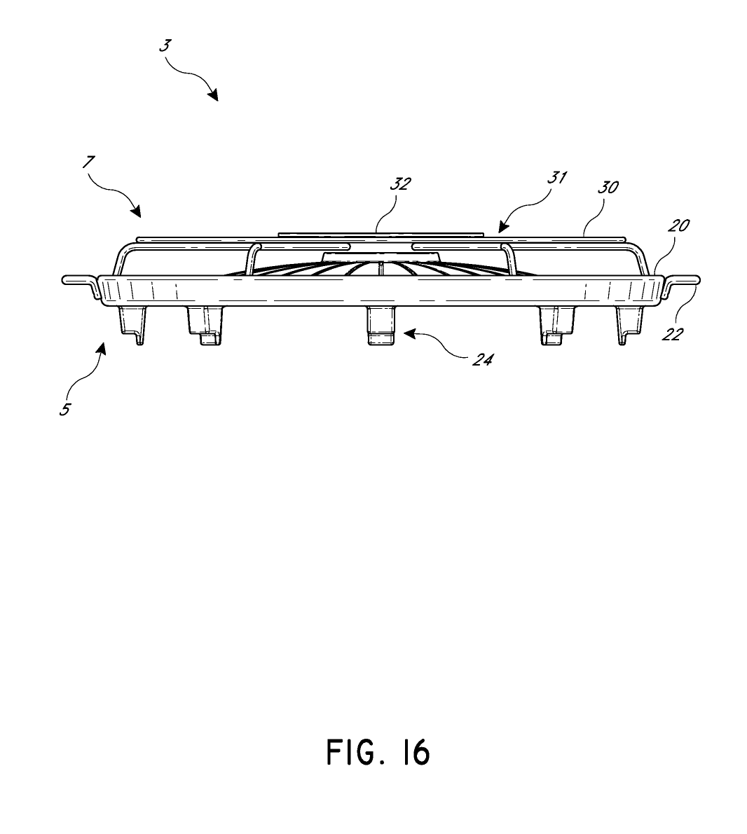

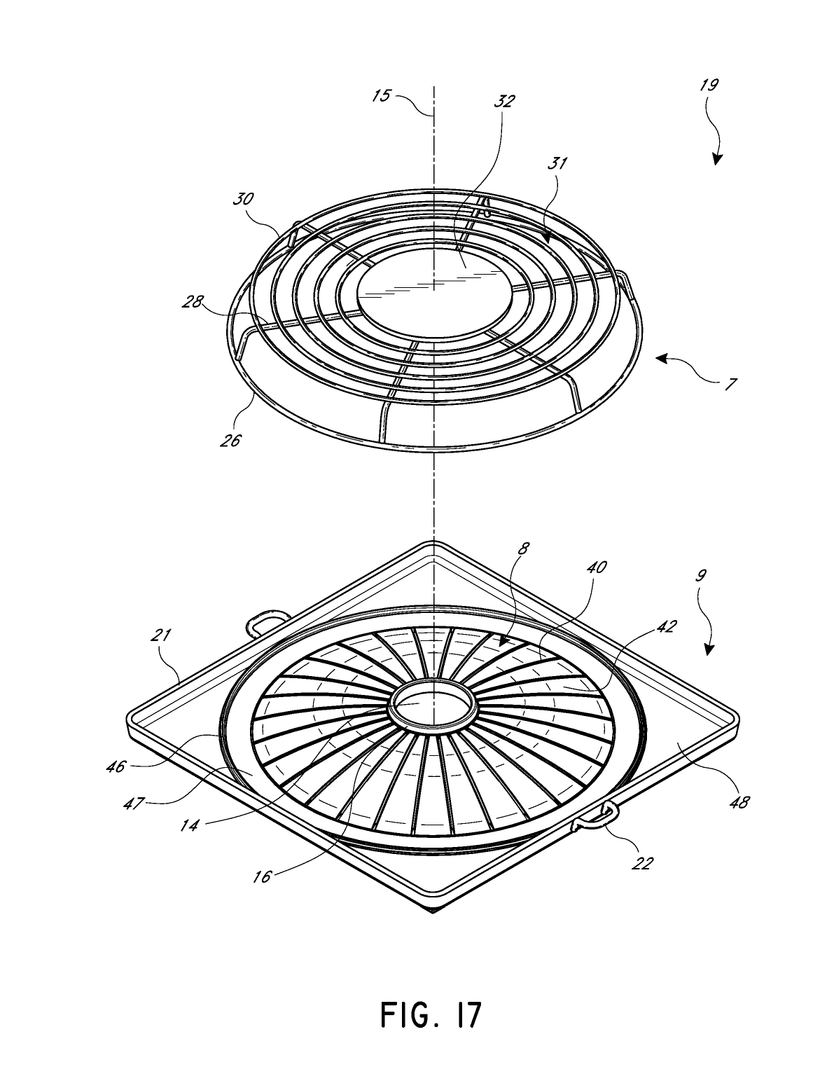

FIG. 16 illustrates a side view of an embodiment of the cooking grill 3. The cooking rack 7 can be on and/or mate with the griddle 5 as discussed herein. The cooking rack 7 can provide a generally horizontal cooking section 31. Various heat zones as discussed herein can correspond to various portions of the cooking section 31. For example, a hotter cooking zone can be toward the center of the cooking grill 3.

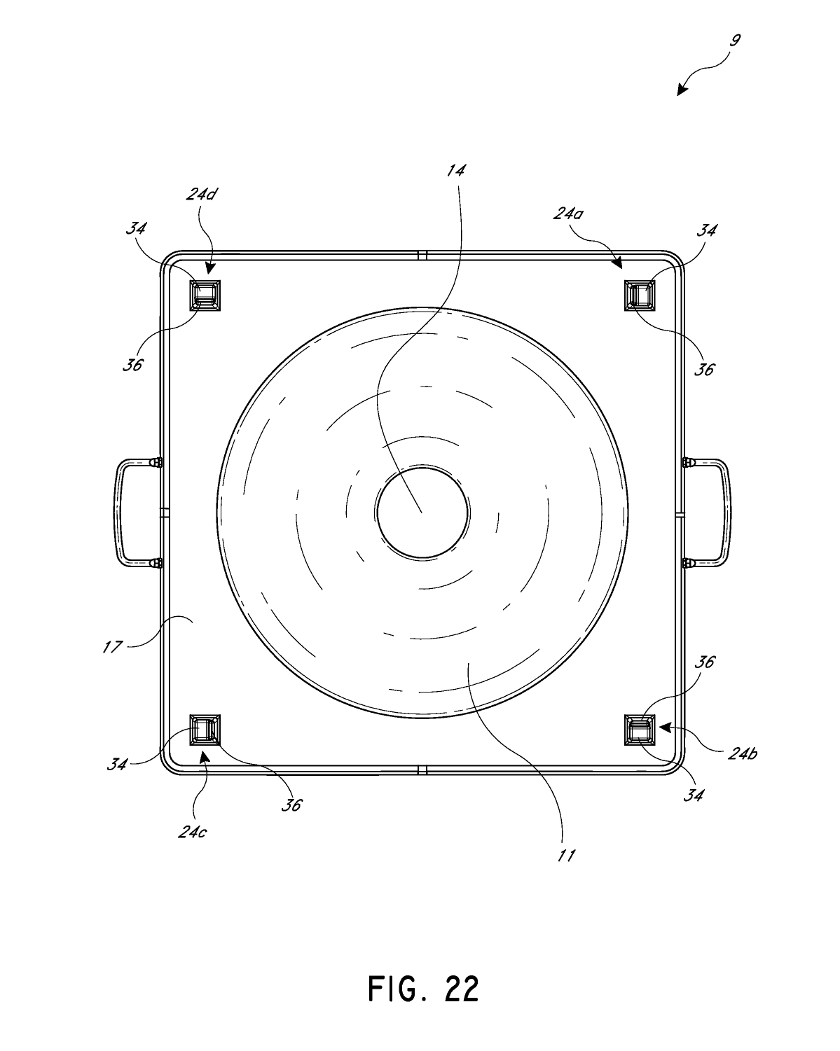

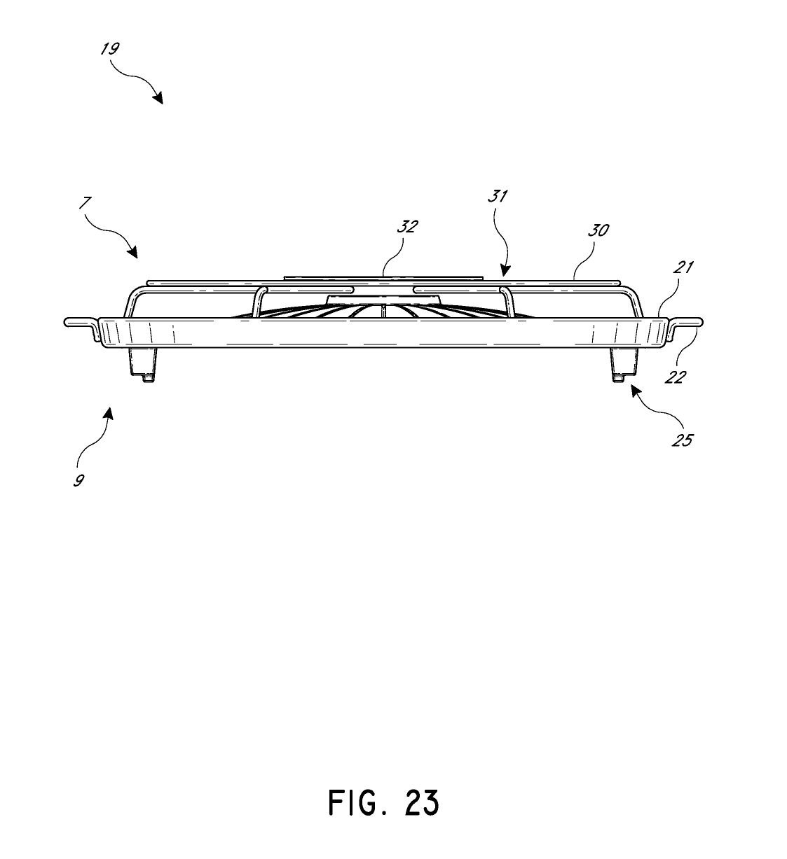

FIG. 17 illustrates a top perspective exploded view of an embodiment of a cooking grill 19. The embodiment of the cooking grill 19 illustrated in FIG. 17 can include generally similar features and functions of a cooking surface 8, peripheral bottom 17 (see FIGS. 21 and 22), convection surface 11 (see FIGS. 21 and 22), center opening 14, center axis 15, inner rim 16, channel 18, periphery rim 20, handles 22, legs 24, periphery wire 26, support wires 28, cooking wires 30, cooking section 31, center plate 32, grooves 40, and/or scallops 42 as discussed herein. The cooking grill 19 can include various other features and functions as discussed herein for some embodiments, and in particular, in reference to FIGS. 1-6 and 24-28B.

A griddle 9 of the cooking grill 19 can have a periphery rim 21 that is substantially square. The square periphery rim 21 can have, for example, rounded corners. The griddle 9 can be used with fire pits or other stoves having square openings for burners and burning or hot media. The griddle 9 can be used with fire pits or other stoves having circular openings for burners and burning or hot media. The griddle 9 can have a lip 46. The lip 46 can be substantially circular. The lip 46 can form a channel 47 between a cooking surface 8 and a landing surface 48. The landing surface 48 can be formed between the periphery rim 21 and the cooking surface 8 or the lip 46. The landing surface 48 can accommodate legs 24, 25 as discussed herein, and in particular, in reference to FIGS. 20-22.

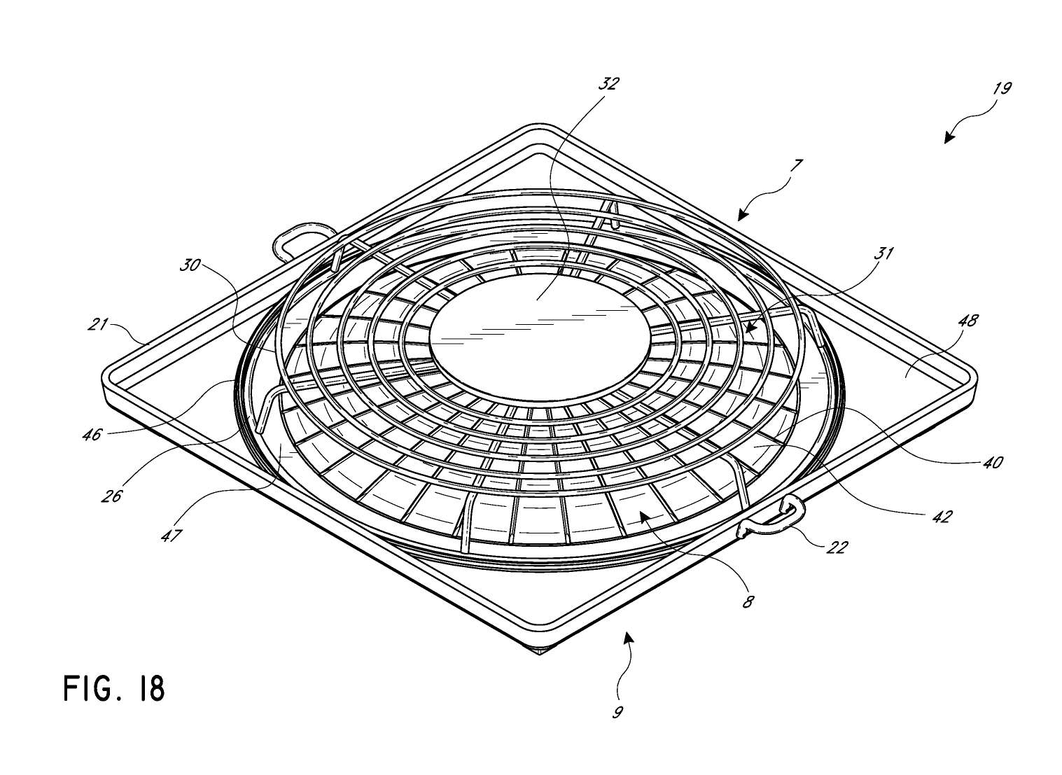

FIG. 18 illustrates a top perspective view of an embodiment of the cooking grill 19. The cooking rack 7 can be on and/or mate with the griddle 9 as discussed herein. A periphery rim 26 can rest inside and/or mate with the lip 46. The lip 46 can inhibit movement of the cooking rack 7 in at least one direction. For example, the lip 46 can inhibit movement of the cooking rack 7 in a horizontal direction by bounding the periphery rim 26. The lip 46 can further provide an interference fit and/or snap fit mechanism to inhibit upward movement of the cooking rack 7 once the lip 46 bounds the peripheral wire 26.

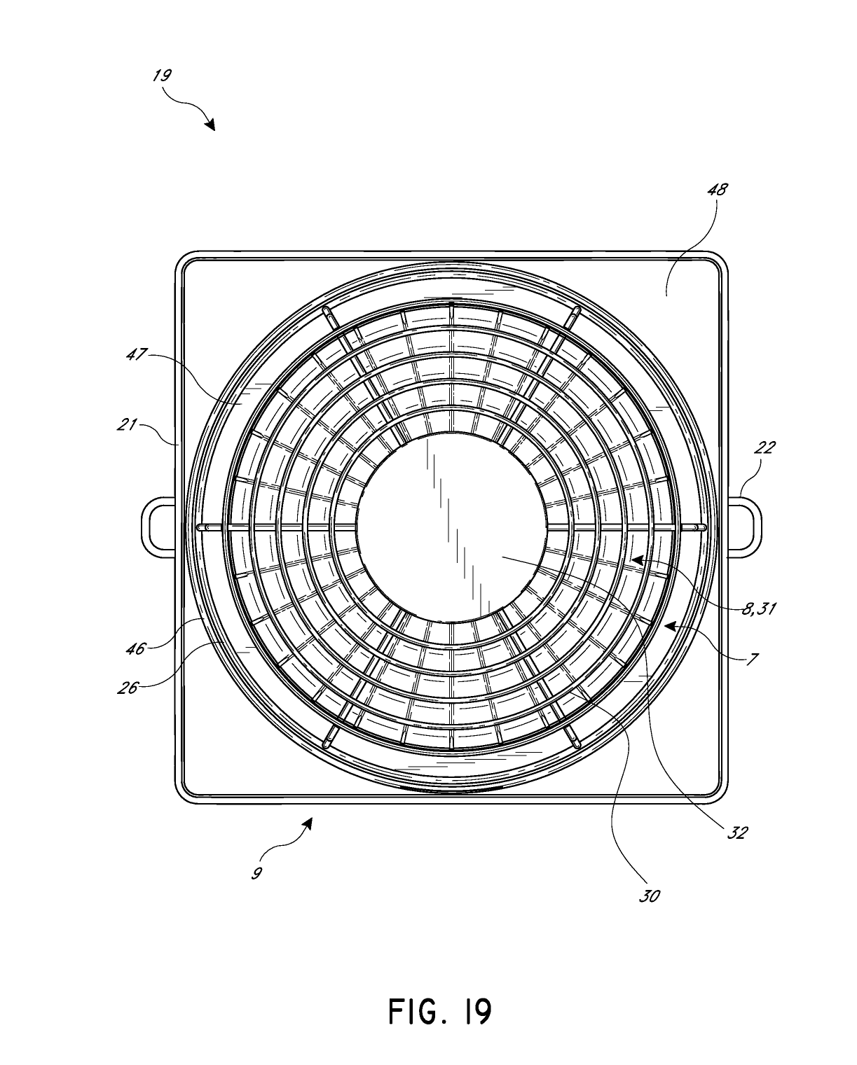

FIG. 19 illustrates a top view of an embodiment of the cooking grill 19. The cooking region 31 of the cooking rack 7 can substantially coincide with the cooking surface 8 of the griddle 9. The lip 46 can be substantially adjacent to the periphery rim 21 at four points where the circular lip 46 coincides with the sides of the square periphery rim 21 when the lip 46 is sized to fit just within the periphery rim 21. In some embodiments, the landing area 48 extends completely around the lip 46, between the periphery rim 21 and the lip 46.

FIG. 20 illustrates a side view of an embodiment of the griddle 9. A cooking surface 8 of the griddle 9 can have a curvature of an arcuate and/or circular shape with a radius R as discussed herein. The cooking surface 8 can be sloped at an angle θ as discussed herein.

The griddle 9 can have legs 25. The legs 25 can be integrally formed with the griddle 9. In some embodiments, the legs 25 can be connected to the griddle 9 using any suitable mechanism, such as, for example, a screw, lock, solder, and/or adhesive mechanism. The legs 25 can have a body portion 35 and protrusion portion 37. The body portion 35 can be sized and positioned on the griddle 9 for the body portion 35 to rest on a square rim of an opening of a fire pit as discussed herein, such as analogously in reference to FIGS. 28A-B for a circular fire pit opening.

The protrusion portion 37 can be integrally formed with the body portion 35. In some embodiments, the protrusion portion 37 can be attached to the body portion 35 using any suitable mechanism, such as, for example, a screw, lock, solder, and/or adhesive mechanism. The body portion 35 can be connected to the griddle 9 using any suitable mechanism discussed herein, and in particular, in reference to the connection between the griddle 9 and the legs 25. The protrusion portion 37 can be sized and positioned on the body portion 35 for the protrusion portion 37 to be on an inside portion of the opening of the fire pit as discussed herein, and in particular, in reference to FIGS. 28A-B.

FIG. 21 illustrates a bottom view of an embodiment of the griddle 9. The griddle 9 can have a convection surface 11 as discussed herein, which can correspond in shape, contour, and/or slope to the cooking surface 8 of the griddle 4.

A peripheral bottom 17 of the griddle 9 can generally correspond to the landing surface 48, channel 18, and/or peripheral rim 21 of the griddle 4. The peripheral bottom 17 can be substantially flat in a horizontal direction or perpendicular to the center axis 15 as discussed herein. The peripheral bottom 17 can transition into the convection surface 11 generally at a region corresponding to a transition between the channel 18 and the cooking surface 8. The legs 24 can be connected to the griddle 9 at the peripheral bottom 17.

In some embodiments, a leg 25 has a protrusion portion 37 that projects from an inner corner of the body portion 35. The protrusion portion 37 can be relatively smaller than the body portion 35. The protrusion portion 37 can be generally square for the protrusion portion 37 to slide inside a corner of a square opening of a fire pit. Thus, the legs 35 can be positioned on the griddle 9 for the body portions 35 to rest on the rim at the corners and for the protruding portions 37 to slide against an inside of the corners of the square opening of the fire pit. The protrusion portions 37 can inhibit motion of the griddle 9 relative to the opening of the fire pit in at least one direction, such as, for example, the horizontal direction. In some embodiments, the protrusion portions 37 have an interference fit and/or snap fit mechanism with the rim of the fire pit to inhibit upward movement once the protrusion portions are engaged with the rim of the fire pit as discussed herein, and in particular, in reference to FIGS. 28A-B.

FIG. 22 illustrates a bottom view of an embodiment of the griddle 19. In some embodiments, the legs 24a-d can have a body portion 34 and protruding portion 36 as discussed herein, and in particular, in reference to FIGS. 4 and 5. The protruding portions 36 can extend along a length of the body portion 34. The protruding portions 36 can be substantially straight to generally follow the contour of the square periphery of the griddle 9 and/or a square opening of a fire pit. The protruding portions 36 can be rotated about 90 degrees relative to each other. The protruding portion 36 of leg 24a can be rotate 90 degrees relative to the protruding portion 36 of leg 24b. The protruding portion 36 of leg 24b can be rotate 90 degrees relative to the protruding portion 36 of leg 24c. The protruding portion 36 of leg 24c can be rotate 90 degrees relative to the protruding portion 36 of leg 24d. The protruding portion 36 of leg 24d can be rotate 90 degrees relative to the protruding portion 36 of leg 24a. When the griddle 9 rests on a square rim of an opening of a fire pit as discussed herein, such as analogously in reference to FIGS. 28A-B for a circular fire pit opening, the protruding portions 36 can be against an inside of the square rim at or near the corners to inhibit movement of the griddle 19 in at least one direction as discussed herein.

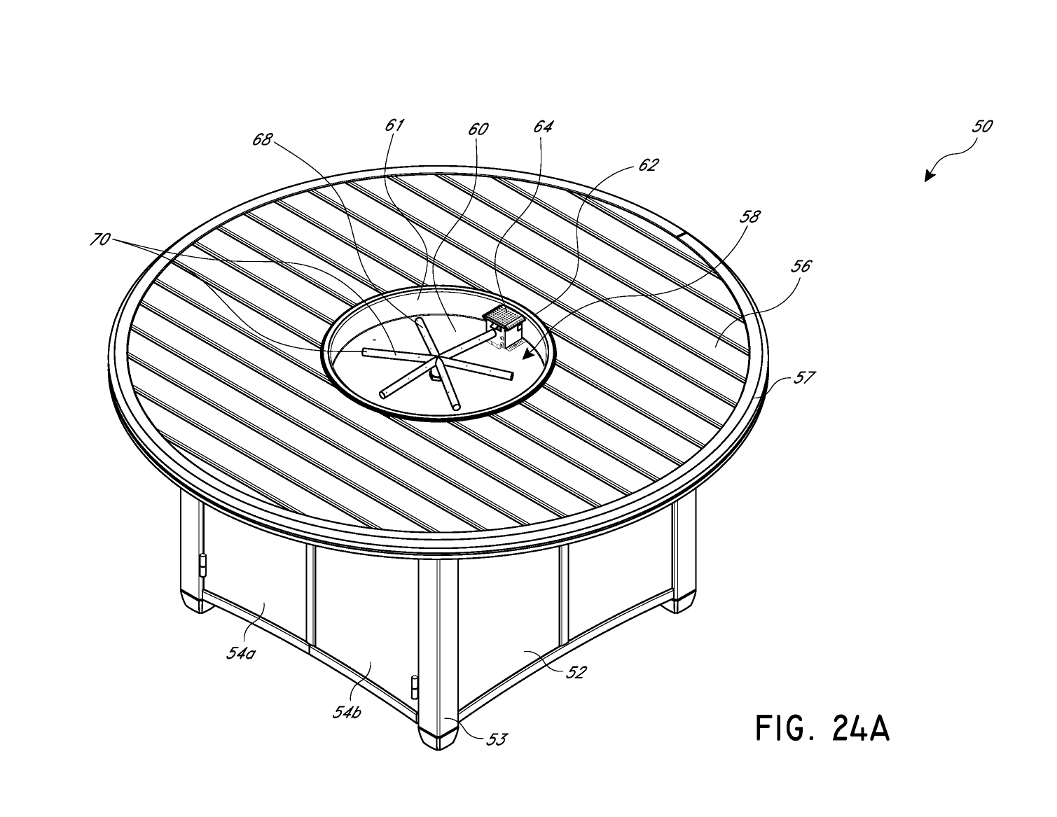

FIG. 23 illustrates a side view of an embodiment of the cooking grill 19. The cooking rack 7 can be on the griddle 9 as discussed herein. The cooking rack 7 can provide a generally horizontal cooking section 31. Various heat zones as discussed herein can correspond to various portions of the cooking section 31. For example, a hotter cooking zone can be toward the center of the cooking grill 19.

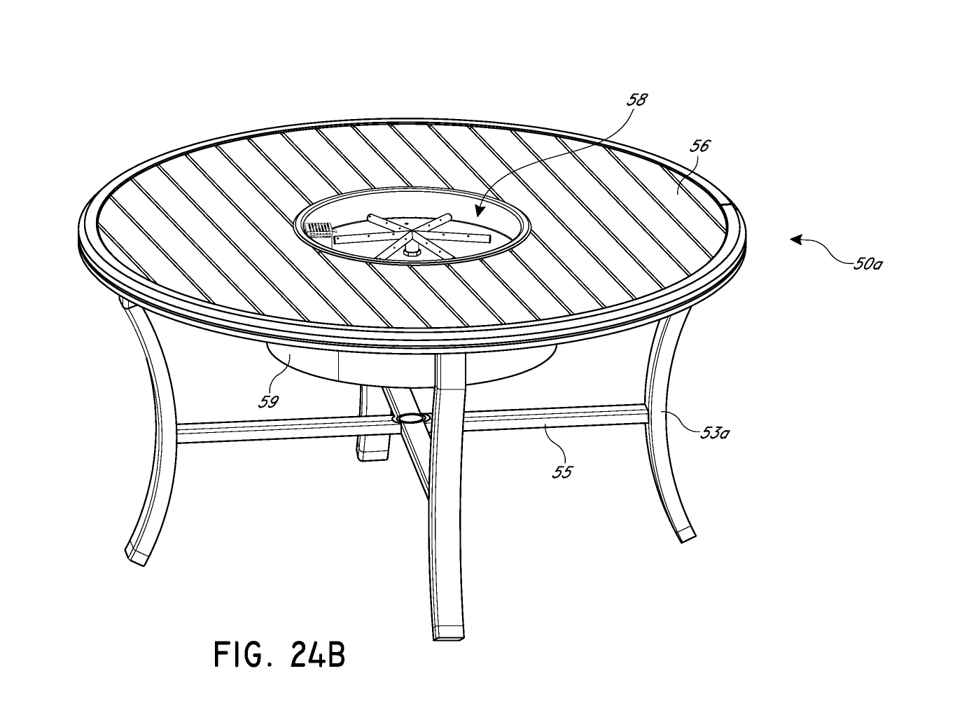

FIG. 24A illustrates a top perspective view of an embodiment of a fire pit 50 (e.g., a table with a fire pit). The fire pit 50 can have walls 52 between posts 53. The posts 53 can rest on the floor or ground below to provide support for the fire pit 50. The fire pit 50 can have double doors 54a, 54b. The doors 54a, 54b can swing open to reveal a space or compartment for storing the mechanisms for the fire pit 50 to function (i.e., combustion of fuel on the burners. The fire pit 50 can be a propane and/or natural gas fire pit. A propane tank can be housed within the walls 52 and doors 54a, 54b. In some embodiments, fire pit 50 can connect to and house a 1 lbs. propane tank for portability (i.e., for use during camping). In some embodiments, the fire pit 50 can connect to and house a 20 lbs. or any other size propane tank for longer fuel combustion time.

The fire pit 50 can have a tabletop 56. The tabletop 56 can be bound by a border 57. The tabletop 56 and border 57 can be circular. In some embodiments, the tabletop 56 and border 57 can be square. In some embodiments, the tabletop 56 and frame 57 can be any suitable shape, such as, for example, rectangular, triangular, oval, or other polygonal and/or round shapes.

The tabletop 56 can have an opening 58 (e.g., burner tray). The opening 58 can be generally round or circular as discussed herein. In some embodiments, the opening 58 can be square. In some embodiments, the opening 58 can be other suitable shapes, such as, for example, square, rectangular, triangular, oval, or other polygonal and/or round shapes. The opening 58 can be about 12 to about 18 inches in at least one dimension, including a diameter or a side.

FIG. 24B illustrates a top perspective view of another embodiment of a fire pit 50a (e.g. a round table with a round fire pit). The fire pit 50a can have posts 53a similar to a conventional patio table. The posts 53a can rest on the floor or ground below to provide support for the fire pit 50a. The posts 53a can connect to supports 55 to help provide structural integrity to the fire pit 50a. The fire pit 50a can have a housing 59 for enclosing fuel combustion components as discussed herein, such as for example, a fuel connector 76, burner tray 58, and/or fuel, and supporting a user interface, such as for example, a controller 72. The housing 59 can have a door or other features to allow access to fuel combustion components. In some embodiments, the fire pit 50a can be assembled and disassembled quickly for portability (i.e., for use during camping). Assembly and disassembly can include engaging and disengaging the supports 55.

The fire pit 50a can have a tabletop 56. The tabletop 56 can be circular. In some embodiments, the tabletop 56 can be square. In some embodiments, the tabletop 56 can be any suitable shape, such as, for example, rectangular, triangular, oval, or other polygonal and/or round shapes. The fire pit 50a can have other features as described herein for the fire pit 50 with doors 54a, 54b.

The opening 58 can have a bottom 60. The opening 58 can be bounded by and/or connect to an inner wall 61. The inner wall 61 can be bounded by and/or connect to an inner rim 62. The inner rim 62 can protrude above the tabletop 56 level. In some embodiments, the inner rim 62 can be generally at the tabletop 56 level. The opening (or burner tray) 58 can contain burning or hot reusable media. The media can include stones, glass, or other materials suitable to withstand heat generated by the burners of the fire pit. In some embodiments, the opening or burner tray 58 can contain charcoal and/or wood to provide a source heat and/or light luminescence as discussed herein. In some embodiments, the burner tray 58 can house an electric heater to provide a source of heat and/or light luminescence as discussed herein.

In some embodiments, the burner tray 58 can house a pilot fire box 64. The pilot fire box 64 can be connected to the internal mechanisms of the fire pit such as, for example, a propane tank and an air intake. The pilot fire box 64 can be connected to burners 68. The burners 68 can be connected to the internal mechanisms of the fire pit such as, for example, the propane tank and the air intake.

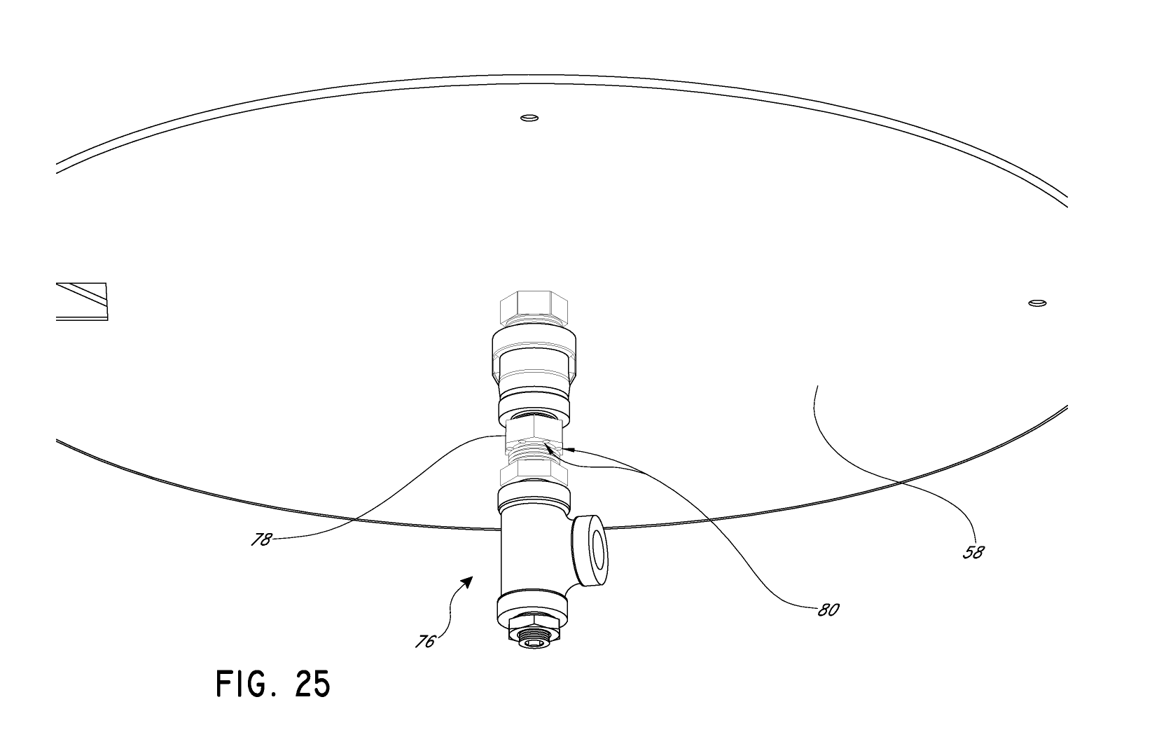

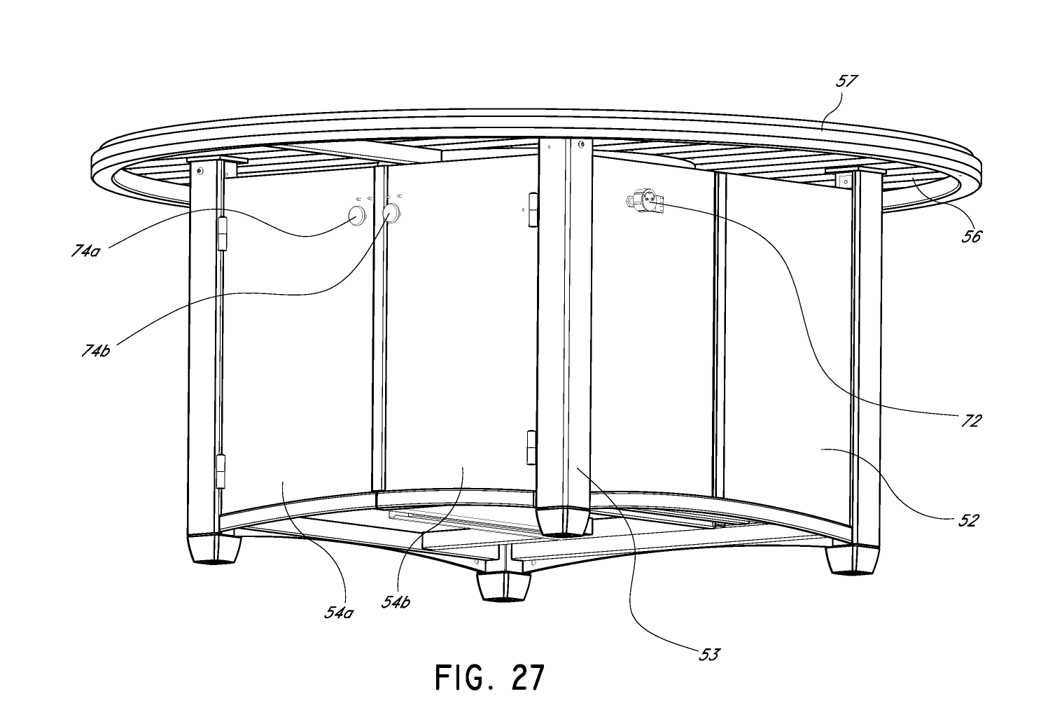

In some embodiments, the fire pit 50 uses liquefied petroleum fuel. Liquefied petroleum can have many elements that are used during the manufacture of the fuel, which can result in fuel combustion with byproducts and soot buildup. The fire pit 50 can use air induction in the fuel stream to mitigate byproducts and soot buildup during combustion. Air induction can include forced air and/or drawn air through venturi induction. FIG. 25 illustrates a bottom perspective view of a burner tray 58 with a fuel connect 76. The fuel connect 76 can have a fuel orifice 78 with venturi openings (or air induction ports) 80. The venturi openings 80 can be located close to the point of combustion (i.e., relatively close to the burners 68) to aid in efficient fuel combustion and reduce undesirable pressure variances. Air and fuel can be induced by creating negative pressure at the fuel orifice 78. The BTU rating of the fire pit 50 can be based at least partly on the specific arrangement and vicinity of the fuel connecter 76, including fuel orifice 78 and fuel venturi openings 80. The fuel connect 76 can operably connect to a controller 72 of the fire pit 50 (see FIG. 27) to regulate combustion rate, flame height, and/or flame luminescence as discussed herein.

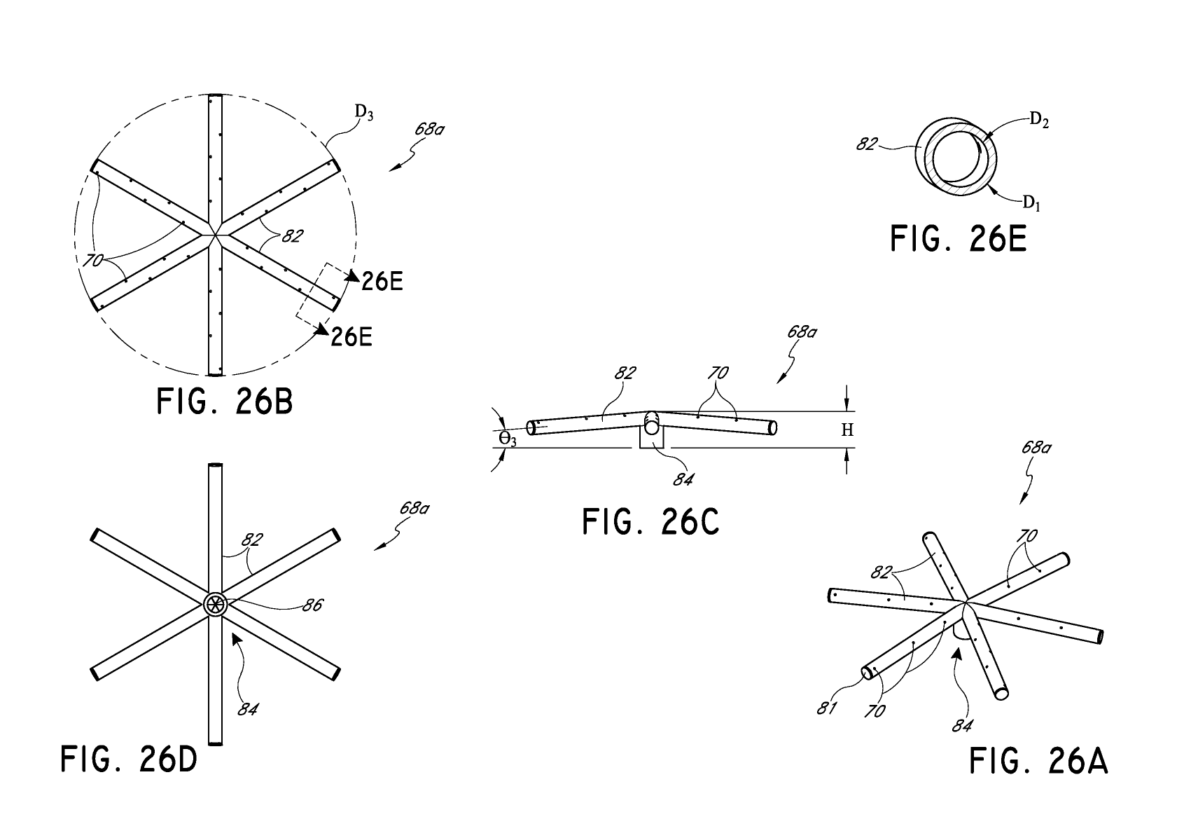

The burner 68 fire pit 50 can have 1 to 16 burner pieces (or arms), including 3 to 12 burner pieces, including 5 to 10 burner, including ranges bordering and the foregoing values, as discussed in further detail in reference to FIGS. 26A-E. The pieces of the burner can have various shapes such as, for example, a star shape with a 5 piece burner as illustrated in FIG. 24A or a hexagon with a 6 piece burner (or 6 arm star burner). Different numbers of pieces and shapes of the burner can be used to provide various heat conduction, heat concentration, and/or burning rates. The burners 68 can have combustion openings or holes 70. The burners and/or arms can have 3 to 100 combustion holes, including 10 to 90, 20 to 80, 30 to 70, 40 to 60 combustion holes, including ranges bordering and the foregoing values. A greater number of holes, such as 100 holes, in the burner piece allows for more air to be drawn in at the air intake of the fire pit, creating a more efficient burn.

The number of combustion holes 70 can be optimized based at least partly on the size of the combustion holes 70. The pressure at the burner 68 should not exceed the pressure at the fuel orifice 78. If the pressure at the burner 68 is greater than the pressure at the fuel orifice 78, then back pressure may result in a reduction of air being inducted into the venturi openings 80. A reduction of air being inducted into the venturi openings 80 can result in unburned fuel. To avoid back pressure, the total area opening of the combustion holes 70 can equal or exceed the opening area of the fuel orifice. Increasing the number of combustion holes 70 can result in a more efficient burning fuel, but a lower flame height and less flame luminescence. For example, with an increased number of combustion holes 70, the back pressure at the fuel orifice 76 is decreased, resulting in a leaner fuel-air mixture. With a leaner fuel-air mixture, the resulting flame can be hotter and more efficient, but smaller and bluer (harder to see than a yellow flame). Reducing the number of combustion holes can result in a less efficient burn (the back pressure at the fuel orifice 76 is increased, resulting a richer fuel-air mixture), but a higher flame height and yellow flame luminescence. A balance between the number and the total area opening of the combustion holes 70 can be achieved to result in a high flame height with a high (yellow) flame luminescence and an efficient burn. A high flame height can be about 2 to 8 inches and/or about 1 to 7 inches higher than the tabletop of the fire pit.

The balance discussed above can result in a ratio range of the total orifice area of the combustion holes to the opening area of the fuel orifice 82. In some embodiments, the ratio of the areas can range from about 1.5:1 to 5:1, including 2:1 to 4.5:1, including ranges bordering and the foregoing values. For example, in one embodiment of the fire pit 50, sixty combustion holes 70 can each have an orifice opening area of about 0.094 inches, resulting in a total opening area of about 0.416 inches. In one embodiment, a 90,000 BTU fire pit can have an opening area of the fuel orifice 78 of about 0.107 inches. A total opening area of the combustion holes 70 of about 0.416 inches and an opening area of about 0.107 inches of the fuel orifice 78 results in a ratio of about 3.9:1. In some embodiments, the combustion holes 70 can each have an orifice opening area of about 0.05 to about 0.15 inches, including about 0.06 to 0.11 inches, including ranges bordering and the foregoing values. In some embodiments, the fuel orifice 78 can have an opening area of about 0.1 to about 1 inches, including about 0.2 to about 0.6 inches, including ranges bordering and the foregoing values. The burner and area ratio features discussed herein can be applied to liquefied petroleum, natural gas, and/or other similar fuels for the fire pit 50.

FIGS. 26A-E illustrate an embodiment of a 6 piece burner 68a. FIG. 26A is a top perspective view of the 6 piece burner 68a. The 6 piece burner 68a has six burner pieces (or arms) 82 that can radiate out from a center. The arms 82 can be pipe-like and hollow to carry fuel. The arms 82 can have end-caps 81 to cap the arms and help ensure that combustion does not occur at the side of the burner 68a (but through the combustion holes 70). As illustrated in FIG. 26E, the arms 82 can have an outer diameter D1 of about 0.3 to 1 inches, including about 0.4 to 0.8 inches, including ranges bordering and the foregoing values. The arms 82 can have an inner diameter D2 of about 0.1 to 0.8 inches, including 0.3 to 0.6 inches, including ranges bordering and the foregoing values. The diameters sizes can depend at least partly on BTU rating of the fire pit and a desired orifice opening area of the combustion holes 70. FIG. 26B illustrates a top view of the burner 68a. The burner 68a can form a generally circular shape with a diameter D3 to generally correspond with the shape of the opening 58. The diameter D3 can be about 10 to about 17 inches. In the embodiment illustrated in FIG. 26A-E, the burner 68a has thirty combustion holes 70 or five combustion holes 70 per arm 82.

FIG. 26C illustrates a side view of the 6 piece burner 68a. The burner 68a can have a connection manifold 84. The connection manifold 84 can mate with the fuel connector 76 with any suitable connection discussed herein. The burner 68a can have a height H from a bottom of the connection manifold 84 to a top of the burner 68a of about 0.5 to 4 inches, including 1 to 3 inches, including range bordering and the foregoing values. Depending on the height H, the burner 68a can have an arm slope angle θ3 of about 1 to 15 degrees, including about 2 to 10 degrees, including about 3 to 5 degrees, including ranges bordering and the foregoing values. The arm slope angle θ3 can help place the arms 82 closer to the cooking grill 2 to, for example, follow a sloped contour of the cooking grill 2 as discussed herein. Placing the arms 82 closer to the cooking grill 2 can help heat the cooking grill 2 to a higher temperature as discussed herein. Further, generally raising the elevation of the arms 82 relative to the burner tray 58 can help raise flame height for better flame luminescence.

FIG. 26D illustrates a bottom view of the 6 piece burner 68a. The burner 68a can have a connection manifold 84 with a pipe opening 86. The pipe opening 86 can mate with the fuel connector 76 as discussed herein. The pipe opening 86 can be any appropriate size to mate with fuel connector 76, including a ¼, ½, ¾, 1 inch, and more than 1 inch standard pipe coupling. Standard pipe coupling mechanisms can include threading, welding, interference fit, and/or the like.

FIG. 27 illustrates a bottom perspective view of a fire pit 50. The fire pit 50 can have the posts 53 supporting the tabletop 56. The doors 54a, 54b can have handles 74a, 75b for ease of opening.

The fire pit 50 can have a controller 72, such as, for example, a turning knob. The controller 72 can control the rate of fuel combustion by the burners 68. The controller 72 can control fuel intake. The controller 72 can control air intake. The controller 72 can be used to achieve a desired level of fire light ambiance from the flame and/or desired cooking temperature. The controller 72 can control a gas valve for regulating flame height. In some embodiments, the controller 72 can regulate the heat output and/or light luminescence for other types of heat and light sources of the fire pit 50, such as for example, an electric heater.

In some embodiments, the fire pit can have a heat output ranging from about 8,000 to about 100,000 BTUs, including about 20,000 to about 90,000 BTUs, including about 30,000 to about 80,000 BTUs, including ranges bordering and the foregoing values. The foregoing heat output can make the cooking griddle reach temperatures of up to about 800° Fahrenheit, up to about 700° Fahrenheit, including about 400 to 660° Fahrenheit, including ranges bordering and the foregoing values. The heat source or flame of the fire pit can be under just a portion of the griddle. The heat can thermally conduct through the griddle, further contributing to the cooking zones discussed herein. The cooking grill can be particularly suitable for use on stovetops and fire pits that are hotter than typical or conventional stovetops or fire pits. Thus, the cooking grills versatility allows it be used over a broad range of cooking applications, including stovetops or fire pits designed to provide fire or light for ambiance that may have higher than typical BTU output.

FIG. 28A illustrates a top perspective view of an embodiment of a cooking grill 2 on a fire pit 50. The cooking grill 2 can substantially cover an opening 58 of the fire pit 50. Legs 24 of the cooking grill 2 can be on an inner rim 62 and inner wall 61 (see FIG. 24A) to situate the cooking grill 2 over the opening 58.

FIG. 28B illustrates a top perspective view of an embodiment of the cooking grill 2 on the fire pit 50 zoomed in from FIG. 28A. When the cooking grill 2 is on top of the opening 58, a user can see inside the opening 58. For example, the user can see the burners 68. The user can see fire light ambiance from the fire pit 50 during combustion while simultaneously providing heat for cooking on the cooking grill 2. How much of the fire a user can see in the opening 58 is at least partially determined by a length of the legs 24 as discussed herein.

The legs 24 can have a body portion 34 and a protrusion portion 36 as discussed herein. The legs 24 can be positioned on the cooking grill 2 such that the body portion 34 of the legs rests on the inner rim 62 as discussed herein. The body portion 34 can elevate the bottom of the cooking grill 2 (or peripheral bottom 13, see FIG. 5) about 0.5 to about 5 inches, including about 1 to 3 inches, including ranges bordering and the foregoing values. The cooking grill 2 can be elevated above the inner rim 62 for the user to be able to still see the flame of the fire pit (i.e., fire light ambiance) while providing enough heat to the cooking grill 2 for cooking food.

The protrusion portion 36 can be correspondingly positioned on the body portion 36 for the protrusion portion 36 to be substantially against or mate with the inner rim 61 (see FIG. 28A) as discussed herein. In some embodiments, the protrusion portions 36 position the cooking grill 2 over the opening 58 in generally a predetermined position and inhibit horizontal movement. In some embodiments, the protrusion portions 36 connect or mate with the inner rim 61 to inhibit horizontal and/or vertical movement of the cooking grill 2 over the opening 58 as discussed herein. The body portion 34 and/or protrusion portion 36 generally follow the contour of the overall griddle 4 shape and/or the inner rim 62 and/or inner wall 61 of the fire pit 50 to nestle within the opening 58 at substantially a predetermined position.

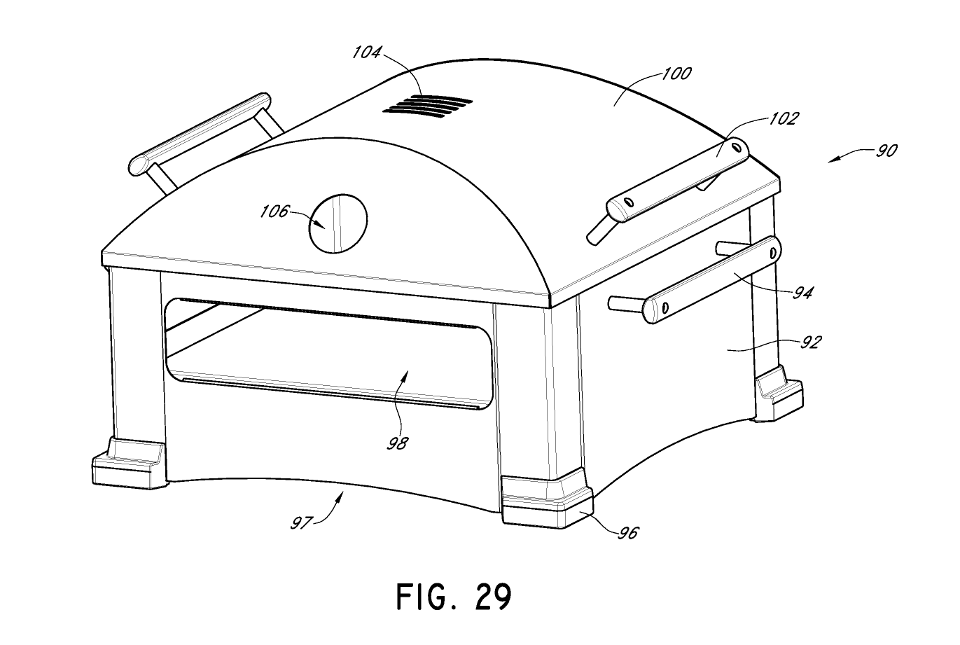

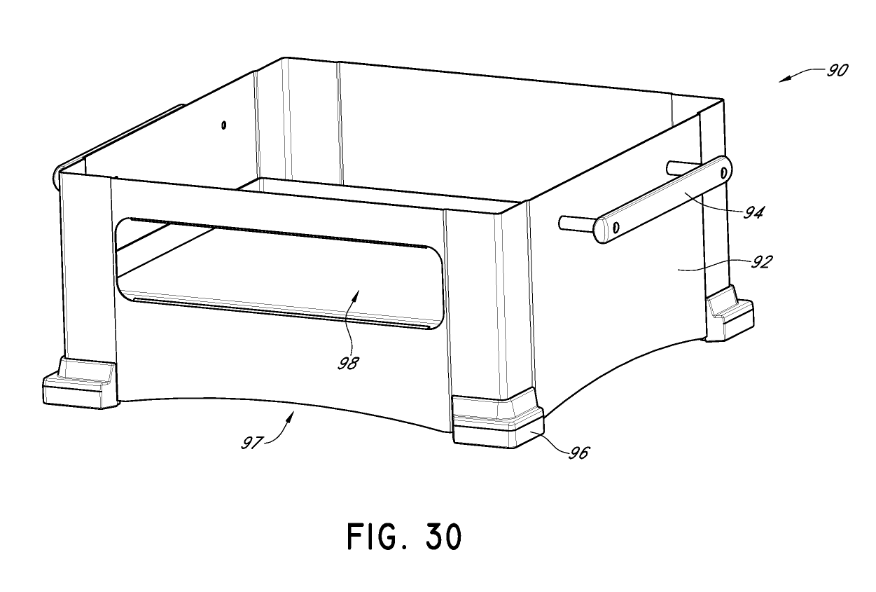

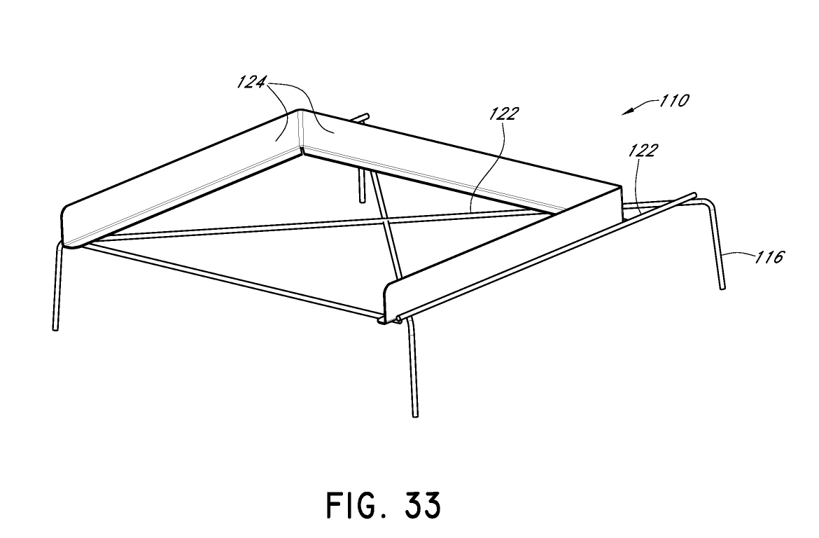

FIG. 29 illustrates a top perspective view of an embodiment of an oven 90. The oven 90 can have a body 92 and a cover 100. The body 92 can have a handles 94 for ease of transportation and handling. As discussed herein, a user can position the oven 90 over the opening or burner tray 58 of the fire pit to prepare various food items such as, for example, pizza. The body 92 can have feet 96 integrated with the body 92. The feet 96 can be positioned to mate with the oven 90 over the opening 58 as discussed herein. The body 92 can have a food opening 98 that allows access to the inside of the oven to place and remove food from the oven 90. The food opening 98 can be large enough to provide access as well as removal of the cooking utensils 110 (FIG. 32) as discussed herein. In some embodiments, the food opening 98 can be sized such that while food can be place in and removed from the oven 90, and the cooking utensils 110 can be accessed primarily by removal of the cover 100 as discussed herein. In some embodiments, the body 92 can include a lid to cover the food opening 98.

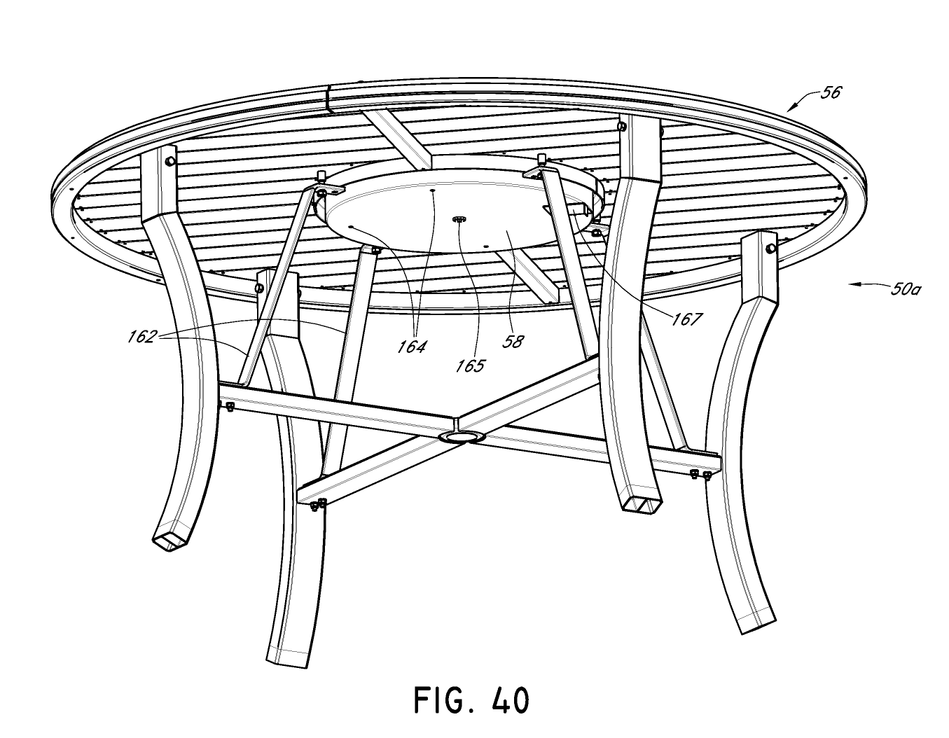

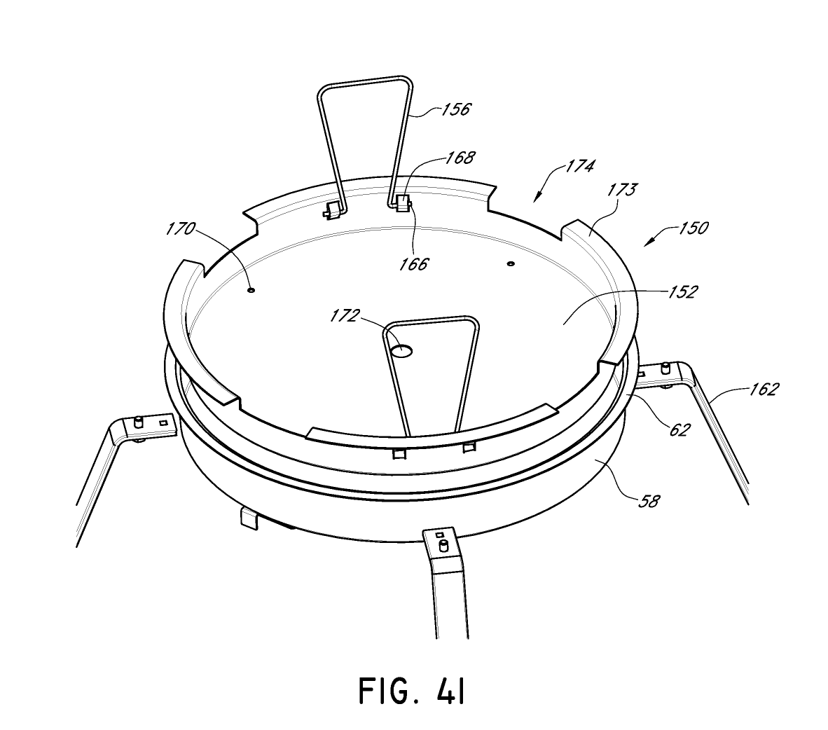

The body 92 can have vent openings 97 near a bottom portion of the body 92 such as the feed 96. The vent openings 97 can provide airflow through the oven 90 and for the burners or other heat sources of the fire pit as discussed herein. As illustrated in FIG. 29, the vent openings 97 can be an arc-like shape forming a bottom periphery of the body 92. In some embodiments, the vent openings 97 can be other features and or openings, such as, for example vent holes 164 discussed herein and in particular in reference to FIG. 40.

The oven 90 can have a cover 100 that is removal. The cover 100 can have handles 102. The handles 102 can be used for ease of transport and removing the cover 100 from the body 92. The cover 100 can have top vent holes 104. The top vent holes 104 can provide airflow through the oven 90. As discussed herein and in particular in reference to the cooking grill 2, 3, 4, the vent openings 97 and top vent holes 104 can provide desired airflow through the oven 90 for managing the airflow, combustion of gases, and/or heat absorption or temperature of the oven 90. For example, air can flow from the vent openings 97, through the oven 90, and out the top vent holes 104. The top vent holes 104 can include a regulator to allow a user to adjust the amount of airflow through the top vent holes 104. The adjustment of the top vent holes 104 can regulate the temperature of and/or in the oven 90. To observe the temperature of and/or in the oven 90, a thermometer can be placed in a thermometer opening 106 of the cover 100. In some embodiments, the vent openings 97 can include regulators to adjust the amount of airflow and correspondingly the temperature of and/or in the oven 90.

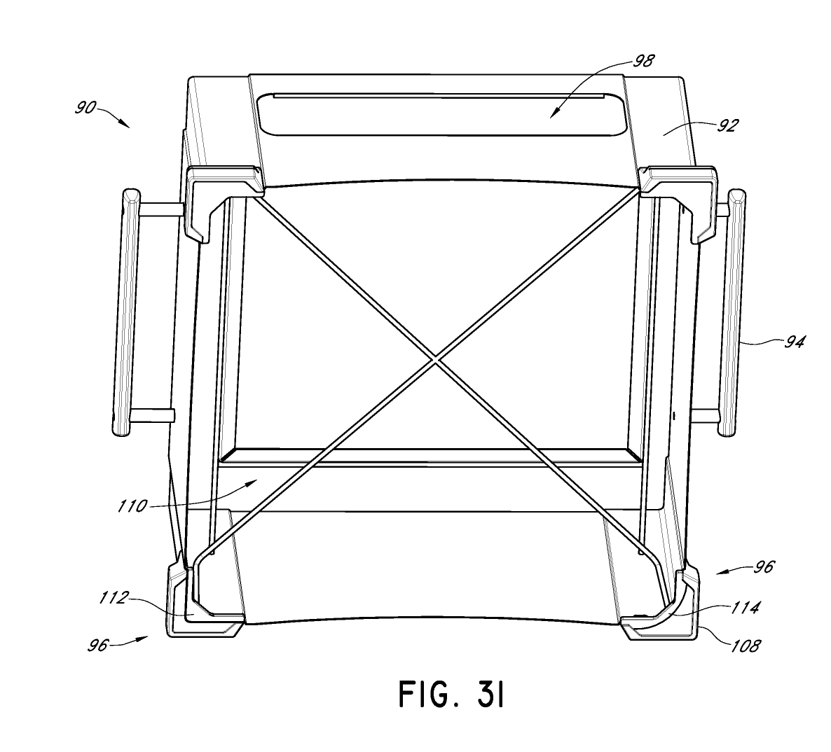

FIG. 30 illustrates a top perspective view of an embodiment of the oven 90 without a cover 100. The cover 100 can be removed to provide access to the inside of the body 92 as well the cover 100. Providing access to the inside of the oven 90 can help with cleaning and maintenance of the oven 90. Further, access to the inside of the oven 90 can provide access to manage the cooking utensils 110 (FIG. 32) or any other components in the oven. In some embodiments, the food opening 98 may not be large enough or convenient to provide access to the cooking utensils 110 or other oven components as discussed herein, and in particular in reference to FIGS. 32-34.

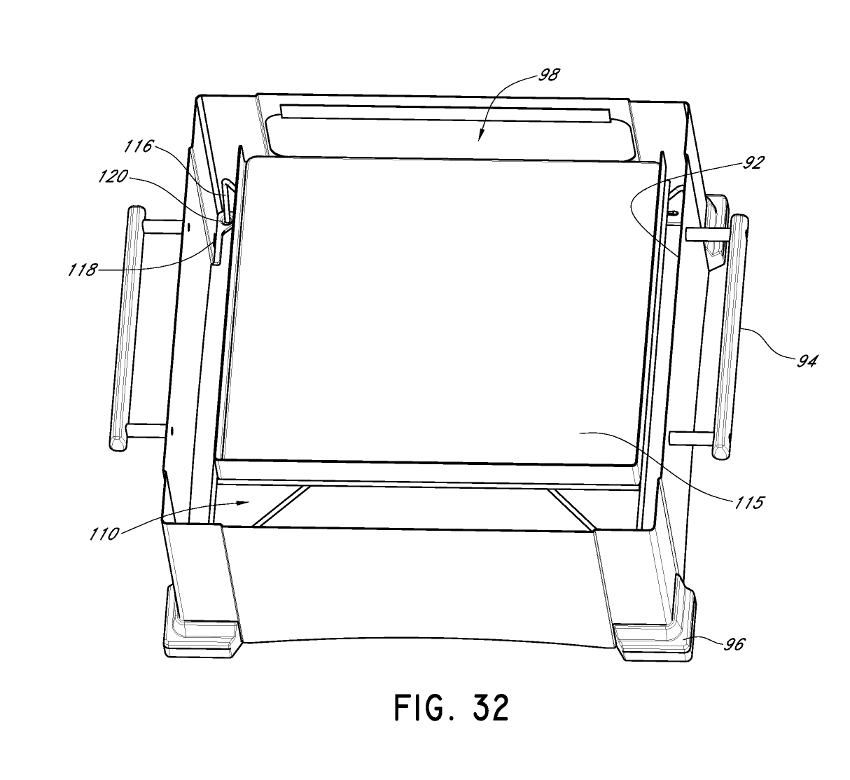

FIG. 31 illustrates a bottom perspective view of an embodiment of the oven 90. Feet 96 can be attached to or integrated with the body 92 of the oven 90. The feet 96 can be positioned on the body 92 to mate with or rest over a corresponding opening 58 of the fire pit (or any other heat source as discussed herein, such as, for example, a charcoal assembly 150). As illustrated in FIG. 31, the oven 90 and/or oven body 92 can be square. The square oven 90 can be positioned over an opening 58 of a fire pit that is square. In some embodiments, the over 90 and/or body 92 can be other suitable shapes discussed herein. The oven 90 and/or body 92 can vary in shape accordingly to either engage and/or cover the opening 58 as discussed herein. The feet 96 can have features to rest on, interlock, engage, and/or mate with the opening 58 as discussed herein, and in particular reference to the feet 36 of the cooking grill 2, 3, and 4.

As illustrated in FIG. 31, the feet 96 can have outer protrusions 108. The outer protrusions 108 can mate with a rim of an opening 58 that is square. The outer protrusions 108 can be positioned and shaped such that when the feet 96 rest over the rim 62 of the opening 58 (FIG. 24A). The outer protrusions 108 inhibit movement of the oven 90 in at least a horizontal plane. In some embodiments, the outer protrusions 108 can have features that engage (interlock and/or mate with) the outer rim 62 of the opening 58 and provide resistance to vertical movement of the oven 90. This can prevent the oven 90 from moving relative to the opening 58 when the fire pit is, for example, accidentally bumped by a user.

The feet 96 can have in combination or alternatively inner protrusions 112. The inner protrusions 112 can interlock, engage, and/or mate with the rim 62 of the opening 58 of the fire pit similarly as discussed here in reference to the outer protrusions 108. For example, the inner protrusions 112 can inhibit movement of the oven 90 in at least a horizontal plane. Further, the inner protrusions 112 can engage (interlock and/or mate with) the opening 58 to inhibit movement in the vertical direction.

As illustrated in FIG. 31, the inner protrusion 112 can have corners to mate with an opening 58 that is square. As also illustrated and FIG. 31, another embodiment of the inner protrusion 114 can be rounded to mate with an opening 58 that is round. In some embodiments, the oven 90 and/or oven body 92 can be square and feature rounded inner protrusions 114. In such embodiments, the oven 90 may cover only a portion of the opening 58. Covering only a portion of the opening 58 can provide better airflow as discussed here in, for example, as related to air vent openings. Further, the oven 90 not fully covering the opening 58 can provide ambient light as may be desired by the user as discussed herein, while still allowing for cooking of foods in the oven 90.

FIG. 32 illustrates a top side view of an embodiment of the oven 90 without a cover 100. The body 92 and/or feet 96 can have flanges 118 for supporting cooking utensils 110. The flanges 118 can have a divot 120 to mate with feet 116 of the cooking utensils 110. The feet 116 can support and elevate the cooking utensils 110 at a desired height from the burners 68 or other heat source of the fire pit. The feet 116 can come down vertically and/or any other suitable angle to rest on, mate with, and/or engage the flanges 118, including the divot 120. The body 92 can have four flanges 118 and/or divots 120 at each corner of the body 92 when the body 92 is, for example, square. In some embodiments, the body 92 can have more or less flanges 118 and/or divots 120 as is needed to support the cooking utensils 110 or as may be dictated by the shape of the body 92 (i.e., the number of corners based on the shape of the body 92).

As illustrated in FIG. 32, the cooking utensils 110 can support a slate or plate 115. The plate 115 can be a slate of any suitable material for cooking, for example, pizza. In some embodiments, other suitable cooking utensils can be used in lieu of a plate 115 depending on the type of foods being cooked, such as, for example, a cooking rack with wires.

FIG. 33 illustrates a top perspective view of an embodiment of the cooking utensils 110. The cooking utensils 110 can have a frame 122, including the feet 116. The frame 112 can provide adequate support for the plate 115 as discussed herein. Supports 124, or as illustrated in FIG. 33 L-beam borders 124, can be connected to the frame 122 to provide support for the plate 115. The L-beam supports 124 can have a bottom portion of the L-beam borders 124 that vertically supports the plate 115, while simultaneously having a side portion of the L-beam borders 124 that inhibits horizontal movement of the plate 115 when the plate 115 is placed within the L-beam borders 124. The cooking utensils 110 can provide other means of support for the plate 115 or a cooking rack. For example, the plate 115 or cooking rack can be supported at just the corners of, for example, the L-beam borders 124. Further, the shape of the supports 124 can vary to correspond to and engage a desired or predetermined shape of cooking plate 115.

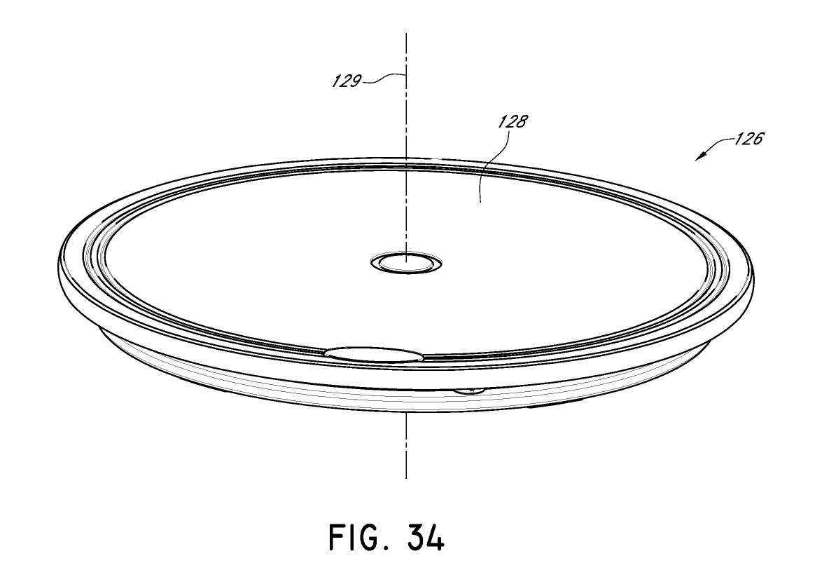

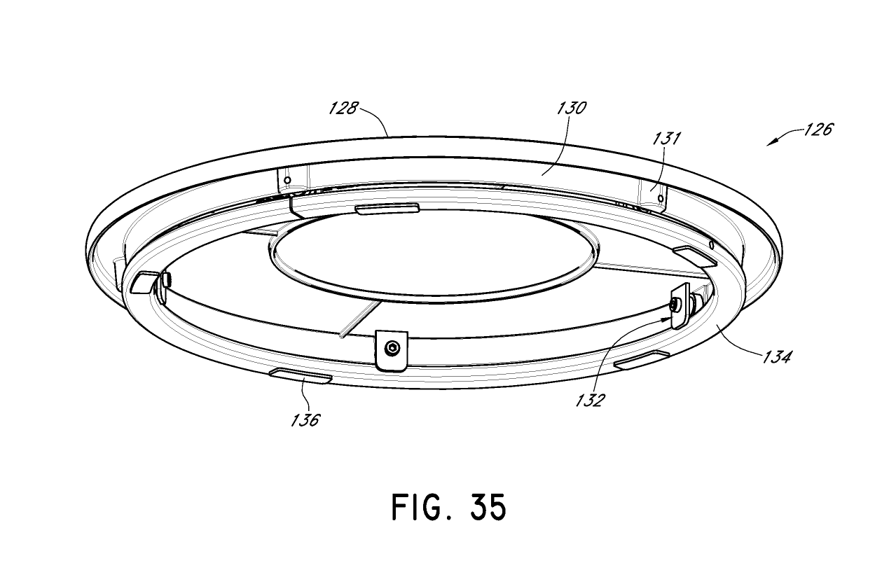

FIG. 34 illustrates a top side view of an embodiment of a turntable 126. The turntable 126 can rest over an opening 58 of the fire pit. The turntable 126, for example, a Lazy Susan, can be used for placing foods on top of a rotating cover, top, or body 128. The rotating cover 128 can rotate about a center or central axis 129 to provide ease of access to the placed food items. The center axis 129 can correspond to the center axis 15 as discussed herein. The rotating cover 128 can be round and have a diameter of about 12 to about 36 inches. The diameter of the rotating cover 128 can correspond to the diameter of the opening 58 of a fire pit table to substantially cover the opening 58 while the turntable is on the table.

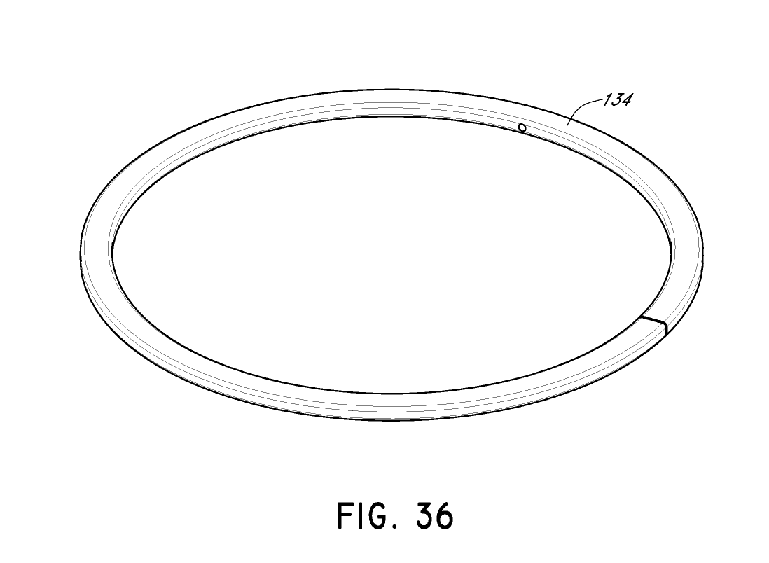

FIG. 35 illustrates a bottom side view of an embodiment of the turntable 126. The rotating cover 128 can have a flange or skirt 130 for supporting roller assemblies 132 (e.g., bearing or wheel assemblies). The flange 130 can have supporting protrusions 131 that provide additional supporting material for the roller assemblies, for example, a bolt/axle hole or opening 139 as discussed herein for supporting the roller assembly 132 in a desired or predetermined position, including a desired or predetermined angle, plane, and/or level, relative to the rotating cover 128 and/or tabletop 56.

The roller assemblies 132 can mate with, engage and/or rest on a table ring, disc, or hoop 134. The table ring 134 can have stops 136 to rest on a tabletop 56 of the fire pit and/or to rest on, engage, and/or mate with an opening 58, such as a rim 62 of the opening 58 (e.g., a lip on or resting surface of the opening 58). In some embodiments, the stops 136 can be shaped and positioned to mate with or engage the opening 58 such as discussed herein, for example, in reference to the feet 36 of the cooking grill 2, 3, and 4 and/or feet 96 of the oven 90. The stops 136 can be rubber to help inhibit slipping of the table ring 134, and correspondingly, the turntable 126, against the tabletop 56 and/or opening 58. The table ring 134 can be used, for example, with a square fire pit table 50b as discussed herein, including over a round opening 58 or a square opening 58 (for a fire pit). The table ring 134 can be used, for example, with a round fire pit table 50, 50a as discussed herein, including over a round opening 58 or a square opening 58 (for a fire pit).

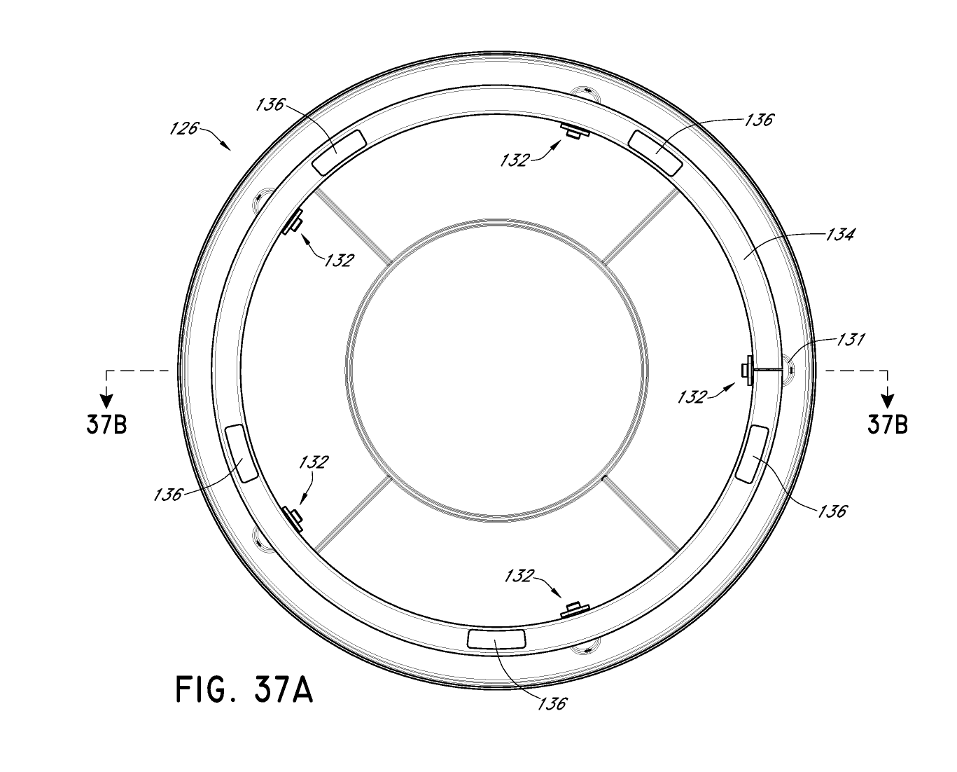

The rotating cover 128 and table ring 134 can separate from each other. In some embodiments, the roller assemblies 132 can have features that engage and/or mate with the table ring 134 to inhibit undesired vertical movement when, for example, the turntable 126 may be accidentally bumped by a user. FIG. 36 illustrates a top side view of an embodiment of the table ring 134 separated from the rotating cover 128. The table ring 134 can be sized and shaped to enclose any type of opening 58 of the fire pit discussed herein. For example, the table ring 134 can be slightly larger than a round opening 58 of a fire pit to enclose the round periphery of the opening 58. In some embodiments, the table ring 134 can be sized to fully enclose the corners of a square opening 58 within the table ring's 134 inner boundary.

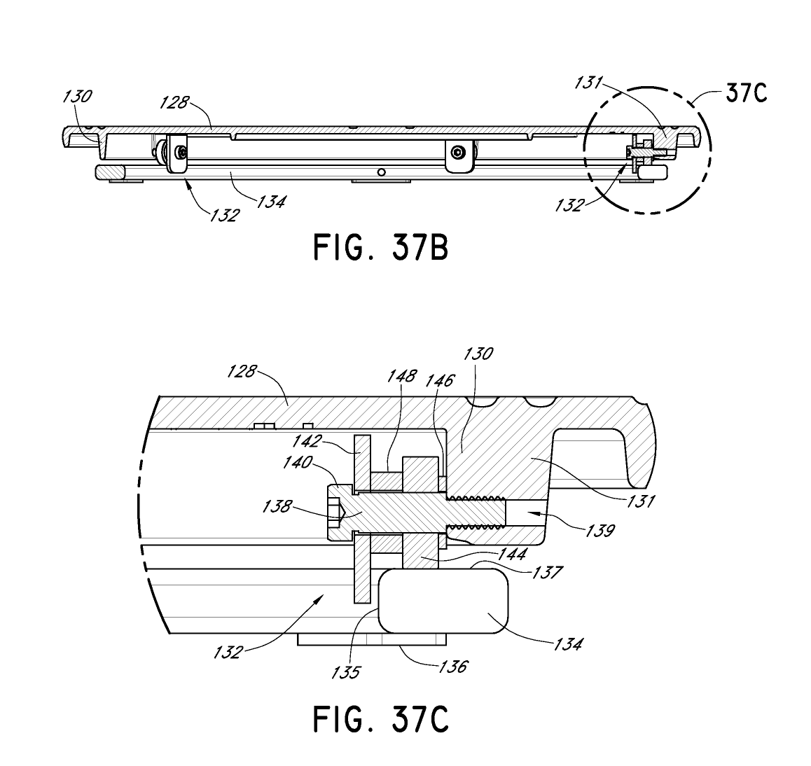

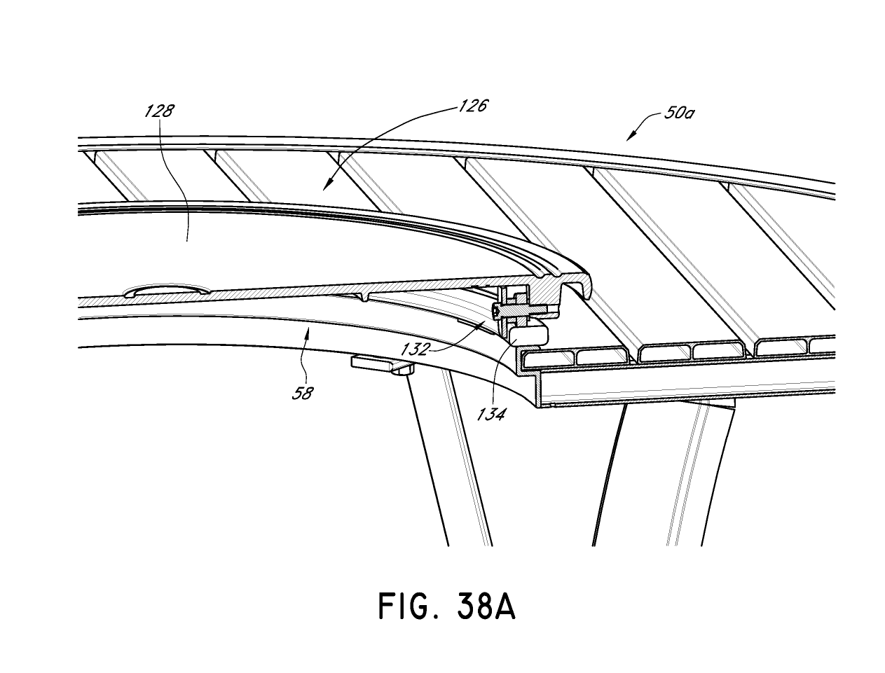

FIG. 37A illustrates a bottom view of the turntable 126. The roller assemblies 132 can be evenly spaced near the outer periphery of the turntable 126. For example, FIG. 37A illustrates five evenly spaced roller assemblies 132. In some embodiments, the turntable 126 can have three, four, six, seven, eight, or more roller assemblies 132. The stops 136 can be evenly spaced near around the table ring 134. For example, FIG. 37A illustrates four evenly spaced stops 136. In some embodiments, the table ring 134 can have three, five, six, seven, eight, or stops 136. FIG. 37B illustrates a cross-sectional view of the turntable 126 along the line shown in FIG. 37A. The roller assemblies 132 can be connected to the turntable 126 via the flange 130 and rest on the table ring 134, engaging the inner periphery or wall 135 of the table ring 134 (see, e.g., FIG. 37C).

FIG. 37C illustrates an enlarged cross-sectional view of the roller assembly 132. The roller assembly 132 can have a shoulder bolt 138 (e.g., an axle, rod, pole, or shaft). The shoulder bolt 138 can engage the protrusion 131 of the flange 130 via a bolt hole 139. As illustrated in FIG. 37C, the shoulder bolt 138 and bolt hole 139 can be threaded to provide a desired tight engagement therebetween. Other suitable connection types as discussed herein can be provided as well, including interference fit and/or snap fit mechanism to inhibit movement between the shoulder bolt 138 and bolt hole 139. The shoulder bolt 138 can have a bolt head 140. A stop washer 142 can fit onto the shoulder bolt 138 and abut the bolt head 140. As discussed herein, the stop washer 142 can be considered a projection, extension, fin, wing, and/or hook functioning as discussed herein (e.g., to engage an inner wall or side of an opening or table ring to guide the rotation of the rotating cover 128). The stop washer 142 can be sized and shaped to engage, mate with, or abut against the inner periphery or wall 135 of the table ring 134 while the bearing 144 rolls or moves along the top portion, lip, or rim 137 of the table ring 134 (e.g., a resting surface). The bearing 144 has a diameter sufficient to elevate the rotating cover and/or flange above the top portion, lip, or rim 137 of the table ring 134 (or other resting surfaces as discussed herein) a desired or predetermine distance (e.g., vertical) such that the rotating flange 128, flange 130, and rotating assembly 132 can rotate freely without obstructions or interference with the resting surface along the rotating path (e.g., in the horizontal plane, perpendicular to the central axis 129).

As illustrated in FIG. 37C, the bottom portion of the stop washer or stop 142 (e.g., portion of the stop washer 142 proximate to the table ring 134 or distal to the rotating cover 128) can protrude or extend past the top of the table ring 134 (e.g., past a periphery or perimeter of the bearing 144) such that when the rotating cover 128 is placed on the table ring 134, the rotating cover 128 is substantially inhibited from traveling in the horizontal plane (e.g., substantially perpendicular to the center axis 129). Top and bottom as discussed herein can be in reference to when the turntable 126 is positioned upright in a desired or predetermined position relative to a table (e.g., table 50) for rotation relative the table as discussed herein (e.g., about center axis 129).

In some embodiments, the stop washer 142 can have a feature that more fully engages the table ring 134 to help prevent vertical movement of the rotating cover 128 relative to the table ring 134. For example, the bottom portion of the stop washer 142 can be an L-shape feature, with the bottom portion of the L at least partially engaging a bottom of the table ring 134 to inhibit undesired vertical motion of the rotating cover 128 relative to the table ring 134.

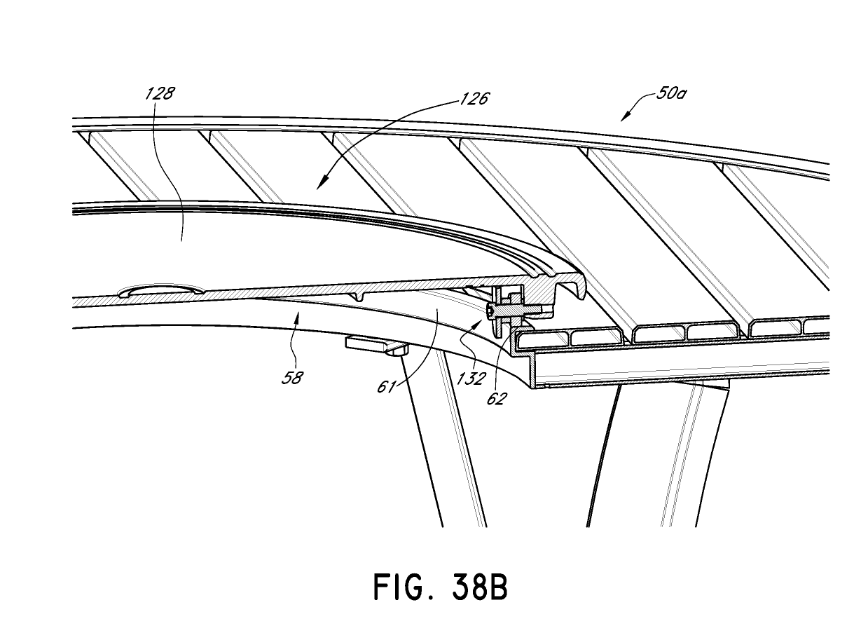

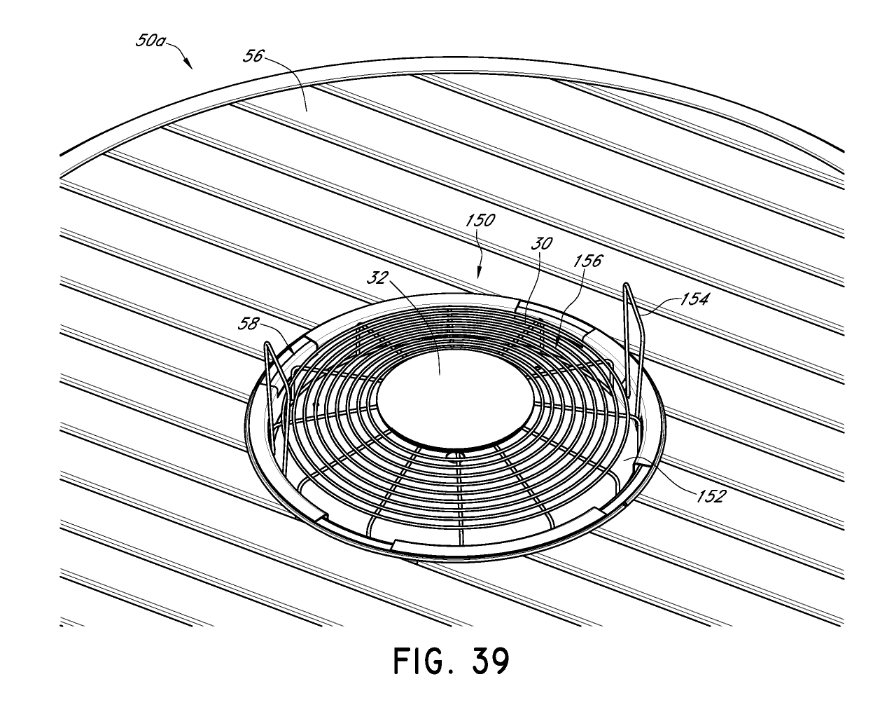

In some embodiments, the stop washer 142 can be sized and shaped to engage, mate with, or abut against the inner periphery of an opening 58 of a table (e.g., a fire pit table), such as for example, engaging an inner wall 61 and/or inner rim 62 of an opening 58 that is round. See FIG. 38B. Also, the table ring 134 illustrated in FIGS. 34-37C can represent the inner wall 61 and/or inner rim 62 of a fire pit table 50. The turntable 126 can engage with an opening 58 similarly as discussed herein with the table ring 134.

In some embodiments, the bottom portion of the stop washer or stop 142 (e.g., portion of the stop washer 142 proximate to the opening 58 or distal to the rotating cover 128) can protrude or extend past the top of the inner rim 61 (e.g., past a periphery or perimeter of the bearing 144) when the turntable 126 is positioned over the opening 58 without the table ring 134 such that the rotating cover 128 is substantially inhibited from traveling in the horizontal plane.

In some embodiments, the stop washer 142 can have a feature that more fully engages the opening 58 to help prevent vertical movement of the rotating cover 128 relative to the opening 58 (e.g., parallel to the center axis 129). For example, the bottom portion of the stop washer 142 can be an L-shape feature, with the bottom portion of the L at least partially engaging, for example, a groove in the inner wall 61 to inhibit undesired vertical motion of the rotating cover 128 relative to the opening 58. [0175] A top portion of the stop washer 142 (e.g., portion of the stop washer 142 distal from the table ring 134 and/or opening 58, or proximate to the rotating cover 128) can be sized and shaped to engage and/or substantially abut the rotating cover 128. When the shoulder bolt 138 is rotated to fix in place the components of the roller assembly 132 as discussed herein, the top portion of the stop washer 142 can abut the rotating cover 128 such that the rotation of the shoulder bolt 138 does not continually rotate the stop washer 142 relative to the rotating cover 128 (e.g., the stop washer is rectangular and in particular, has a substantially straight side abutting the table cover 128 as illustrated in FIG. 37B).

Such an abutment of the stop washer 142 and the rotating cover 128 can fix the stop washer 142 in a desired position relative to the table ring 134. As illustrated in FIG. 37C, in some embodiments upon assembly, the bolt head 140 can abut the stop washer 142, which can abut a spacer 148 that abuts a rotating bearing or rotation/rotating wheel 144. In some embodiments, the spacer 148 illustrated in FIG. 146 can be a washer 146. For example, the spacer 148 can be considered a washer with an extended axial length along a longitudinal axis of the bolt 138. The bearing 144 can abut a washer 146, which can abut flange 130 and/or the protrusion 131. In some embodiments, the washer 146 illustrated in FIG. 37C can be substituted with a washer 148. As illustrated in FIG. 37C upon assembly, the components of the roller assembly 132 are fixed relative to the protrusion 131, flange 130, and/or rotating cover 128.

The roller assembly 132 can have a rolling or rotating feature that provides movement of the roller assembly 132 relative to the table ring 134 and/or opening 58 (e.g., inner rim 62). As illustrated in FIG. 37C, the roller assembly 132 can have a bearing 144 that rotates about the shoulder bolt 138. The bearing 144 can contact the table ring 134 and/or opening 58 (e.g., inner rim 62) when the rotating cover 128 is placed onto the table ring 134 and/or opening 58. As the bearing 144 rotates relative to the surface of the table ring 134, the rotating cover 128 revolves substantially about a shared central axis with the table ring 134 and/or opening 58.

The bearing 144 can fit onto the shoulder bolt 138. The bearing 144 can be fitted with washers 146 on one or both sides of the bearing 144. The washers 146 can fit onto the shoulder bolt 138. The bearing 144 can be spaced a desired or predetermined distance from the protrusion 131 of the flange 130 and/or stop washer 142 by a spacer 148 that fits onto the shoulder bolt 138 such that the bearing 144 rests on the surface 137 of the table ring 134 as illustrated in FIG. 37C and/or a surface (e.g., rim 62) of an opening 58. As the rotating cover 128 revolves and the roller assemblies 132 move relative to the table ring 134 and/or opening 58, the bottom portion of the stop washer 142 can engage the inner periphery of the table ring 134, inner wall 61, and/or rim 62 to maintain the bearing 144 in substantially the same radial position relative to the table ring 134 and/or opening 58. The stop washer 142 helps the bearing 144 stay engaged and rolling on the table ring 134 and/or opening 58 as the rotating cover 128 revolves substantially about its central axis.

In some embodiments, the roller assembly 132 can engage the rim 62 of an opening 58 of the fire pit as discussed herein and in particular, in reference to FIG. 24A. In some embodiments, the rim 62 of the opening 58 can substantially act as the table ring 134. The bearing 144 can rest on the top of the rim 62 to move or rotate on the rim 62. The stop washer 142 can engage the inner wall 61 of the opening 58 in substantially a similar manner as the inner periphery of the table ring 134 to help prevent horizontal movement of the rotating cover 128 relative to the opening 58 of the fire pit.

Accordingly, the turntable 126 can be configured and have features that engage the table ring 134 and/or opening 58 of a table without additional features, modification, arrangement, and/or setup of the opening 58 and/or table needed. The turntable 126 can be placed onto the table (e.g., onto or at a desired elevation above the tabletop 56 of a table 50) quickly when desired by the user (e.g., before or after using the fire pit functionality of the table as discussed herein). After use, the turntable 126 can be lifted away (e.g., removed) from the tabletop 56 along with the roller assemblies 132 without additional steps (e.g., disengagement of connections between the turntable 126 and table ring 134 and/or tabletop 56), providing access to the opening 58 as desired for other uses discussed herein.

In addition, the arrangement of the turntable 126 and roller assemblies 132 as discussed herein are substantially not visible and are unobtrusive to a user when the turntable 126 is positioned on the table (e.g., on the tabletop 56 over the opening 58) as discussed herein. For example, as illustrated in FIGS. 37A-C, the roller assemblies 132 protrude or project from the flange 130 inwards toward the a center axis 129 of the turntable 126 (e.g., substantially perpendicular to the center axis 129). In some embodiments, the roller assemblies may protrude or project from the flange 130 outward away from the center axis 129.

FIG. 38A illustrates a top perspective view of an embodiment of a turntable 126 on a table ring 134 resting on a table 50a (e.g., a table with an opening 58 that can be used with, for example, a fire pit or other accessories as discussed herein, including other tables 50, 50b). As illustrated in FIG. 38A, the table ring 134 can have a diameter that substantially coincides with the diameter of the opening 58 (e.g., is the substantially or about the same). In some embodiments, the diameter of the table ring 134 can be about 12 to about 18 inches to correspond to the diameter of the opening 58 as discussed herein. The table ring 134 can rest on a top surface (e.g., rim 62) of the opening 58 as discussed herein. The rotating cover 128 can rest on the table ring 134 for the roller assemblies 132 to rest on, engage with, or mate with the table ring 134 as discussed herein (e.g., with the rim 137 and/or inner wall 135, see FIG. 37C).

FIG. 38B illustrates a top perspective view of an embodiment of a turntable 126 on a table 50a (e.g., a table with an opening 58 that can be used with, for example, a fire pit or other accessories as discussed herein, including other tables 50, 50b). As illustrated in FIG. 38A, the rotating cover 128 can have a diameter that substantially coincides with the diameter of the opening 58 for the roller assemblies 132 to rest on, engage with, or mate with opening 58 (e.g., top resting surface such as a rim 62 and/or inner wall 61 of the opening 58) as discussed herein. In some embodiments, the diameter of the rotating cover 128 can be about 12 to about 36 inches to correspond to the diameter of the opening 58 as discussed herein while substantially covering the opening 58 at the periphery/perimeter of the opening 58.

Accordingly, as illustrated in FIGS. 38A and 38B, the turntable 126 can substantially cover the opening 58 to provide a surface to place items such as food on top of the rotating cover 128 while allowing the rotating cover 128 to rotate along about a central axis 129 as discussed herein for ease of access to those items. The turntable 126 provides this functionality without any or minimal modification, adjustment, or set-up needed to tables 50, 50a, 50b as discussed herein.

FIG. 39 illustrates a top perspective view of an embodiment of a charcoal assembly 150 on a fire pit 50a (e.g., a table with a fire pit). The charcoal assembly 150 can be used as a heat and light source with or as an alternative to the burners 68 discussed herein. The charcoal assembly 150 can fit into an opening or burner tray 58 of a fire pit 50a. The charcoal assembly 150 can have a charcoal tray 152. The charcoal tray 152 can be sized and shaped rest in/on top of, mate with, and/or engage the burner tray 58. The burning media, firebox 64, and/or burners 68 as discussed herein, and in particular in reference to FIGS. 24A-26D, can be removed before engagement of the charcoal assembly 150. In some embodiments, the burner tray 58 can be removed with the firebox 64 and burners 68 for the charcoal tray 152 to directly engage the tabletop 56. The charcoal tray 152 can engage the tabletop 56 in a similar manner as the engagement of the burner tray 58 as discussed herein.

The charcoal assembly 150 can have handles 154 for handling of the charcoal assembly 150. The charcoal assembly 150 can have a cooking rack 156 for cooking foods thereon. The cooking rack 156 can have wires 30 and a center plate 32 as discussed herein, and in particular in reference to the cooking grill 2, 3, 4.

FIG. 40 illustrates a bottom perspective view of an embodiment of a fire pit 50a. The fire pit 50a can have opening supports 162 for supporting the opening or burner tray 58. The opening supports 162 can engage the opening or burner tray 58 to help fix the position of the burner tray 58 relative to the fire pit 50a. The burner tray 58 can have vent openings 164. The burner tray 58 can have a burner opening 165, where, for example, the fuel connector 76 can be engaged with the burner tray 58 as discussed herein, and in particular in reference to FIG. 25. The burner tray 58 can have a firebox opening 167, where, for example, the firebox 64 can be engaged with the burner tray 58 as discussed herein, and in particular in reference to FIG. 24A. The vent openings 164, burner opening 165, and/or firebox opening 167 can be left open or closed when in use with the charcoal assembly 150 depending on desired air flow and/or clean up of spent charcoal (ash). The vent openings 164, burner opening 165, and/or firebox opening 167 can be closed with, for example, plugs, plates, bars, and/or other suitable components that engage or mate with the vent openings 164, burner opening 165, and/or firebox opening 167 to provide satisfactory/desired sealing/closure of the openings. The vent openings 164, burner opening 165, and/or firebox opening 167 can be subsequently opened for use, for example, with the firebox 64 and burners 68 as discussed herein.

FIG. 41 illustrates a top perspective view of an embodiment of a charcoal assembly 150. As discussed herein, the charcoal assembly 150 can have a charcoal tray 152 that fits within the burner tray 58. Coals (or other suitable combustible media) can be put into the charcoal tray 152 for combusting to enjoy ambient light and/or cooking of foods. The opening supports 162 can be attached to the burner tray 58 and/or charcoal tray 152 to provide a fixed engagement relative to the tabletop 56.

The charcoal tray 152 can have vent openings 170 for airflow. The charcoal tray 152 can have a burner opening 172 that corresponds to the burner opening 165 in the burner tray 58. Depending on desired airflow and/or ease charcoal ash cleanup, any of the airflow openings or holes discussed herein can be opened or closed to achieve a desired operation and balance between airflow and cleanup. Further, in some embodiments, some of the vent holes can be vertically misaligned such that charcoal ash falling through the vent holes 170 onto the burner tray 58 do not fall through the vent holes 164 of burner tray 58.

The charcoal tray 152 can have handles 156 to carry and/or position the charcoal tray 152 as desired, for example within burner tray 58. The handles 156 can have side prongs 166. The charcoal tray 152 can have slots 168 attached or integrated with the charcoal tray 152. The side prongs 166 can engage the slots 168 to fix at least the vertical position of the handles 156 relative to the charcoal tray 152. For example, the handles 156 can be biased to position the side prongs 166 outwardly relative to the separation between the side prongs 166. When the sides of the handle 156 are squeezed, the side prongs 166 can be inserted into the slots 168. Upon release of the handle 156, the side prongs 166 are pushed into and/or engage the slots 168. The side prongs 166 can stay engaged with the slots 168 until the handle 156 is squeezed again by the user. The user may desire to disengage the handles 156 from the charcoal tray 152 after positioning the charcoal tray 152 relative to the tabletop 56, but before starting combustion of the coals. Thus, the handles 156 can be removed with the charcoal tray 152 positioned as desired, but before combustion of the coals so the handles 156 do not get hot during combustion of the coals, presenting a potential safety hazard.

The charcoal tray 152 can have a lip 173. The lip 173 can be sized and shaped to rest on top of the rim 62 of the burner tray 58 to provide vertical support to the charcoal tray 152. The charcoal tray 152 can have cutouts 174. The cutouts 174 can provide openings for further airflow underneath the charcoal tray 152 during combustion of charcoal.

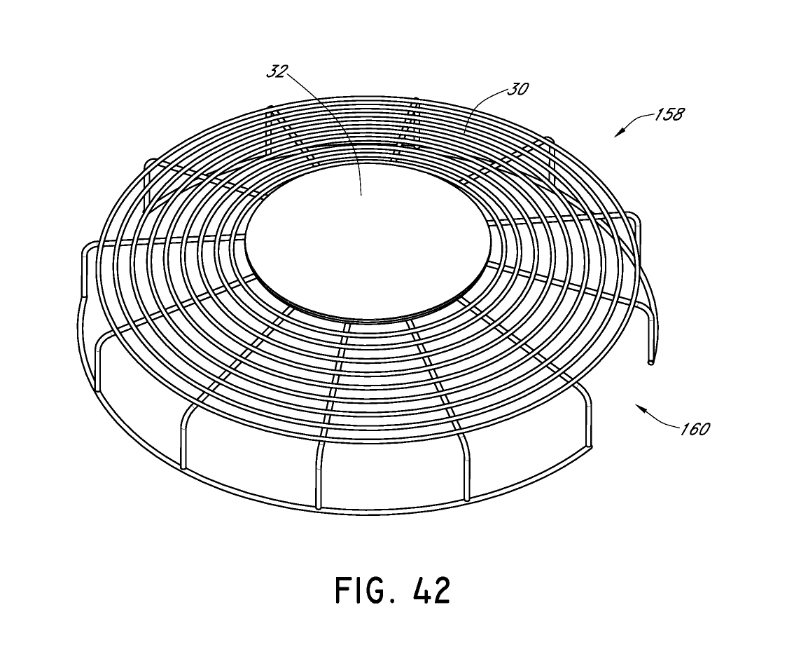

FIG. 42 illustrates a top perspective view of a cooking rack 158. The cooking rack 158 can have handle cutouts 160. The handle cutouts 160 can be positioned to correspond to the position of the handles 156 when the handles are engaged with the charcoal tray 152 and the cooking rack 158 is positioned within the charcoal tray 152. The handle cutouts 160 can be sized, shaped, and/or positioned such that the cooking rack 158 can be positioned inside the charcoal tray 152 without having to remove the handles 156. This can be useful when filling the charcoal tray 152 with coals in a location located away from the fire pit, and then positioning the cooking rack 158 in the charcoal tray 152. The handles 156 can be used to carry the charcoal assembly 150 as one unit to the fire pit. The cooking rack 158 and handle cutouts 160 can also be sized and shaped such that handles 156 can be disengaged from the charcoal tray 152 before combustion of the coals as discussed herein, without having to remove the cooking rack 158. Thus, the charcoal tray 152 and the cooking rack 158 can positioned in the fire pit as one unit using the handles 156, and the handles 156 can removed thereafter.

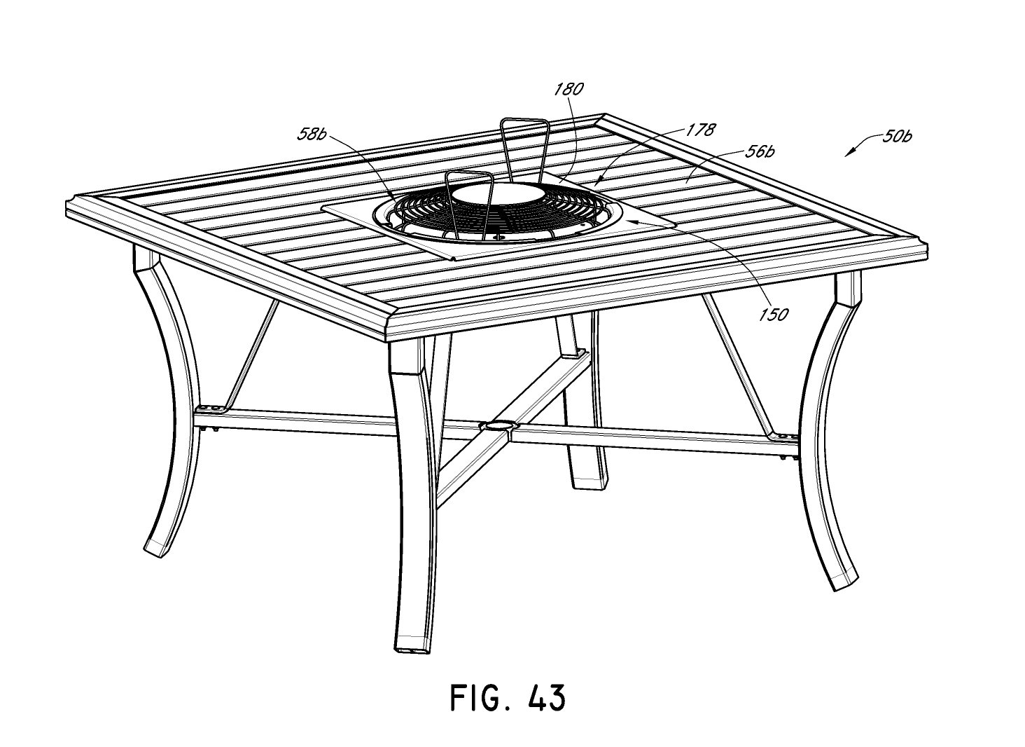

FIG. 43 illustrates a top perspective view of an embodiment of a square fire pit 50b (e.g., a square table with a square fire pit). The square fire pit 50b can have a square tabletop 56b. The square tabletop 56b can have a square opening 58b. In some embodiments, the square tabletop 56b can have a round opening 58. The square opening 58b can house a support tray 180. The support tray 180 can be sized and shaped to fit within and be supported by the square opening 58b. The support tray 180 can have a round opening for accepting, for example, a burner tray 58 and/or charcoal assembly 150 that are round as discussed herein. In some embodiments, the burner tray 58 and/or charcoal assembly 150 can be square to be positioned within and be supported by the square opening 58b without the support tray 180.

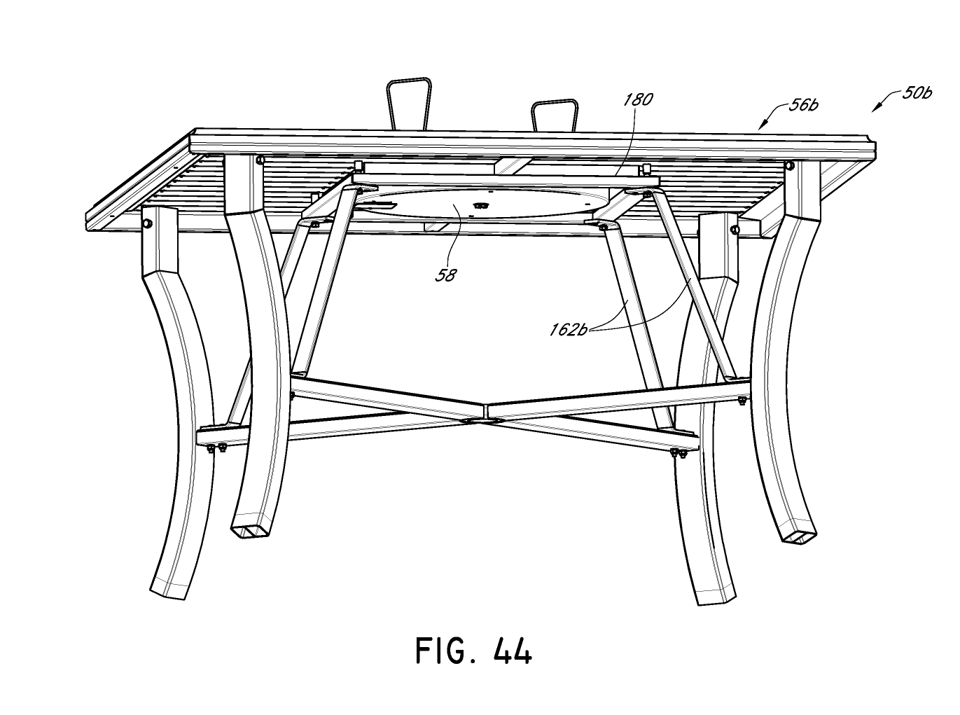

FIG. 44 illustrates a bottom perspective view of an embodiment of a square fire pit 50b. The support tray 180 tray can be supported by opening supports 162b. The opening supports 162b can engage the support tray 180 to help fix the position of the support tray 180 relative to the tabletop 56b. In some embodiments, the opening supports 162b can support the burner tray 58 as discussed herein, for example, with opening supports 162. As illustrated in FIG. 44, the support tray 180 can support a burner tray 58. The burner tray 58 can house the charcoal assembly 150 as discussed herein. In some embodiments, the support tray 180 can support the charcoal assembly 150 directly without the burner tray 58.

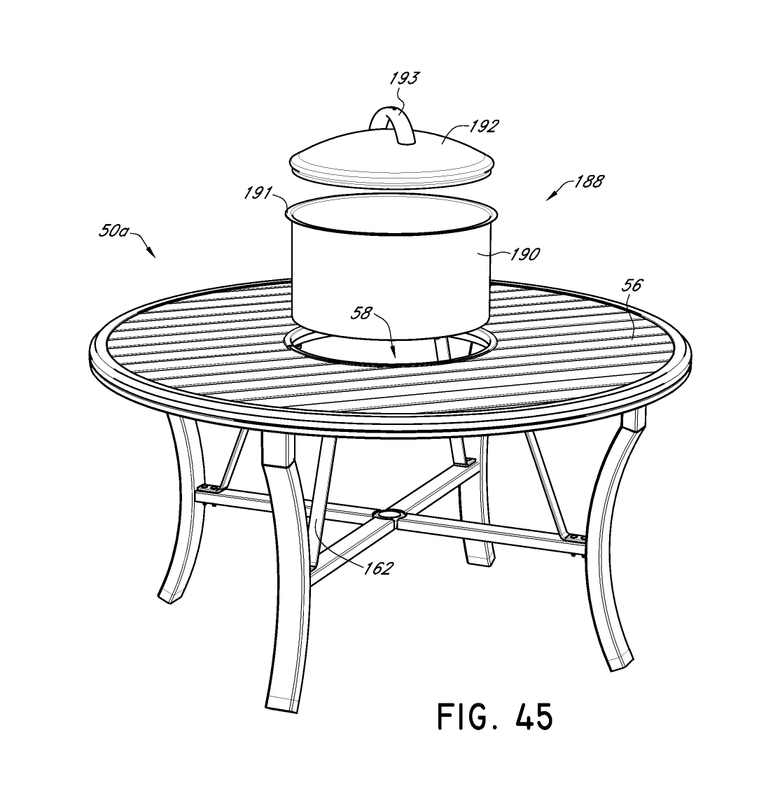

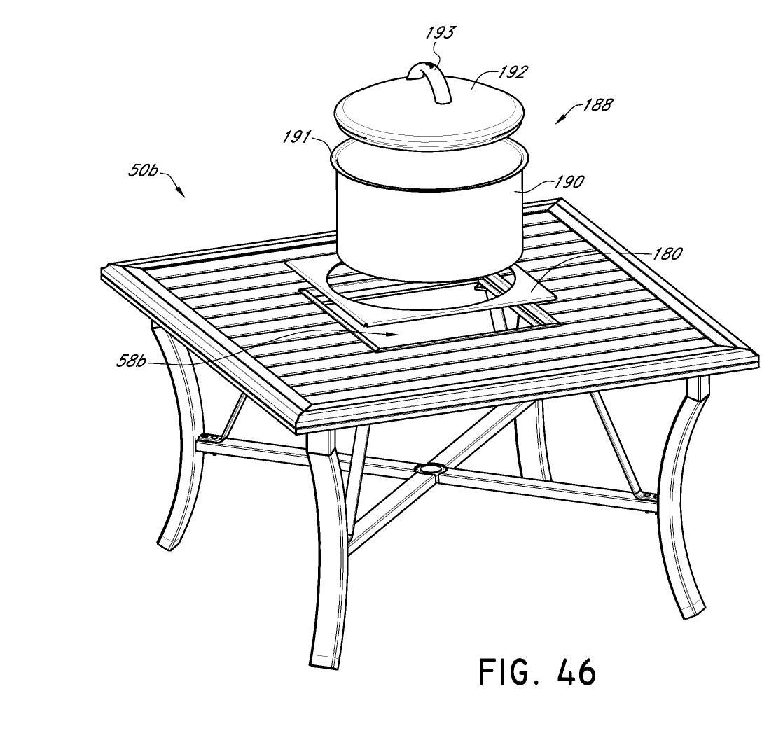

FIG. 45 illustrates a top perspective view of an embodiment a bucket or pan 188 in a fire pit table 50a. The bucket 188 can be used to store food items such as beverages or any other items desired by the user. The bucket 188 can retain liquids to, for example, can contain ice and keep beverages or other food items cold. The bucket can be made of any suitable polymer, metal, or metal alloy as discussed herein. In some embodiments, the bucket 188 can be insulated or be made of a material with insulating properties to, for example, keep ice from melting and retain coolness of beverages. The bucket 188 can have a body 190 and a cover 192. The bucket 188 can be round as illustrated in FIG. 46. In some embodiment, the bucket 188 can be any suitable and/or desired shape as discussed herein, and in particular in reference to FIG. 46. The body can have a lip 191 which can rest on, mate with, and/or engage the periphery of an opening 58 (or rim 62) of the fire pit 50a. In some embodiments, the burner tray 58 and other fire pit burner components, such as the firebox 64 and the burners 68, can be removed to insert the bucket 188 into the fire pit 50a. In some embodiments, the burner tray 58 does not have to be removed. The body 190 of the bucket 188 can be sized and shaped to fit within the opening or cavity formed by a burner tray as discussed herein for a charcoal assembly 150 being sized and shaped to fit within a burner tray 58.

The cover 192 can have a handle 193 to allow the cover 192 to be lifted and provide access to an interior cavity formed by the body 190. The fire pit 50a can have opening supports 162 that connect to the opening 58 and/or bucket 188 to provide structural support and integrity such as, for example, retaining the bucket 188 in a desired position relative to the tabletop 56.

FIG. 46 illustrates a top perspective view of an embodiment of a bucket 188 in a fire pit table 50b. The bucket 188 can be used with a square fire pit table 50b. In some embodiments, the bucket 188 can be of a square or rectangular shape to rest on, mate with, and/or engage the periphery of an opening 58b (e.g., rim) that is square. For example, the lip 191 can be sized and shaped to rest on, mate with, and/or engage the periphery of an opening 58b that is square. The cover 192 can correspondingly be of matching shape and size, such as, for example, square.

A bucket 188 that is of a different size or shape than, for example, square to match a square opening 58b can be used with a support tray 180. The square opening 58b can house the support tray 180. The support tray 180 can be sized and shaped to fit within and be supported by the square opening 58b. The support tray 180 can have a round opening for accepting, for example, the bucket 188 such that the lip 191 can rest on, mate with, and/or engage the inside periphery of the opening of the support tray 180.

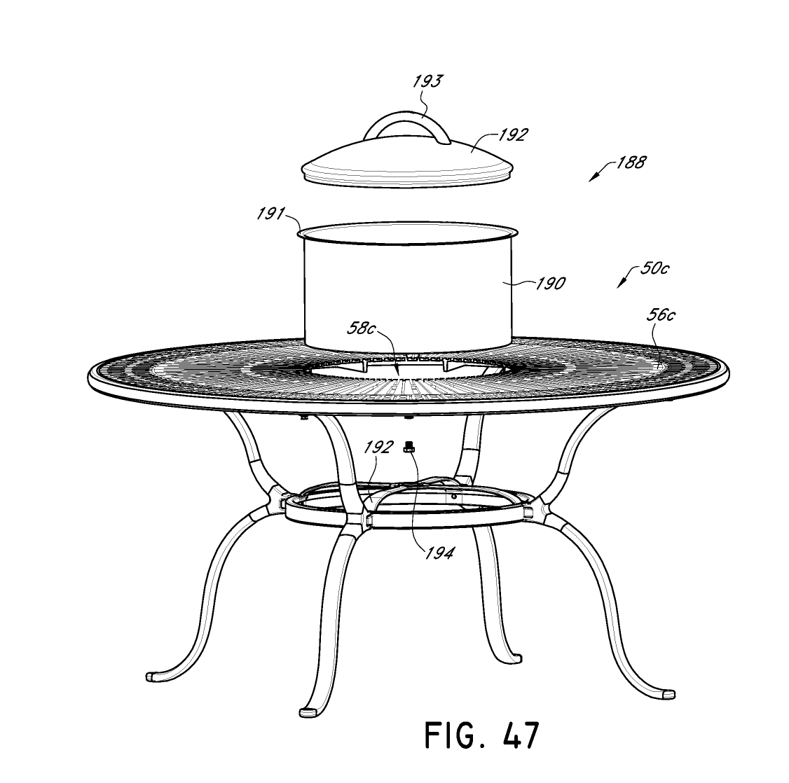

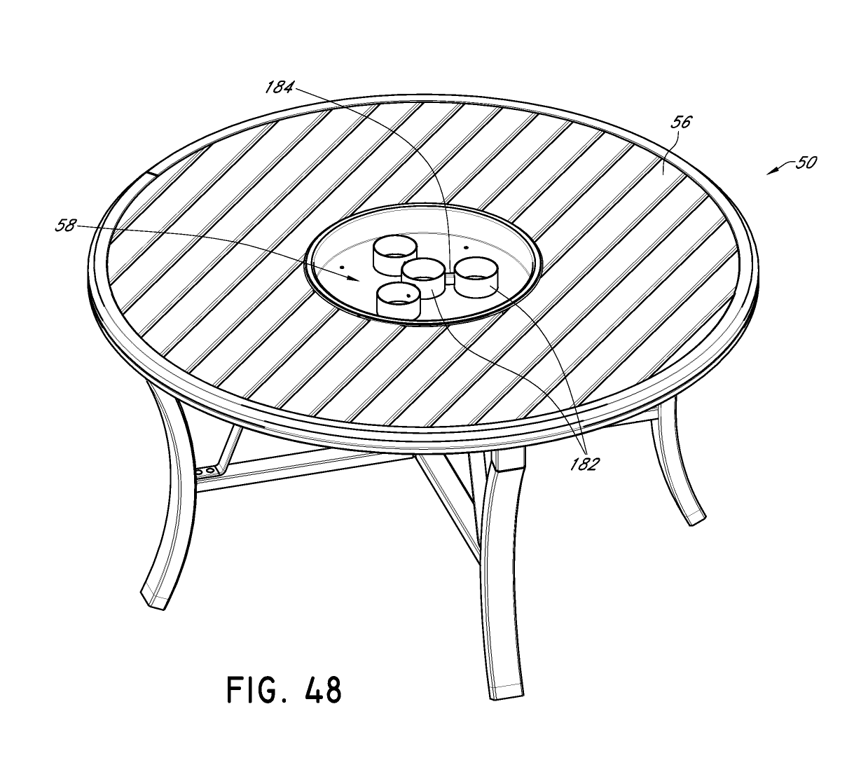

FIG. 47 illustrates a top perspective view of an embodiment of a bucket 188 in a table 50c. The table 50c can have a tabletop 56c that is round. The table 50c can be a table for dining/entertainment that is not necessarily adapted to be used with a fire pit as discussed herein. The table 50c can have an opening 58c. The opening 58c can be used with various other accessories such as, for example, a table umbrella to act as an umbrella stand. The opening 58c can be used with an adapter support plate to accommodate the various accessories such as, for example, an adapter for accepting the pole of the umbrella. As illustrated in FIG. 47, the table 50c can accommodate a bucket 188 as discussed herein. The bucket 188 can have a body 190 with a lip 191 and a cover 192 with a handle 193. The lip 191 can be sized and shaped to rest on, mate with, and/or engage the periphery of the opening 58c as discussed herein.

The bucket 188 can be attached or fixed to a support structure 192 of the table 50c. The bucket 188 can have a threaded opening in the body 192 to accept a threaded bolt 194. The threaded bolt 194 can seal openings in the body 192 to hold, for example, ice as discussed herein. Simultaneously, the bolt 194 can engage the support structure 192 to fixedly attach the body 190 of the bucket 188 to the table 50c.

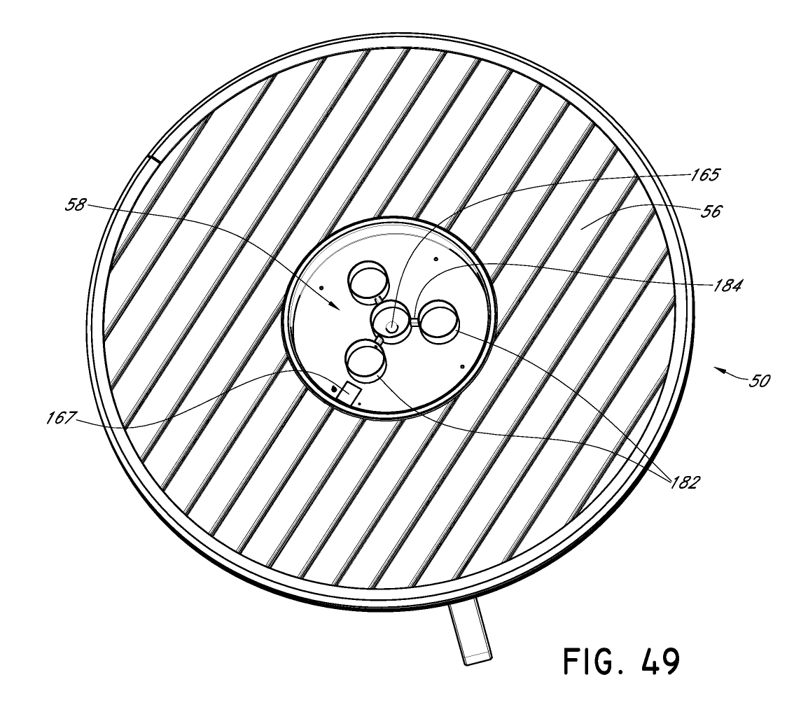

FIG. 48 illustrates a top perspective view of an embodiment of gel burners 182. The gel burners 18 can hold, for example, a combustible gel fuel. In some embodiments, the gel fuel can be any suitable type that gives off relatively less combustible byproducts than burners 68 or charcoal and may be used safely indoors (or in a closed or semi-closed environment) to provide a desired ambiance. The gel burners 182 can be a plurality of cylinders attached together with support bars 184. As illustrated in FIG. 48, there can be four gel burners 182 arranged in various shapes as desired for aesthetics. In some embodiments, there may be more or less gel burners 182 of varying sizes and shapes.

The gel burners 182 can be placed into the burner tray 58. In some embodiments, the burning media, firebox 64, and/or burners 68 can be removed prior to placing the gel burners 182 onto the burner tray 58. The gel burners 182 can comprise a cylindrical or other type of shape wall. In some embodiments, the gel burners 182 can have a bottom to form a sealed container for retaining liquids, similar to the body 190 of the bucket 188 as discussed herein. In some embodiments, the gel burners 182 can be placed onto the charcoal assembly 150.

FIG. 49 illustrates a top view of an embodiment of gel burners 182. As illustrated in FIG. 49, the gel burners 182 can have cylindrical (or other shaped) bodies without a bottom. The gel burners 182 can be connected by support bars 184. The gel burners 182 can rest on, mate with, and/or engage the burner tray 58. The burner opening 165 and firebox opening 167 can be closed as discussed herein while using the gel burners 182.

It is contemplated that various combinations or subcombinations of the specific features and aspects of the embodiments disclosed above may be made and still fall within one or more of the inventions. Further, the disclosure herein of any particular feature, aspect, method, property, characteristic, quality, attribute, element, or the like in connection with an embodiment can be used in all other embodiments set forth herein. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above. Moreover, while the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents, and alternatives falling within the spirit and scope of the various embodiments described and the appended claims. Any methods disclosed herein need not be performed in the order recited. The methods disclosed herein include certain actions taken by a practitioner; however, they can also include any third-party instruction of those actions, either expressly or by implication. For example, actions such as “passing a suspension line through the base of the tongue” include “instructing the passing of a suspension line through the base of the tongue.” It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. The ranges disclosed herein also encompass any and all overlap, sub-ranges, and combinations thereof. Language such as “up to,” “at least,” “greater than,” “less than,” “between,” and the like includes the number recited. Numbers preceded by a term such as “approximately”, “about”, and “substantially” as used herein include the recited numbers, and also represent an amount close to the stated amount that still performs a desired function or achieves a desired result.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced embodiment recitation is intended, such an intent will be explicitly recited in the embodiment, and in the absence of such recitation no such intent is present. For example, as an aid to understanding, the following disclosure may contain usage of the introductory phrases “at least one” and “one or more” to introduce embodiment recitations. However, the use of such phrases should not be construed to imply that the introduction of an embodiment recitation by the indefinite articles “a” or “an” limits any particular embodiment containing such introduced embodiment recitation to embodiments containing only one such recitation, even when the same embodiment includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” or “one of the A, B, or C,” etc. is used, in general such a construction is intended in the sense one having skill in the art would understand the convention (e.g., “a system having at least one of A, B, and C (or one of the A, B, or C)” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, embodiments, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting.

1. A turntable fire pit assembly comprising:
a fire pit comprising a tabletop supported by sides, the tabletop including an opening bounded by a rim; and
a turntable comprising a rotating cover and a flange connected to the rotating cover, and at least one roller assembly connected to the flange, the turntable configured to engage the fire pit to allow the rotating cover to rotate on the roller assemblies relative to the tabletop of the fire pit about a central axis of the turntable when the turntable is at least partially over the opening of the fire pit,
wherein the roller assembly comprises:
a bolt connected to the flange and extending radially inward toward the central axis of the turntable;
a roller on the bolt, the roller configured to rotate about the bolt to allow the rotating cover to move relative to the tabletop about the central axis when the turntable is at least partially over the opening of the fire pit; and
a fin connected to the bolt, the fin proximate to the central axis relative to the roller and extending past a periphery of the roller away from the rotating cover to guide the rotating cover along a rotating path while the roller rotates about the bolt to allow the rotating cover to move relative to the tabletop about the central axis when the turntable is at least partially over the opening of the fire.

2. (canceled)

3. (canceled)

4. (canceled)

5. The turntable fire pit assembly of claim 1, wherein the fin extends toward the rotating cover, the fin comprising a substantially straight side that inhibits rotation of the fin about the bolt by abutting a surface of the rotating cover via at least one contact point between the substantially straight side and the surface of the rotating cover.

6. (canceled)

7. The turntable fire pit assembly of claim 1, wherein the roller is configured to roll on the rim of the opening of the fire pit, the rim circumscribing a perimeter of the opening and connected to an inner wall inside the opening, and wherein the fin extends past the rim into the opening adjacent the inner wall to guide the rotating cover along the rotating path, wherein the rotating path corresponds to the perimeter of the opening via the inner wall inhibiting movement of the fin beyond the perimeter of the opening when the turntable is at least partially over the opening of the fire pit.

8. The turntable fire pit assembly of claim 1, further comprising a table ring configured to be placed on the fire pit about the opening, and wherein the roller is configured to roll on a rim of the table ring of the fire pit, the rim circumscribing a perimeter of the opening and connected to an inner wall of the table ring, and wherein the fin extends past the rim adjacent the inner wall to guide the rotating cover along the rotating path, wherein the rotating path corresponds to the perimeter of the opening via the inner wall inhibiting movement of the fin beyond the rim of the table ring when the table ring is at least partially over the opening of the fire pit with the turntable on the table ring.

9. (canceled)

10. The turntable fire pit assembly of claim 1, wherein a diameter of the opening of the fire pit is about 12 to about 18 inches, and wherein a diameter of the rotating cover is about 12 to about 36 inches.

11. The turntable fire pit assembly of claim 1, wherein the fire pit comprises a table comprising legs configured to support the table on a resting surface

12. A turntable assembly for placement onto a table, the turntable assembly comprising:
a body comprising a skirt circumscribing a central axis of the body, the skirt extending from the body generally in a direction parallel to the central axis;
an axle connected to the skirt, the axle radially extending relative to the central axis;
a bearing on the axle, the bearing configured to spin on the axle; and
a wing on the axle, the wing extending substantially parallel to the central axis beyond a periphery of the bearing,
wherein when the turntable is placed on top of a table with an opening, the bearing contacts the table to support the turntable on the table, and
wherein when the turntable is placed on the table at least partially over the opening, the wing extends into the opening to guide the body along a perimeter of the opening while the body moves relative to the table via the bearings spinning on the axle.

13. (canceled)

14. (canceled)

15. (canceled)

16. The turntable assembly of claim 12, wherein the wing extends toward the body parallel to the central axis, the wing comprising a side that inhibits rotation of the wing about the axle by the side abutting the body.

17. The turntable assembly of claim 12, further comprising a protrusion connected to the skirt and radially extending out relative to the central axis beyond a perimeter of the flange about the central axis, wherein an axle opening radially extends through the skirt and the protrusion, and wherein the axle is securely connected to the skirt via the axle opening with the axle opening orienting the axle substantially perpendicular to the central axis.

18. The turntable assembly of claim 12, wherein the bearing is configured to roll on a lip of the opening of the table, the lip circumscribing the perimeter of the opening of the table and connected to an inner wall of the opening of the table, and wherein the wing extends past the lip into the opening adjacent the inner wall to guide the body relative the inner wall such that the inner wall inhibits movement of the wing beyond the perimeter of the opening when the body is at least partially over the opening of the table.

19. The turntable assembly of claim 12, wherein the bearing is configured to roll on a table hoop configured to be placed on the table about the opening of the table, the table hoop sized to follow the perimeter of the opening, and wherein the wing extends past a top of the table hoop to guide the body along a perimeter of the table hoop when the table hoop is at least partially over the opening of the table with the bearing on the table ring.

20. The turntable assembly of claim 19, wherein the table hoop comprises a stop configured to rest against the table to inhibit movement of the table ring relative to the table.

21. The turntable assembly of claim 12, wherein the axle radially extends from the skirt to the central axis.

22. (canceled)

23. (canceled)

24. A wheel assembly for supporting a rotating cover on a resting surface, the wheel assembly comprising:
a shaft;
a wheel on the shaft, the wheel configured to spin on the shaft; and
a projection on the shaft, the projection extending substantially parallel to the central axis beyond a periphery of the wheel,
wherein when the shaft is connected to a rotating cover, the wheel is configured to support the rotating cover relative to a resting surface, and
wherein when the shaft is connected to the rotating cover and the wheel is placed onto the resting surface, the rotating cover is allowed to rotate relative to resting surface via the wheel rotating on the resting surface, the rotation of the rotating cover guided along a predetermined path by the projection engaging a side of the resting surface.

25. The wheel assembly of claim 24, wherein the resting surface comprises an opening having the side, wherein when the shaft is connected to the rotating cover and the wheel is placed onto the resting surface, the rotating cover at least partially covers the opening such that the projection extends into the opening of the resting surface to engage the side and guide the rotating cover along the predetermined path about a central axis of the rotating cover.

26. The wheel assembly of claim 25, wherein when the shaft is connected to the rotating cover, the projection extends toward the rotating cover parallel to the central axis, the projection comprising a side that inhibits rotation of the wing about the shaft by coming against the body via at least one contact point between the side of the projection and the rotating cover.

27. The wheel assembly of claim 24, further comprising a spacer on the shaft, the spacer configured to position the projection at a desired position on the shaft.

28. The wheel assembly of claim 27, wherein the spacer is between the wheel and the projection.

29. The wheel assembly of claim 24, further comprising a washer on the shaft between the rotating cover and the bearing, the washer configured to allow the wheel to rotate about the shaft.

30. The wheel assembly of claim 24, wherein the shaft radially extends substantially perpendicular to a central axis of the rotating cover.

31. (canceled)
